(19) United States
(12) Patent Application Publication
(10) Pub. No.: US 2023/0414430 A1
(43) Pub. Date: Dec. 28, 2023

(54) System, Method and Apparatus for Supporting a Device

(71) Applicant: Bolt Fitness Solitions LLC, Dundalk, MD (US)

(72) Inventor: John Godlasky, Dundalk, MD (US)

(21) Appl. No.: 18/339,381

(22) Filed: Jun. 22, 2023

Related U.S. Application Data
(60) Provisional application No. 63/577,107, filed on Apr. 3, 2023.
(60) Provisional application No. 63/354,832, filed on Jun. 23, 2022.

(51) Int. Cl. A61G 13/00; A61G 13/08

(52) U.S. Cl. CPC A61G 13/009; A61G 13/08

(57) ABSTRACT

Embodiments describe a system for facilitating physical massage therapy of a patient. The system comprises of an X-axis support member and actuator; a Y-axis support member and actuator; and a Z-axis support member and actuator. The Z-axis support member includes a mounting surface at its distal end for the mounting of a therapy device. The X-axis support member is operably coupled to the Z-axis support member, and the Y-axis support member is operably coupled to the X-axis support member. The Z-axis actuator is configured to move the Z-axis support member along the Z-axis; the X-axis actuator is configured to move the Z-axis support member along the X-axis; and the Y-axis actuator is configured to move the X-axis support member along the Y-axis. A graphical user interface is configured to control the operation of the actuators, receive input from a user, display data from a network device, and generate control signals.

### RELATED APPLICATIONS

This application claims the benefit of U.S. Provisional Application No. 63/577,107, filed on Apr. 4, 2023 and U.S. Provisional Application No. 63/354,832, filed on Jun. 23, 2022. The entire teachings of the above applications are incorporated herein by reference.

### BACKGROUND

Current physical therapy treatments for rehabilitation of neurological and neuromuscular disorders have many shortcomings. For example, conventional therapy devices have potential to provide beneficial improvements but suffer from limited range of motion for delivery of the massage therapy to a patient. There are &so shortcomings in algorithms or types of apparatus used to provide effective control of a massage device. Massage therapy tools for home use such as percussion massage guns are effective but are limited to the patient's reach, especially for effective back therapy, as well as limited to the patient's understanding of massage therapy or physical therapy protocols. Other massage therapy apparatus systems which may not be limited by range of motion, may be limited by shortcomings of effective use of AI algorithms or are currently designed in such a way that is too expensive to be considered for purchase by the general public and are limited to institutional use only, thus greatly limiting the ability for the general public to consistently access the benefits of improved massage therapy systems.

### SUMMARY

Embodiments provide an improved system, method and apparatus for rehabilitation therapy that can be used in any suitable venue, including a private residence, and can be provided to the patient based on real-time input from the patient.

One such example embodiment is a system for facilitating massage therapy of a patient. Such an embodiment has a Z-axis support member, which is configured to move along a Z-axis. A Z-axis actuator is operably coupled to the Z-axis support member, and is further configured to move the Z-axis support member along the Z-axis. An X-axis support member is operably coupled to the Z-axis support member, the Z-Axis support member is further configured to move along the X-axis support member in the X-axis direction. The X-axis actuator is coupled to the X-axis support member, such that the X-axis actuator is configured to move the Z-axis support member along the X-axis. A Y-axis support member movably supports the X-axis support member, such that the X-axis support member is movable along a Y-axis. A Y-axis actuator is operably coupled to the Y-axis support member, and is configured to move the X-axis support member along the Y-axis. Further, there is at least one processor operably coupled to the X-axis actuator, the Y-axis actuator, and the Z-axis actuator. Further still, the system has a memory with computer code instructions stored thereon. The processor, combined with the computer code instructions and the memory, is configured to receive signals from a network device, transmit signals to the network device, and to control the operation of the X-axis actuator, the Y-axis actuator, and the Z-axis actuator, based at least in part on the received signals from the network device. Further still, the system contains a graphical user interface which is coupled to the processor. The graphical user interface is configured to receive input from a user and display data from the network device to generate control signals based at least in part on the user input and the data received from the network device. The graphical user interface further transmits the control signals to the processor to instruct the processor to control the operation of the X-axis actuator, the Y-axis actuator, and the Z-axis actuator.

In embodiments, an additional axis of rotation is introduced at the coupling between the therapy device and the Z-axis support member, such that the therapy device is free to rotate around the X-axis.

In some embodiments, the system for facilitating massage therapy includes one or more imaging sensors which are configured to generate image signals and provide the image signals to the processor.

In some further embodiments the processor is further configured to provide the image signals to the graphical user interface.

In yet another embodiment, the one or more imaging sensors include one or more cameras, time of flight sensors, LiDAR, or any combination thereof.

In another embodiment, a therapy plan is generated comprising a combination of human input data and image sensor data.

In embodiments, an artificial intelligence technique is utilized to generate body scan data points that are provided to the processor as input signals.

In another embodiment, the artificial intelligence technique is based on user defined variables of height, weight, sex, or any combination there.

In a further embodiment, one or more 3-dimensional human anatomy models are programmed in the memory of the processor and identify certain human anatomical locations which are identifiable as body scan data points. These data points are defined by the system in 3-dimensional Cartesian coordinate space.

In another embodiment, the artificial intelligence technique is utilized to alter the body scan data points in the 3-dimensional Cartesian coordinate space based on user defined variables of height, weight, sex, or any combination thereof.

In yet another embodiment, an artificial intelligence technique is configured to alter the body scan data points in a 3-dimensional Cartesian coordinate space based on input from one or more imaging sensors, wherein the imaging sensors are configured to generate image signals and provide the image signals to the processor.

In embodiments, the system for facilitating massage therapy further comprises one or more pressure sensors disposed on either the X-axis support member or the Z-axis support member. The pressure sensors are configured to sense pressure exerted by the mounting surface of the X-axis support member or the Z-axis support member and provide sensed pressure data signals to the processor.

In further embodiments, the system for facilitating massage therapy comprises a remote controller operatively coupled to the processor. The remote controller is configured to provide user input control signals to the processor, independently control the motion of the Z-axis support member in the Z-axis, independently control the motion of the Z-axis support member in the X-axis, and independently control the motion of the X-axis support member in the Y-axis.

In still further embodiments, the remote controller is configured to control a therapy device operably coupled to the mounting surface.

In another embodiment, the graphical user interface is configured to provide user input control signals to the processor; control motion of the Z-axis support member in the Z-axis; control motion of the X-axis support member in the X-axis and the Y-axis; and control the operation of a therapy device coupled to the mounting surface of the Z-axis support member.

In yet another embodiment, the system for facilitating massage therapy comprises a substantially planar surface configured to support the Y-axis support member.

In some further embodiments, the X-axis support member includes elevation legs coupled to the Y-axis support member, and elevate the Y-axis support member above the planar surface, and a hinge is configured such that the Y-axis support member is able to fold parallel along the planar surface.

In embodiments, the Y-axis support member has a construction of a similar length to the planar surface, and a hinge which is operably coupled to the midway point of the Y-axis support member; and the planar surface has a construction of a similar length to the Y-axis support member, and a hinge operably coupled to the midway point of the planar surface; and the Y-axis support member and the planar surfaces are coupled by their respective hinges, such that the Y-axis support member and the planar surface are able to fold in a parallel manner.

In another embodiment of the system for facilitating massage therapy, the Y-axis support member is oriented to be behind or underneath a user; and there is a material affixed between the user and the Y-axis support member, which is configured to support the weight of the user; and a therapy device is attached to the Z-axis support member and configured such that the therapy device is capable of applying pressure on the user through the material.

A further embodiment includes a system for controlling one or more support members. The system processor includes defining in the memory of a processor, one or more saved data sets configured to store representations about a user. The system also receives input data from a user; signals from a patient device; signals from a network device; image signals from an image device; and signals from a pressure sensor. The system also generates control signals to control movement of one or more support members based at least in part on the input data from a user, signals received from the patient device, and signals received from the network device. The system also provides control signals to one or more actuators which are operably coupled to the one or more support members.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A illustrates a perspective view of an embodiment of the disclosure where a patient us using the table with a frame and therapy device.

FIG. 1B illustrates a perspective view of an embodiment of the disclosure with a therapy device and frame.

FIG. 1C illustrates an enlarged view of an embodiment of the disclosure.

FIG. 1D illustrates a network diagram of an embodiment of the disclosure.

FIGS. 2A-2G illustrate a foldable embodiment of the present disclosure.

FIG. 3 illustrates a perspective view of a therapy device attached to a frame of an embodiment of the present disclosure.

FIG. 4 illustrates a flowchart to implement an embodiment of the present disclosure.

FIG. 5 illustrates a flowchart to implement an embodiment of the present disclosure.

FIG. 6 illustrates a remote controlling device for the therapy system according to an embodiment of the present disclosure.

FIG. 7A illustrates a display application according to an embodiment of the present disclosure.

FIG. 7B illustrates an example of a smartphone application according to an embodiment of the present disclosure.

FIG. 8 illustrates a schematic of processing elements according to an embodiment of the present disclosure.

FIG. 9 illustrates a partial view of a posterior portion of a human.

FIGS. 10A-10H illustrate lever attachments between the device and the frame according to an embodiment of the present disclosure.

FIG. 11 illustrates a partial view of a posterior portion of a human.

FIG. 12A-12B illustrates use of a seated embodiment of the present disclosure.

FIG. 13 illustrates use of a seated embodiment of the present disclosure.

FIG. 14A-C illustrates use of a zero-gravity chair embodiment of the present disclosure.

FIG. 15A-D illustrates use of a bed-frame embodiment of the present disclosure.

FIG. 16 illustrates use of a dual massage device embodiment of the present disclosure.

### DETAILED DESCRIPTION

A description of example embodiments follows.

Wherever possible, the same or like reference numbers will be used throughout the drawings to refer to the same or like features. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

Embodiments of the present disclosure will be described more thoroughly from now on regarding the accompanying drawings. Like numerals represent like elements throughout the several figures, and in which example embodiments are shown. However, embodiments of the claims may be embodied in many different forms and should not be construed as limited to the images set forth herein. The examples set forth herein are non-limiting examples and are merely examples, among other possible examples.

There exist present challenges in providing effective physical therapy treatments for patients. This is particularly true for out-patient treatments that may be more efficiently and cost-effectively performed in the patient's home, rather than a medical treatment facility. As described herein, embodiments of this disclosure provide an “at-home” therapy system that permits patients to treat their conditions without needing an appointment and without requiring traveling to a medical facility or rehabilitative facility.

One embodiment of the disclosure is directed to controlling a programmable massage therapy device having a vertical arm on the Z-axis, coupled to a horizontal arm on the X-axis, coupled to a support length arm on the Y-axis, using a processor, a memory, and actuators. The term vertical support member should be understood to refer to the support member operating in the Z-axis. The term horizontal support member should be understood to refer to the support member operating in the X-axis.

Program data, image data, feedback sensory data, and human input data may be stored for each massage and therapy event in a database. The database which may be stored in a memory accessed by a network 400, such as a server with neural network (NN) program code storage, convolutional neural network (CNN) program code storage, recurrent neural network (RNN) program code storage and provided to a remote device 159. Such personnel (therapists) can also prescribe and send massage routines to patient's devices, which may be located in the patient's home.

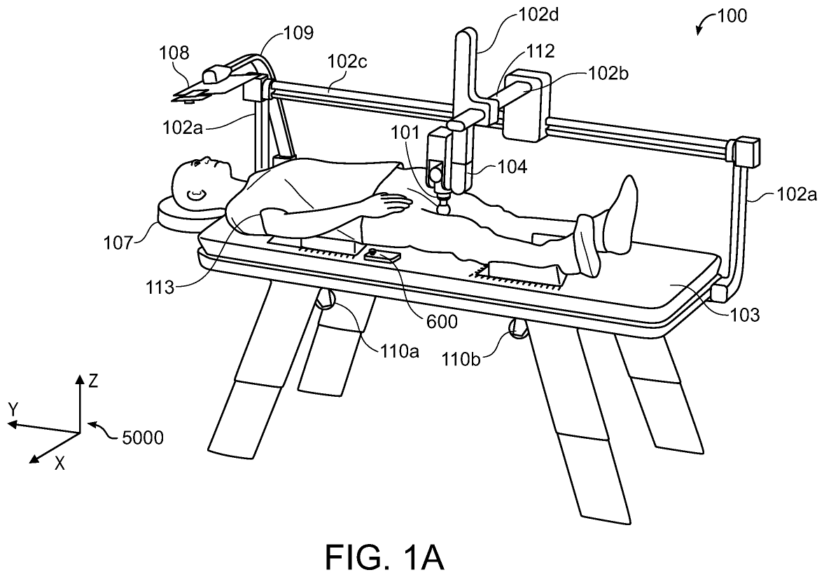

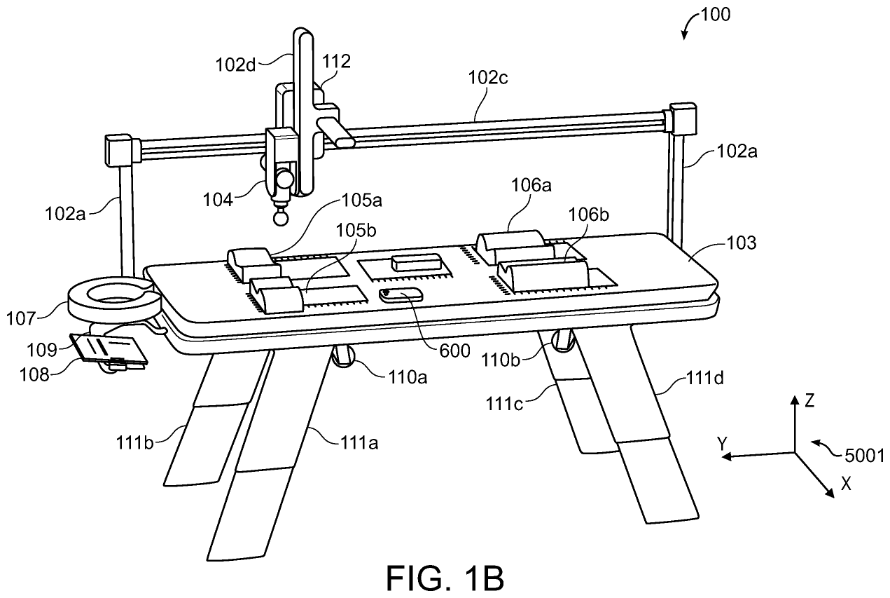

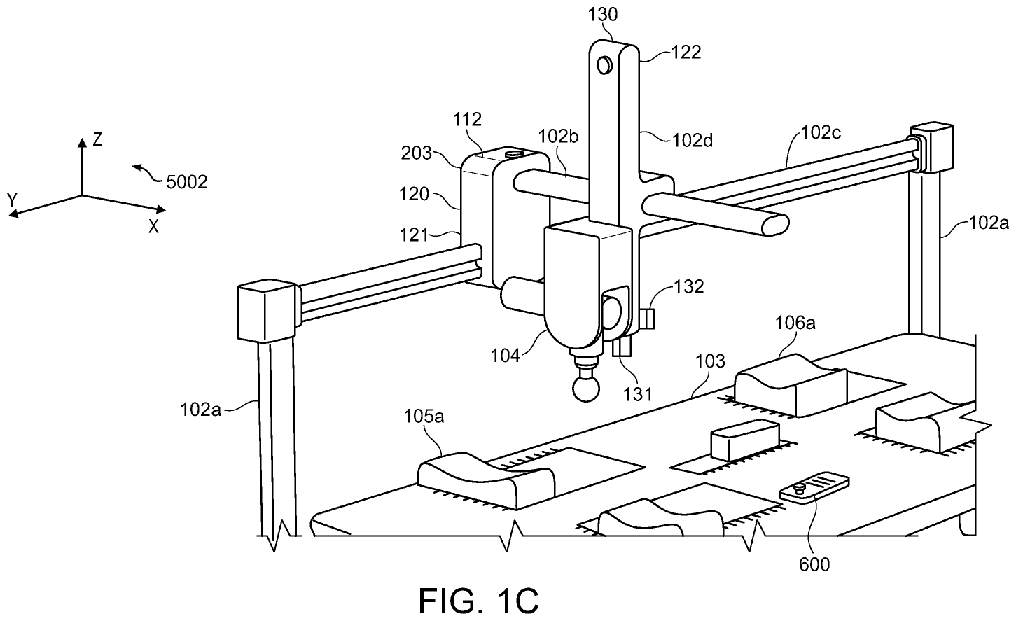

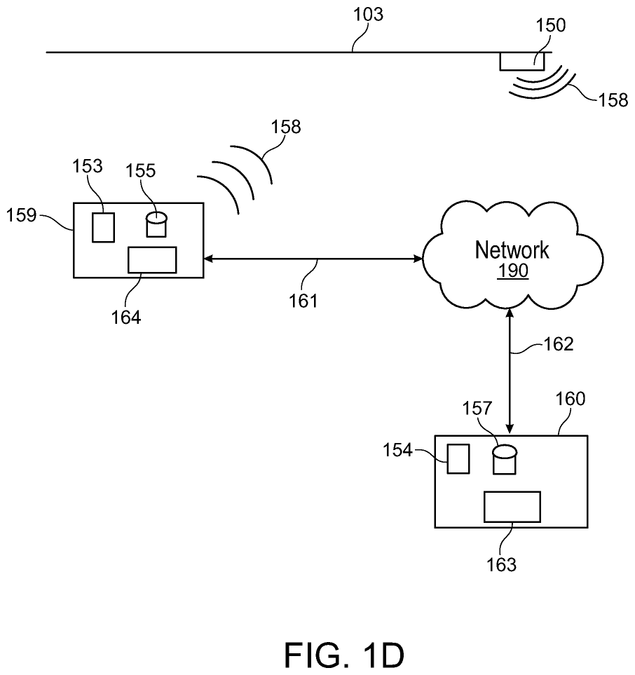

FIGS. 1A and 1B illustrate perspective views of an at home therapy system 100 with a therapy device 101 and with a frame 102. Frame 102 includes the Y-axis support track (Y-axis support member) 102c, the vertical support members 102a, the X-axis support member 102b, and the Z-axis vertical support member 102d. The frame 102 has vertical portions 102a, that elevate frame 102 above the table 103 and that include a therapy device support 104. Therapy device support 104 is designed to support a therapy device 101, which could be, as an example, a percussion massage gun. The table 103 has positioning reference cushions 105a-b and 106a-b which can be adhesive to the table 103. The positioning reference cushions 105a-b and 106a-b provide reference for the anatomy of the patient 113 for the therapy system 100. The reference cushions 105a and 105b provide reference for the patient's 113 left and right arms, respectively, and the reference cushions 106a and 106b provide reference for the patient's 113 left and right legs, respectively. Headrest 107 allows for view of graphical user interface (GUI) 108, which is attached to positioning lever 109. Positioning lever 109 positions the graphic user interface 108 to be viewed below the headrest 107 (as shown in FIG. 1B) or above the headrest (as shown in FIG. 1A). The table 103 includes wheels 110a-b which allow the therapy system 100 to be easily transported after table legs 111a-d are folded into storage positions. Although only two wheels (110a and 110b) are shown, four wheels are used in total. Two wheels are hidden from view on the opposite side of the table 103. Compartment 112 includes actuators which are hidden from view.

In FIG. 1A, the patient 113 is using the therapy system 100 and is laying on the table 103 with frames 102a-c and therapy device 101. Graphical user interface 108 is shown to be positioned above the headrest 107 for access while the patient 113 is laying supine (face-up), and is able to be re-positioned, using the positioning lever 109, under the headrest 107 for access while the patient 113 is laying prone (face-down). 3-dimensional orientation compass 5000 is shown for orientation clarity.

In some embodiments, the table 103 may be any suitable supporting surface. For example, the table 103 may be a massage table, medical examination table or surface upon which a patient may lay.

The Z-axis vertical support member 102d is substantially vertical (Z-axis), and is configured to move along a Z-axis. This vertical support member may be fabricated from metal, plastic, polymer, injection molding process or other suitable material or process to form a resilient, rigid, non-brittle member. The member 102d may be referred to as an arm, lever, truss, structure, section, component, integrant. The arm for the Z-axis vertical support member 102d is operably coupled to substantially horizontal (X-axis) support member 102b, which is to be attached to a Y-axis support track 102c, having vertical portions 102a, which may attach to the perimeter of table 103, or exist as a standalone frame.

The vertical support member 102d may be retractable, telescoping, or extendable to vary the vertical length of the member 102d. Typically, the vertical support member 102d may be between approximately 12 inches in length to 60 inches in length, and between approximately 4 inches in width to 8 inches in width. The vertical Z-axis arm 102d may also be considered to attach or couple to the horizontal arm 102b via a carriage. The carriage moves horizontally along 102b in the X-axis while the vertical Z-axis arm 102d moves over the carriage in the Z-axis. The vertical arm motion over the carriage may be considered as the boom of the arm traveling over the carriage such that it appears to retract as its moved away from the patient and to extend as it moves towards the patient.

The Z-axis substantially vertical (Z-axis) support member 102d includes a mounting surface configured to receive a therapy device 104. The structural integrity of the vertical support member 102d is capable of holding or supporting dimensions and weight characteristics associated with the therapy device 101 and the therapy device support 104. The therapy device 101 may be a percussion massage gun device that can be inserted into therapy device support 104 and removed from support 104; or may be a percussion massage device that is built into the support 104. This therapy device would then be able to provide massage therapy to a patient 113 on the table 103. A distal end portion or near the distal end portion of the vertical support member 102d may have device support 104 configured to support multiple shapes of different types of therapy device 101, such as a variety of percussion massage guns. Device support 104 may have multiple adaptors which may be removed or attached which may be used to support multiple shapes or different types of therapy devices 101, or that may be used for an attachment such as a therapy tool, needle, heat application, or other desired accoutrement that may be positioned via vertical member 102d. The adaptor attachment that may be attached to 104 may include for example, a tool, or device that can comprise a number of massage applicators, a massage head comprising, by way of example, four massage applicators. By way of example, massage applicators may be a soft cushion massager, a ball massager or robot hand massagers. Motion of the attachment may be controlled to provide contact or pressure to a region of a patient's body to be massaged and controlled to move with various massaging motions, such as for example oscillatory rotary motion, to massage a region. Alternatively, a ball massager may be used that includes a relatively hard ball, or a relatively hard cylindrical roller, which is used to massage the patient's body. Motion of the attachment may also be used for a tool which applies heat to specific locations of the patient's body, especially on areas of the patient's back which are difficult to access alone.

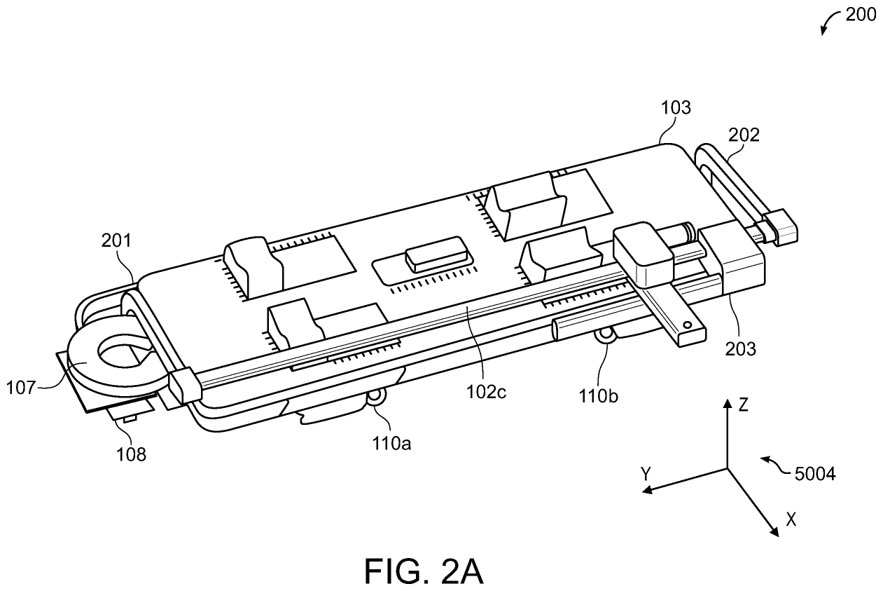

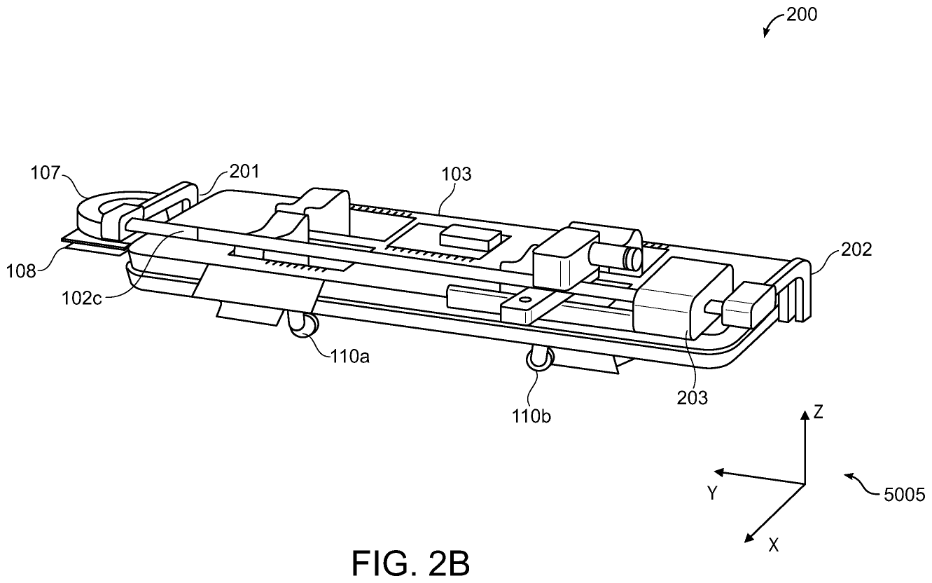

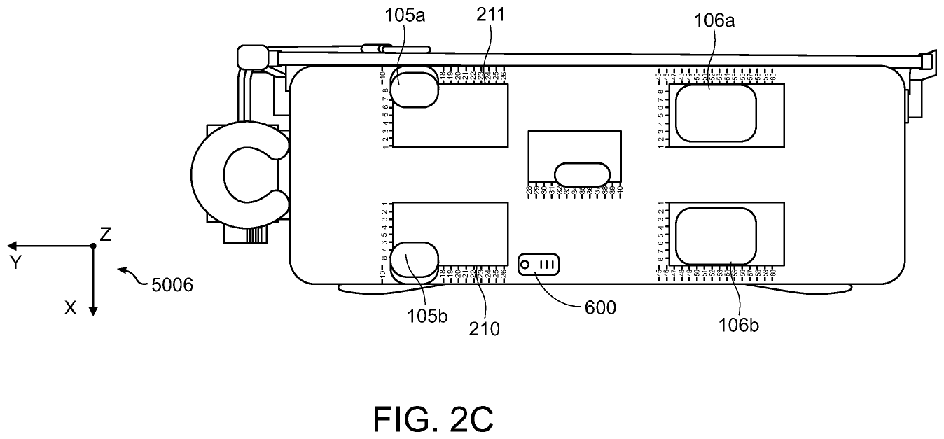

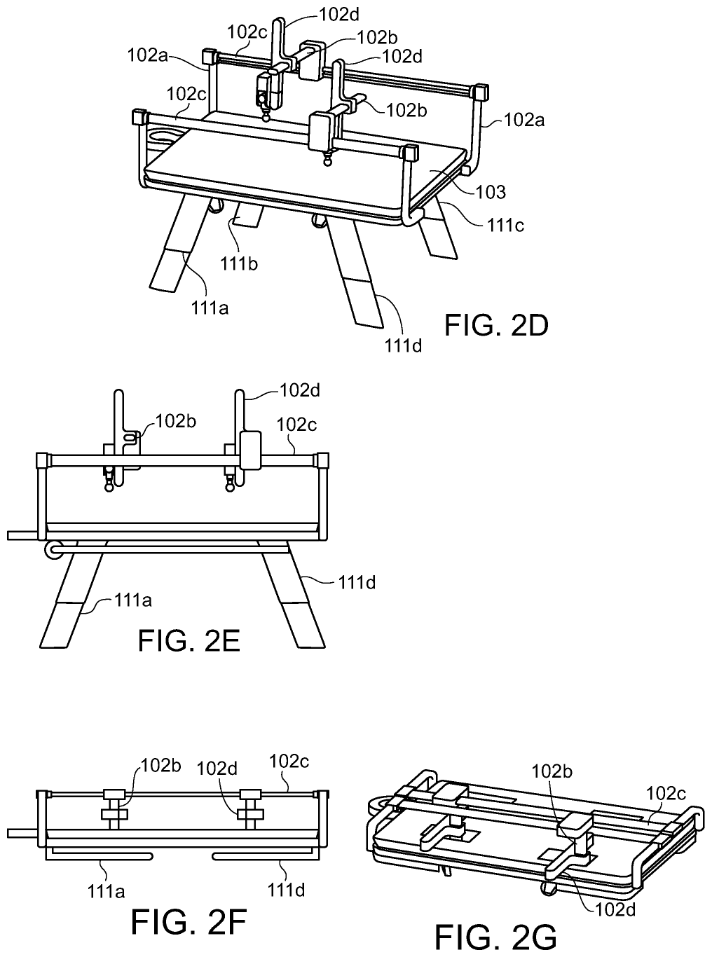

FIG. 1B illustrates a perspective view of track frame 102. Not shown, the track frame 102 may be independent of the table 103. In one embodiment, the track frame 102 has vertical sections 102a that are capable to form a stand-alone frame to provide a foundation for Y-axis support track 102c, horizontal support member 102b, and vertical support member 102d. In this embodiment, the vertical sections 102a are not attached to the table, but rather, are independent, which may be attached to the table or may be positioned to be supported by the floor. In this embodiment, the supports can be set up around, or used in conjunction with any suitable table or surface. The track frame 102 may be set-up so as to support the supports 102c, 102b, 102d, and controller 150 so that a massage device support 104 can provide stimulus to a patient in a multitude of positions. The track frame 102 may be smaller, and meant for stimulus of a patient's torso only, or lower body only. The track frame 102 may be positioned to attach to a multitude of stable objects independently including a chair frame, door frame, exercise squat rack, or bed frame for example. The track frame 102 and device support 104 may be oriented to provide therapy for a patient laying underneath, side-laying or seated. The track frame 102 and device support 104 may also be positioned below the back of a patient's leg while the patient is seated and using a footrest so as to provide a stimulus to the patient's posterior leg in such a position. Actuators 120, 122 and 121 are controlled by processor 150 to control device support 104. Hinges 201, 202, and 203 may be used to fold frame 102a, as shown in FIGS. 2A and 2B. An embodiment with a smaller independent frame 102 and hinges may provide a frame that is used for easy storage and is easily portable. 3-dimensional orientation compass 5001 is shown for orientation clarity.

FIG. 1C represents an enlarged view of the frame 102 and its various sub-components of an embodiment. The frame 102 has a Y-axis support track 102c, which is coupled to X-axis horizontal support member 102b. The X-axis horizontal support member 102b is coupled to Z-axis vertical support member 102d which includes a mounting surface of a lower portion of the member 102d configured to receive a therapy device 104. The frame 102 is mounted to table 103, wherein table 103 is a flat surface. Positioning reference cushions 105a and 106a are also shown attached to the flat surface of table 103. Also shown is the therapy device support and attachment 104. Processor 150, with CPU 151, and accompanying Memory 152, is shown for identification but may be positioned under the table or off of the table. Compartment 112 includes horizontal support member hinge 203. Compartment 112 also contains actuators 120 and 121, which are hidden from view. Actuator 122 is hidden from view but shown to be located near the top of the vertical support Z-axis member 102d. Actuators 120, 121, and 122 are configured to receive control signals from a processor or controller 150 to move and thereby control motion and positioning of the support arms 102b-d. Image sensors 130, 131, and 132 are also shown. Image sensor 130 is shown to be positioned on or near the top of vertical support member 102d to provide a perspective overhead view of patient 113 on the table 103 and frame 102. Image sensors 131 and 132 are shown to be positioned so that view of patient 113 and therapy device 101 in contact with patient 113 is unobstructed. While three image sensors (130, 131, and 132) are shown, there may be more image sensors, or less image sensors, positioned to provide input data to the system. 3-dimensional orientation compass 5002 is shown for orientation clarity.

The actuator 122 is operably coupled to the substantially vertical (Z-axis) support member 102d for moving the substantially vertical (Z-axis) support member 102d and device support 104 in the Z-axis.

The actuator 122 may be a motor, or other force generating device, which is controlled by signals provided by processor, or controller, 150 via suitable communication channels and/or wires to provide a transmission medium or media. Transmission media can include a network and/or data links which can be used to carry desired program code in the form of computer-executable instructions or data structures, and which can be accessed and executed by a general purpose or special purpose computing system. Combinations of the above should also be included within the scope of computer-readable media.

Still referring to FIG. 1C, the actuator 122 is sized and powered such that the actuator 122 moves a position of the vertical support member 102d in the Z-axis and can move an attached device to determine a pressure interaction with a patient 113. In an embodiment the actuator 122 may also be attached to horizontal support member 102b at its coupling with the vertical support member 102d, or may be positioned near the top of the vertical support member 102d. The actuator 122 may be covered and hidden from view for aesthetic purposes.

The substantially horizontal (X-axis) support member 102b is operably coupled to the substantially vertical (Z-axis) support member 102d. The substantially horizontal (X-axis) support member 102b is configured to move the vertical support member along an X-axis. This horizontal support member 102b may be fabricated from metal, plastic, polymer, injection molding process or other suitable material and/or fabrication process. The member 102b may be referred to as an arm, lever, truss, structure, section, component, integrant, or other term to connote the structural integrity to hold or support the substantially vertical (Z-axis) support member 102d and attached device support 104. The member 102b has dimensions and weight characteristics that permit connection to substantially vertical (Z-axis) support member 102d and to the Y-axis support track 102c.

The horizontal support member 102b may be retractable, or telescoping or extendable to vary the horizontal length of the member 102b. Typically, the horizontal support member 102b may be between approximately 12 inches in length to 60 inches in length and between approximately 4 inches in width to 8 inches in width. A hinge 203 located near the horizontal support member's coupling to the Y-axis support track 102c permits the horizontal support member 102b to bend or be folded for ease of storage.

Device support 104 may be any suitable attachment device that is supported by vertical support member 102d. The device support 104 may attach, for example, a massage device, percussion massage gun, a deep tissue muscle massage device, or other suitable device. The device support 104 may provide various massaging motions, such as for example oscillatory rotary motion, to massage the region.

An actuator 120 is operably coupled to the substantially horizontal (X-axis) support member 102b for moving the substantially vertical (Z-axis) support member 102d along the X-axis.

The actuator 120 may be a motor, or other force generating device, which is controlled by signals provided by processor, or controller, 150 via suitable communication channels and/or wires to provide a transmission medium or media. Transmission media can include a network and/or data links which can be used to carry desired program code in the form of computer-executable instructions or data structures, and which can be accessed and executed by a general purpose or special purpose computing system. Combinations of the above should also be included within the scope of computer-readable media.

The actuator 120 is sized and powered such that the actuator 120 moves a position of the vertical support member 102d along the X-axis and can move an attached device support 104 along the X-axis while maintaining a pressure interaction with a patient. The actuator may also be attached to the Y-axis support track 102c at its coupling with the horizontal support member 102b, or may be positioned near the end of the horizontal support member. The actuator may be covered and hidden from view for aesthetic purposes. Compartment 112 contains actuator 120.

The Y-axis support track 102c provides a path of motion of the horizontal member 102b along the Y-axis. The support track 102c path may be a track, rail, or interference fit for the substantially horizontal support member 102b to fit such that the substantially horizontal support member (X-axis) 102b is movable along a Y-plane, which is delineated by track 102c.

The Y-axis support track 102c may be coupled to the table frame with vertical supports 102a also referred to as elevation legs, which elevate the coupled track and members above the table. The vertical supports 102a contain hinges 201 and 202 located near their coupling with the table frame, such that the hinges allow the vertical supports and coupled track and members to fold parallel to the horizontal planar surface of the table 103 for ease of storage. In several embodiments, the horizontal planar surface is a massage table, though it may also be any horizontal planar surface.

In another embodiment, there may be a hinge at the midway point if the Y-axis support track 102c and table 103, such that the table 103 and Y-axis support track 102c can also fold in half for ease of storage.

An actuator 121 is operably coupled to the Y-axis support track 102c for moving the substantially horizontal (X-axis) support member 102b along the Y-axis.

The actuator 121 may be a motor, or other force generating device, which is controlled by signals provided by processor, or controller, 150 via suitable communication channels and/or wires to provide a transmission medium or media. Transmission media can include a network and/or data links which can be used to carry desired program code in the form of computer-executable instructions or data structures, and which can be accessed and executed by a general purpose or special purpose computing system. Combinations of the above should also be included within the scope of computer-readable media.

The actuator 121 is sized and powered such that the actuator 121 moves a position of the horizontal support member 102b and coupled vertical support member 102d in the Y-axis, and can move an attached device support 104 in the Y-axis while maintaining a pressure interaction with a patient. The actuator 121 may also be attached to the Y-axis support track 102c at its coupling with the horizontal support member 102b, or may be positioned near the end of the Y-axis support track 102c. The actuator may be covered and hidden from view for aesthetic purposes. In this embodiment, compartment 112 contains actuator 121.

FIG. 1D illustrates a network diagram for the processor and actuator controllers for the therapy system disclosed herein. Processor, or controller 150 is used to control operation of the first actuator 122, the second actuator 120, and the third actuator 121. The first actuator is operably coupled to a portion of the substantially vertical (Z-axis) support member 102d which moves the attached device support 104 along a Z-axis. The second actuator 120 is operably coupled to a portion of the substantially horizontal (X-axis) support member 102b, which moves the vertical support member 102d carriage along the substantially horizontal (X-axis) support member 102b along the X-axis. The third actuator 121 is operably coupled to a portion of the Y-axis support track 102c, which moves the substantially horizontal (X-axis) support member 102b along the Y-axis support track 102c, with vertical portions 102a. The vertical portions 102a are attached to the perimeter of table 103.

Processor 150 is operatively coupled to actuators 122, 120, and 121. The controller, or processor 150 includes memory 152 and CPU 151. The memory 152 is any suitable electronic storage medium. This includes any suitable register, non-transitory computer-readable medium and may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like.

A computer readable storage medium may be, for example, but not limited to, an electronic, magnetic, optical, electromagnetic, infrared, or semiconductor system, apparatus, or device, or any suitable combination of the foregoing, including non-transitory computer readable media. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray Disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals.

The processor 150 sends signals to the actuator(s) 122, 120, and 121 to control the motion and positioning of the horizontal and vertical support members such that the attached device is movable in a full range of motion of the associated coupled track and members in the X-axis, Y-axis, and Z-axis. As described herein, the controller 150 may receive and/or transit signals via a network to one or more remote devices. Indeed, the processor 150 is configured to receive signals from a network device and transmit signals to the network device, and control operation of the first actuator 122, the second actuator 120, and the third actuator 121 based at least in part on the received signals from the network device. The controller 150 has suitable memory 152 and processing power in CPU 151, to transmit/receive signals. The control signals are provided from controller 150 to actuators 122, 120, and 121 as described herein.

Processor, or controller, 150 may be any suitable processor capable of executing or otherwise performing instructions. Each processor as described herein (including processors 153, 154) may include an associated central processing unit 151 (CPU), or general or special purpose microprocessors, special purpose logic circuitry, e.g., an FPGA (field programmable gate array) or an ASIC (application specific integrated circuit), that carries out program instructions to perform the arithmetical, logical, and input/output operations. Each processor 150, 153, 154, may also include and associated processor memory (152, 155, 157), adapted to store data the associated processor may use.

Processor 150 is shown as disposed in proximity to the actuators 122, 120, and 121. However, the processor 150 may also be located remotely from the actuators 122, 120, and 121, and transmit signals to the actuators 122, 120, and 121 via wired or wireless communication channels 158. The processor 150 communicates with network 190 via wireless or wired signals 161. The processor 150 may also communicate with remote device 159 via wireless or wired signals 158. The processor 150 provides control signals to user remote controller 600, GUI 108, and receives signals from image sensor 130, 131, and 132, and pressure sensor 301. The processor 150 has adequate storage capacity and processing power to receive/transmit data and signals to/from remote devices (159, 160) and actuators 122, 120, and 121 as described herein.

Processor 150 may execute code (e.g., processor firmware, a protocol stack, a database management system, an operating system, or a combination thereof) that creates an execution environment for program instructions. Processor 150 may receive instructions and data from a memory (e.g., 159, 155, or other remote memory, via network 190), image sensors 130, 131, 132, remote control 600, pressure sensor 301 and/or GUI 108. Multiple processors may be employed to provide for parallel or sequential execution of one or more portions of the embodiments described herein. Processes, such as logic flows, described herein may be performed by one or more programmable processors executing one or more computer programs to perform functions by operating on input data and generating corresponding output.

A computer program may be written in a programming language, including compiled or interpreted languages, source code or object code, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

The program code may execute entirely on the computing device 150, partly on the remote device 159, therapist device 160, computer, and/or partly on another device.

Network 190 is any suitable network of computers, such as a cloud, or Internet, or other network of interconnected computers and/or processors, processing devices, output devices or similar series of interconnected apparatus that provides bi-directional communication between processor 150 via channel 158 and/or remote device 159 via channel 158 and/or therapist device 160 via wired or wireless channel 158. These bi-directional communication channels 158, 161, 162 as well as other communication channels, 161, may be wired or wireless communication.

The network 190 may include an Internet Protocol (IP) network via hypertext transfer protocol (HTTP), secure HTTP (HTTPS), and the like. The network 190 may also support an email server configured to operate as an interface between clients and the network components over the IP network via an email protocol (e.g., Simple Mail Transfer Protocol (SMTP), Internet Message Access Protocol (IMAP), Post Office Protocol (POP), etc.).

Therapist device 160 is operatively coupled to network 190 via bi-directional communication channel 162. The therapist device 160 includes a memory 157, processor 154 and graphical user interface 163. Therapist device 160, may be situated at a venue, such as a medical facility, physical therapy center, residence or other location where a health care professional, such as physical therapist, doctor, trainer, or other personnel, is located. The network device 190 may also be in the same location as the patient. Data and information may be received, processed, transmitted and/or displayed at the device 190 via GUI 163. The device 160, generally, may include a computer, smart phone, tablet, laptop, processor, and may also include input device(s) and graphical user interface (GUI) 163, presented on displays (e.g., a cathode ray tube (CRT) or liquid crystal display (LCD) monitor).

The input devices (not shown) to therapist device 160 may include pointing devices (e.g., a computer mouse or trackball), keyboards, keypads, touchpads, scanning devices, voice recognition devices, gesture recognition devices, printers, audio speakers, microphones, cameras, or the like.

The therapist device 160 can operate any of a wide variety of desktop or server operating systems (e.g., Microsoft Windows, Linux, UNIX, Mac OS X, etc.), mobile operating systems (e.g., Apple iOS, Google Android, Windows Phone, etc.), or other operating systems or kernels.

The therapist device memory 157 is any suitable register, non-transitory computer-readable medium and may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like.

Therapist device processor 154 may be any suitable processor capable of executing or otherwise performing instructions. Each processor as described herein may include an associated central processing unit (CPU), or general or special purpose microprocessors, special purpose logic circuitry, e.g., an FPGA (field programmable gate array) or an ASIC (application specific integrated circuit), that carries out program instructions to perform the arithmetical, logical, and input/output operations.

Processor 154 may execute code (e.g., processor firmware, a protocol stack, a database management system, an operating system, or a combination thereof) that creates an execution environment for program instructions. Multiple processors may be employed to provide for parallel or sequential execution of one or more portions of the embodiments described herein. Processes, such as logic flows, described herein may be performed by one or more programmable processors executing one or more computer programs to perform functions by operating on input data and generating corresponding output.

Program code for carrying out operations for aspects of the present disclosure may be generated by any combination of one or more programming language types, including, but not limited to any of the following: machine languages, scripted languages, interpretive languages, compiled languages, concurrent languages, list-based languages, object oriented languages, procedural languages, reflective languages, visual languages, or other language types. Program instructions may include a computer program, which in certain forms is known as a program, software, software application, script, or code.

The memory 157 and processor 154 can utilize one or more artificial intelligence algorithms to generate body scan data points that are provided to the processor 150 as input signals. Alternatively, other machine learning protocols, or algorithms may be stored in memory 157 and processed by processor 154. The artificial intelligence algorithms may be stored in a memory accessed by network 190, such as a server with neural network (NN) program code storage, convolutional neural network (CNN) program code storage, recurrent neural network (RNN) program code storage and provided to therapist device 160.

Remote device 159 includes memory 155, processor 153 and GUI 164.

Remote device 159 is operatively coupled to network 190 via bi-directional communication channel 161 and device 159 is operatively coupled to processor 150 via channel 158. The remote device 159 may be used to perform some or all of the processing that can be performed by processor 150 and provide the results of the processing to processor 150. Data and information may be received, processed, transmitted and/or displayed at the device 159 via GUI 164. The device 159 may include a computer, smart phone, tablet, laptop, processor, and may also include input device(s) and graphical user interface (GUI) 120, presented on displays (e.g., a cathode ray tube (CRT) or liquid crystal display (LCD) monitor).

The input devices (not shown) to remote device 159 may include pointing devices (e.g., a computer mouse or trackball), keyboards, keypads, touchpads, scanning devices, voice recognition devices, gesture recognition devices, printers, audio speakers, microphones, cameras, or the like.

The remote device 159 can operate any of a wide variety of desktop or server operating systems (e.g., Microsoft Windows, Linux, UNIX, Mac OS X, etc.), mobile operating systems (e.g., Apple iOS, Google Android, Windows Phone, etc.), or other operating systems or kernels.

The remote device memory 155 is any suitable register, non-transitory computer-readable medium and may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like.

Remote device processor 153 may be any suitable processor capable of executing or otherwise performing instructions. Each processor as described herein may include an associated central processing unit (CPU), or general or special purpose microprocessors, special purpose logic circuitry, e.g., an FPGA (field programmable gate array) or an ASIC (application specific integrated circuit), that carries out program instructions to perform the arithmetical, logical, and input/output operations.

Processor 153 may execute code (e.g., processor firmware, a protocol stack, a database management system, an operating system, or a combination thereof) that creates an execution environment for program instructions. Multiple processors may be employed to provide for parallel or sequential execution of one or more portions of the embodiments described herein. Processes, such as logic flows, described herein may be performed by one or more programmable processors executing one or more computer programs to perform functions by operating on input data and generating corresponding output.

The memory 155 and processor 153 can utilize one or more artificial intelligence algorithms to generate body scan data points that are provided to the processor 150 as input signals. Alternatively, other machine learning protocols, or algorithms may be stored in memory 155 and processed by processor 153. The artificial intelligence algorithms may be stored in a memory accessed by network 190, such as a server with neural network (NN) program code storage, convolutional neural network (CNN) program code storage, recurrent neural network (RNN) program code storage and provided to remote device 159.

The controller 150 may be in bi-directional communication with a network 190, via wired or wireless connection 158. The network 190 may have potential to be in bi-directional communication with therapist device 190 and remote device 159.

FIGS. 2A and 2B illustrate a foldable frame embodiment 200 of the home therapy system 100. Wheels 110a-b may be used to roll the folded frame 102 and table 103. Headrest 107 and GUI 108 may be retracted for a more compact form factor. Hinges 201 and 202 are at the vertical portion's 102a coupling to table 103 and allow frame 102a to be folded parallel to the horizontal planar surface of table 103. Hinge 203 is at the horizontal support members 102b coupling with the Y-axis support track 102c, which allows the horizontal support member 102b to also be folded along the horizontal planar surface of table 103. 3-dimensional orientation compass 5004 and 5005 are shown for orientation clarity.

FIG. 2C illustrates the table 103 with positioning indicia 210 and 211 and positioning reference cushions 105a-b and 106a-b. The positioning indicia 210 and 211 are represented by a numerical grid on the table 103, and are used to set a position for positioning reference cushions 105a-b and 106a-b. Thus, a user may position the positioning reference cushions 105a-b and 106a-b in a desired location relative to their individual body, and use indicia 210 and 211 as reference numbers which can be input as data into the system. The data provides points of reference for scale of the patient 113. Positioning reference cushions 105a-b and 106a-b may be adhesive to the table 103. The positioning reference cushions 105a-b and 106a-b may also contain, within each respective positioning reference cushion, a sensor providing location data of the respective positioning reference cushion to the system. The location data is used in order to provide reference for scale of the patient 113. Individual adhesive sensors, separate from the positioning reference cushions, may also be placed onto certain anatomical locations on the patient's 113 body to provide location data via a Cartesian coordinate data system of the patient's anatomical locations as input data into the system. 3-dimensional orientation compass 5006 is shown for orientation clarity.

FIGS. 2D-2G illustrate various foldable configurations of the massage therapy system where the massage therapy system has two frames 102 attached at opposite sides of the table 103. Here, the foldable configuration for each of the two frames on the one table are identical to configuration for the one frame as described above.

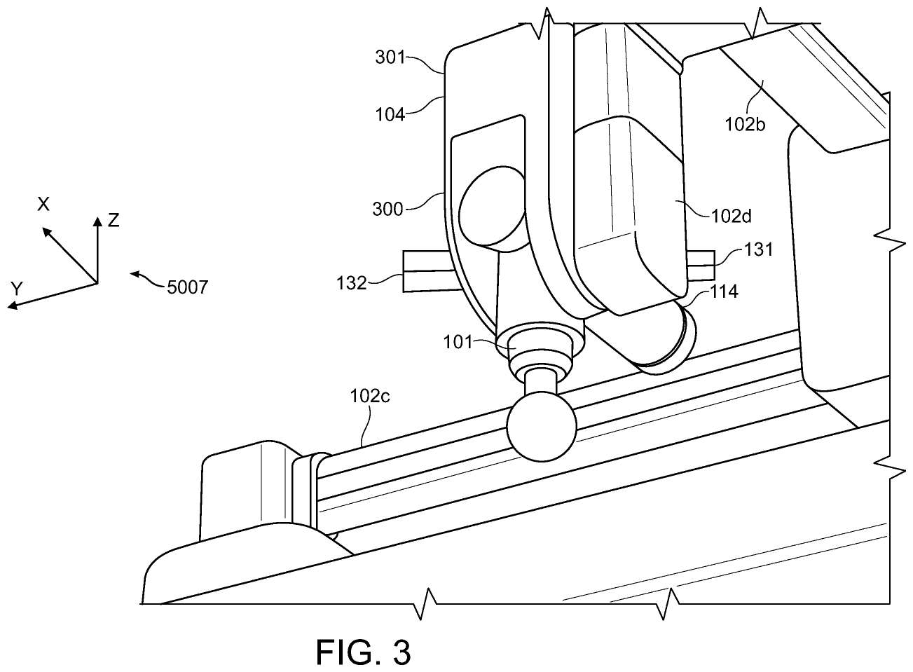

FIG. 3 illustrates a perspective view of the therapy device support 104 and attached therapy device 101, mounted on Z-axis vertical support member 102d. The therapy device 101 contains an integrated battery 114 to supply power to the therapy device 101 during usage. Integrated battery 114 is shown to be exposed to provide an option for charging the integrated battery 114 while its attached, or coupled to, therapy device support 104. Therapy device support 104 may include a charging source to charge the integrated battery 114. The therapy device support 104 may have suitable wired or wireless connectors or adaptors to provide communication and/or power to the therapy device 101. The therapy device 101 may include a Bluetooth connection which allows for the patient 113 to control the therapy device 101, for example, to change the massage speed, to change the amplitude, or to turn the device 101 on or off. This control may be done via the graphic user interface 108, or via remote controller 600. The device support 104 may also contain power button which is used to press the power button on the therapy device 101 after it is attached to support 104. An additional axis of rotation is provided by actuator 300, which is contained within device support 104. Actuator 300 provides rotation motion in the B-axis relative to the system frame 102. In this embodiment, actuator 300 provides a 90-degree motion right or left, but may be positioned to provide a 360-degree rotation of therapy device 101 while it's attached to device support 104. Image sensors 131 and 132 are shown to be positioned near the distal end of vertical support member 102d, and may also be attached to device support 104. Image sensors 131 and 132 are shown to be positioned such that their view of patient 113 and therapy device 101 in contact with patient 113 is unobstructed. In some embodiments, additional image sensors may be utilized. One or more pressure sensors 301, are also contained within device support 104, which can measure a pressure interaction of a device attached to device support 104 and interaction with a patient 113. 3-dimensional orientation compass 5007 is shown for orientation clarity.

A holster, or harness, included in device support 104 may be used to support or hold a device 101 in a desired position relative to vertical support member 102d. The holster may be configured to provide an additional axis of rotation which is powered by actuator 300, which is contained within device support 104. Actuator 300 provides rotation motion in the B-axis relative to the system frame 102. In this embodiment, Actuator 300 provides a 90-degree motion right or left, but may be positioned to provide a 360-degree rotation of percussion massage gun 101 while it's attached. The holster can be controlled via a remote controller, as described herein. Alternatively, an additional holster remote controller may be used to control movement of the holster independent of the movement of the member 102d. Additionally, the holster is configured to control a power button of an attached instrument, such as the percussion massage gun instrument. This functionality is adapted to emergency stop, pause and/or modify or alter operation of the instrument. This may also be accomplished by a knob, or other control device mounted on the holster that a user may use to control operation of the instrument.

In an embodiment, the therapy device support 104 allows for there to be an integrated depth sensor for the therapy device 101, and or a force sensor, in order to provide feedback possibly stop the operation of the therapy system. The therapy device support 104 and may be configured to accommodate different shapes and sizes of therapy devices and their respective accessories. There may be additional optical systems to ensure that the patient is in the correct position, in addition to helping guide the massager along the body of the patient.

Device support 104 is a section of vertical support member 102d, which may be disposed on a lower surface near the distal end of support member 102d. The device 101 may be slid into or inserted into support 104, to mount, support, hold a device 101, or other attachment, such as a massage ball, needle, or massage implement, to vertical support arm 102d.

Actuator 122 is configured to enable movement of the vertical support member 102d in the z-plane. Actuation of actuator 122 may also provide force capable of moving the vertical support member to determine a pressure interaction with a patient, measured by one or more pressure sensors 301.

Pressure sensor(s) 301, while only one pressure sensor 301 is labeled, any suitable number of pressure sensors 301 may be used to obtain additional pressure data relative to a patient's body. As shown in FIG. 3, pressure sensor 301 is disposed on the vertical support member 102d and is configured to sense pressure exerted by the massage device support 104, and attached device 101 on a patient's body. The pressure sensor 301 provides sensed pressure data signals to the processor 150.

Pressure sensors 301 can be mounted to a portion of the vertical support member 102d or within device support 104. The sensors 301 can also prevent the vertical support members 102d from applying excessive tactile pressure to a patient. In some embodiments, the sensors 301 are configured to deliver no more than a threshold amount of tactile pressure (e.g. 40 psi, 30 psi, 20 psi, 10 psi, 5 psi, or less), and can monitor the amount of tactile pressure exerted on the patient. Additionally, or alternatively, the sensors 301 can move and gather data relative to the 3D model image data of the patient. This 3D image data can be used to ensure the contact surface of the vertical support members 102d, device support 104, and attached device 101, does not press into the patient beyond a threshold depth (e.g., 4 inches, 3 inches, 2 inches, 1.5 inches. 1 inch, 0.75 inches, 0.5 inches, 0.25 inches, or less).

Input data from therapist sessions may be accessed through network 190 for machine learning purposes. A therapist could choose a predetermined therapy program for the patient, based on the therapist's professional recommendation, and the therapist can input reasons they chose the particular program for that individual patient. The reasons for the selected program data can be used for machine learning purposes. The therapist may also self-manually control a therapy program for the user remotely, which provides therapist access to control patient device's actuators 120, 121, and 122, as well as device support 104 and attached device 101, while receiving signals from image sensors 130, 131, and 132, and pressure sensor 301, which can be referred to as a live session. Similarly, the therapist can input reasons for their choosing of their self-controlled paths of their manual therapy program. The reasons input by the therapist, and the entire therapist-run movement of actuators 120, 121, and 122, and control of device support 104 and attached device 101, and input signals from image sensors 130, 131, and 132, and pressure sensor 301 during a live session, can be stored in memory and accessed by network and used for AI data analysis and machine learning.

A therapist may input data for the patient, such as the patient's current location of pain and a perceived level of pain in each location, patient's current or previous injury, patient's exercise or activity schedule, and a postural analysis or structural analysis of the patient, be noted in conjunction with their self-manually run live session program, to be stored in memory and give appropriate context for AI data analysis and machine learning. The data from the therapist program can be used for machine learning purposes, including learning from the paths and anatomical locations on the patient's body the therapist chooses for therapy, as associated with the therapist's input of the patient's current location of pain and perceived level of pain in each location, patient's current or previous injury, patient's exercise or activity schedule, and a postural analysis or structural analysis of the patient. The paths and locations of anatomical locations for the patient can also be stored in memory in relation to the Cartesian coordinate position of the paths and anatomical locations in space relative to the patient's position during the therapy session.

The patient's current location of pain and perceived level of pain in each location, patient's current or previous injury, patient's exercise or activity schedule, may be input by the patient through a display application on the graphic user interface 108 or through a smartphone application on a user's smartphone. In addition, a postural analysis or structural analysis of the patient 113 may be provided by the system 100 to the patient through input to the system from image sensors 130, 131, and 132, all of which may be provided to a therapist prior to a live therapy session with a therapist or prior to a recommendation from the therapist for a user to select a predefined program provided by the system. In this case, the patient provides input to the graphic interface 108 or a smartphone application, and the image sensors 130, 131, and 132 may provide input to the system, which the system AI will analyze and the system AI will output a diagnostic therapeutic program for the patient, without a therapist input. The system AI have a pre-programmed diagnostic output for each the patient input parameters.

After a pain reference location is selected, the patient will have an option to grade their level of perceived pain, such as using a scale of 1 out of 5 or 1 out of 10, for example. The pain level grade adds input data context to the location of the pain and provides a prioritization for the AI system diagnostic output when multiple pain reference locations are selected. After the patient input data is input and analyzed by the system, the therapist can access the input data and AI system diagnostic output through the network 190.

The therapist can use their professional analysis to determine if they agree with the AI diagnosis, and if the therapist would make any changes to the AI diagnosis. This means the therapist can approve of the AI's diagnosis or augment the diagnosis and provide an input reason for the change. Then, the patient can be provided the new input from the therapist as an updated diagnostic therapeutic program recommendation in combination with the AI system recommendation. This would not be for purposes of a ‘live’ session with a therapist, but rather for the user to have a human professional provide input on their AI system diagnostic therapy programs. All of this data can be analyzed by the AI machine learning system to improve the diagnosis process.

If the patient and therapist are performing a ‘live’ session, the patient and therapist can have real-time audio communication through microphones on patient device and therapist device. The patient microphone may be leveraged through a smartphone application on the patient smartphone or graphic user interface 108. The patient may have visual access to the therapist through the graphic user interface 108 or through application on their smartphone, and the therapist will have visual access to the user's through the system's camera image sensors which may include 130, 131, or 132, so the therapist can see the location of the device support 104 and attached device 101 while in contact with the patient's body.

The therapist can communicate in real-time with the patient to confirm that the patient data inputs are correct. The therapist can input any necessary changes, including changes to patient input data, as well as adding new pain locations, including new “trigger point” locations in real-time. Trigger point locations can be remembered by the system in terms of their Cartesian coordinate position in space relative to the patient's position during the therapy session. Trigger points and their locations can also be remembered by the system for AI diagnostic therapeutic programming purposes. The therapist can then use their professional judgment to self-manually control or run the ‘live’ therapy session for the user they deem to be most beneficial. The therapist may have designated controls on their therapist device which includes control of the patient's device's X-axis motion, Y-axis motion, Z-axis motion (pressure exerted), through control of actuators 120, 121 and 122 and movement of support members 102c, 102b, and 102d and control of device support 104 including speed of amplitude of the percussion massage device 101 (if percussion massage device is the used therapeutic device). The therapist may also be provided real-time feedback of pressure sensor 301 data, and visual data from image sensors 130, 131, and 132.

Live therapist session data can then be stored in memory and accessed by the network 190 and used for AI analysis and machine learning, and the data can also store to memory for access by the patient at any future point to repeat the session's paths and locations on their patient device. This means that the AI will learn from the therapist run session, but the user will also have access to repeat the exact therapist run session an infinite number of times as the session data will become a part of their library of therapy programs.

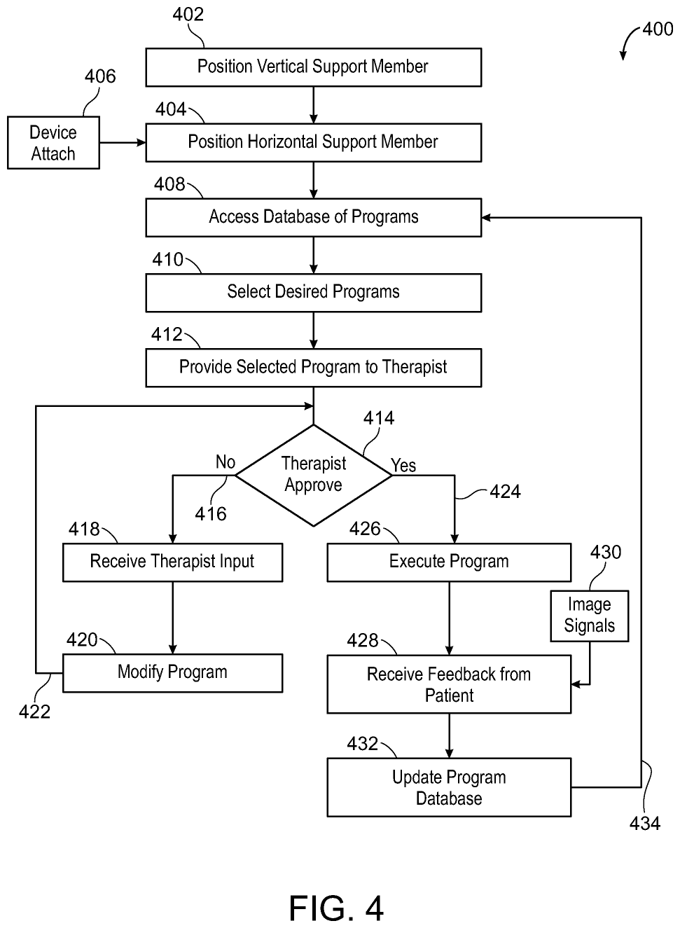

FIG. 4 illustrates a process 400 to implement an embodiment of the disclosure. The vertical support member is placed into a first position 402. This position may be relative to a table and/or placed in a track, rail or linkage to permit desired motion of the vertical support member.

A horizontal support member is positioned relative to the vertical support member, 404. A device may be attached to the horizontal support member, 406.

A patient can access a database of massage therapy programs, 408 and select one or more desired massage therapy programs, 410.

The selected massage therapy programs are provided to a therapist, medical personnel, personal trainer, or other third party, 412.

A determination is made whether the therapist, medical personnel, personal trainer, or other third party approves of the selected program, 414. If not, “no” 416 shows that the therapist, medical personnel, personal trainer, or other third party provides input to the selected massage program, 418. The selected massage program is modified, 420 and the modified massage program is reviewed, 422 and approval is sought, 414.

Once the selected, or modified, massage therapy program is approved, “yes” 424 shows that the massage therapy program is provided to the patient, 426.

During execution of the massage therapy session to the patient, the patient can provide feedback to the algorithm, 428. The patient feedback can include, or be based at least in part on, image signals 430, which may be obtained from image sensors.

The massage therapy program can be updated based on the feedback from the patient and/or image data, 432. The updated massage therapy program is provided to the database of programs, 434.

In an embodiment, a live session feature is available to the patient's own personal contact network, leaving it up to the individual to schedule through their contact network to connect together through the display application. When a user does not have a personal contact network, there may be a virtual network, which may include physical therapists, licensed massage therapists, or personal trainers for example, who are willing to be included within a network provided for access by the patient, to include times of availability that a user could book a session remotely.

In this embodiment, a patient could choose to book a session and have access to a list of available times for their desired date and availability, and a list of therapists who have listed times they are available on that specific date. The user could choose to schedule a session and that professional would be notified that a session was just scheduled within their available listed time on that date.

Further, a patient may not have a personal network and may desire a live remote therapist session. However, it may be a spur of the moment that this individual only has availability within the next hour. There may be a network of therapists: physical therapists, licensed massage therapists, personal trainers for example, that may leave themselves available for these types of spur of the moment bookings. Typically, therapists may be vetted by submitting proof of their professional certifications in order to be included within the network offerings. The therapist may assume responsibility for the safety of the user. This is similar to walking down the street and seeing an establishment that offers therapeutic massage, and going in to see if there is availability for a walk-in session, but in this case, the walk-in session would be remotely from the comfort of the user's home, and the establishment would be one of potentially many therapists in a virtual marketplace.

In this embodiment, a network of therapists may be considered employees. However, there may be an agreed upon fee for both the user and the network of therapists to have access to a therapist marketplace. In this sense, the network of therapists would not be considered employees, but after paying a fee to have access to the marketplace, could offer their services for a price of their choosing and availability of their choosing. The therapists may be reviewed with a rating system for quality of performance. Then, the user can make an informed decision based on factors such as therapist credentials, availability, rating, and price when they scan the marketplace to book a live session outside of their personal network.

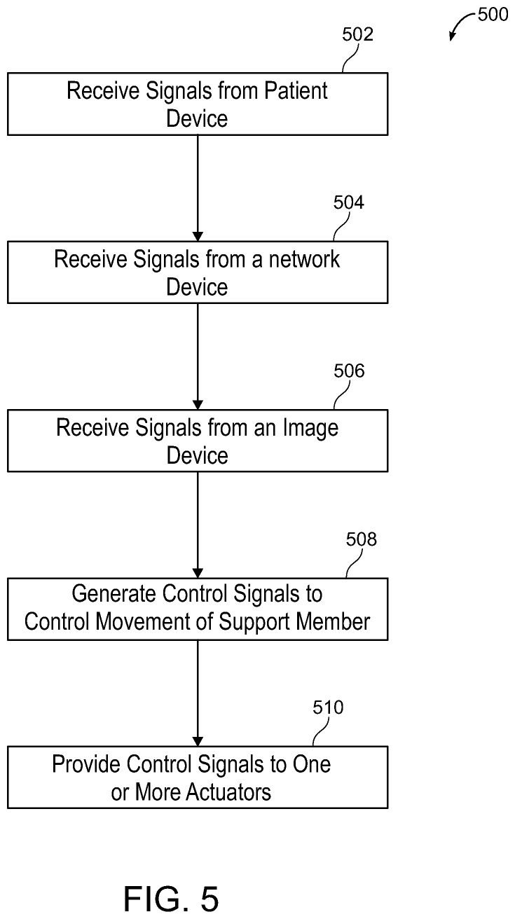

FIG. 5 a process 500 to implement an embodiment of the disclosure. This process 500 may be executed by one or more processors, servers, controllers or another suitable device or computer. A patient, using a patient device, such as a GUI, or remote control, or other input device provides signals to a server, or controller, or processor, which are received at the processor from the user, 502. A network device, such as a therapist device, AI computer, server, or other connected device generates signals and provides those signals to the server, controller or processor, 504.

An image device, such as a sensor, or other imaging camera generates image signals and provides the image signals to the server, controller or processor, which are received from the image device by a processor, 506.

The server, or controller, or processor generates control signals to control movement of one or more support members (shown herein as 102b, 102c, 102d with actuators 122, 120, 121) based at least in part on the signals received from the patient device, signals received from the network device and signals received from the image device, 508.

The server, or controller, or processor provides the control signals to one or more actuators operably coupled to one or more support members, 510.

The memory and processor can utilize one or more artificial intelligence algorithms to generate body scan data points that are provided to the processor as input signals.

Alternatively, other machine learning protocols, or algorithms may be stored in memory and processed by processor. Artificial intelligence algorithms may be stored in a memory accessed by network, such as a server with neural network (NN) program code storage, convolutional neural network (CNN) program code storage, recurrent neural network (RNN) program code storage and provided to therapist device.

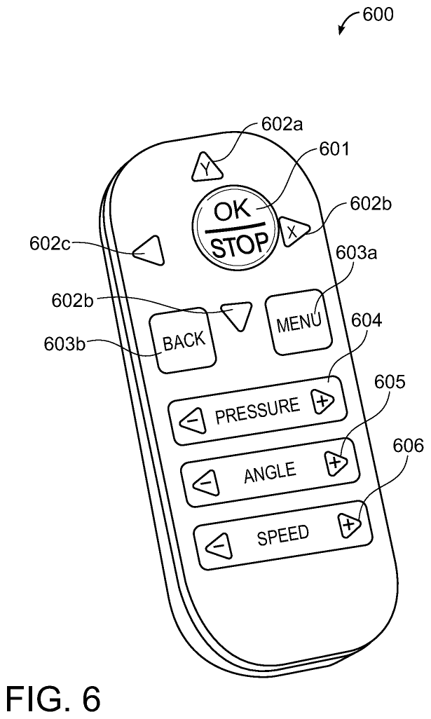

FIG. 6 shows an image of a user controller 600. User controller 600 may be a remote-control device operated by a patient 113 during a therapy session. The user controller 600 may be a remote-control unit such as, for example, an IR control unit similar to a TV control unit and data can be input to processor(s) 150, 153, 154, without having to press video screen or GUI 108. Data is input and provided to a selected processor 150, 153, 154 by a patient operating the user controller 600. The user controller 600 may have inputs that permit a user to input control commands, which are received by a processor 150, 153, 154 to modify the operation of the vertical support member 102d, the horizontal support member 102b, and Y-axis support track 102c. It may also provide control signals to control operation of device support 104 and attached device 101.

The user controller 600 may contain operational controls for the therapy system 100. For example, it may contain “OK/STOP” button 601 to allow the user to make a selection on the GUI 108, or stop the operation of the therapy system 100 any time. Further, the user controller 600 may contain directional arrows 602a-d to control the placement of the therapy device by controlling the appropriate actuators to move the appropriate frame members. The controller may also contain menu controls 603a-b in order to allow the user to interact with the GUI 108. The controller 600 also contains user controls to adjust the pressure 604, the angle 606, and the speed 606, of the therapy device 101.

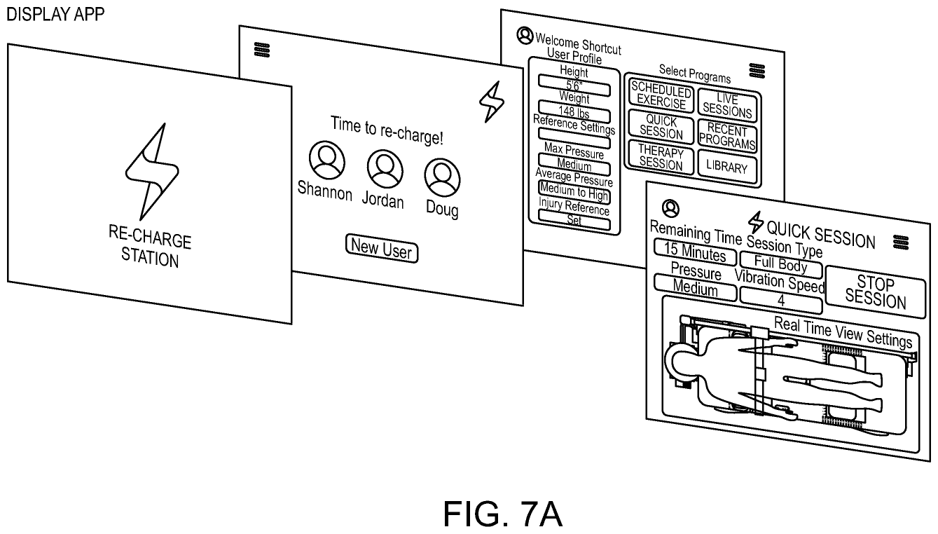

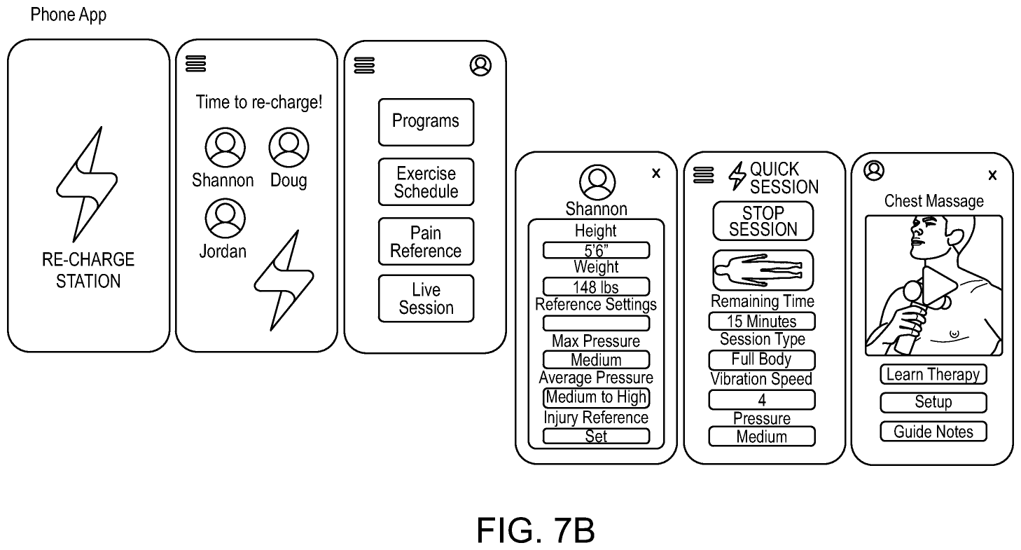

FIG. 7A shoes an example of the GUI 108 touch screen display application; alternatively, FIG. 7B shows that the GUI 108 display and interface may be accessed via a smartphone application. The patient input data may be provided to the network throughout the GUI 108.

GUI 108 is a graphical user interface, operably coupled to the processor 150 and controller 600, processor 153 and/or processor 354. The graphical user interface 108 is configured to receive input from a user via touch screen or controller 600 and display data from the therapist device 160 and/or network device(s) 159, to generate control signals based at least in part on the user input and the data received from the network device 159 and therapist device 160, the control signals transmitted to the processor 150 to control operation of the first actuator 122, the second actuator 120, and third actuator 121.

The GUI 108 may include video display screen, such as a flat panel display, which can display image data to the patient. The GUI 108 may be interactive with input controls for the patient, including input data defining which regions of the person's body are to be massaged and in what sequence the regions are to be massaged. The user may modify a therapy program in real-time by sequentially pressing on corresponding regions of the GUI 108.

By choosing from among the various templates and options provided by GUI 108, the patient can specify a massage “program” to applied to his or her body. For example, the patient might choose to have his or her full back massaged, and in real-time, during the massage program, can specify a location to focus on their lower back specifically, by sequentially pressing on corresponding regions of the GUI 108 which can also be input from remote controller 600. The patient may also be provided with multiple options for specific massage motions which may be selected by pressing the GUI 108 or input from remote controller 600, for their specific region or muscles of their choosing, including motions parallel to the muscle's direction of orientation, parallel motion which may include increased pressure while moving towards the muscle's proximal attachment and decreased pressure while moving towards the muscle's distal attachment or vice versa, or cross-sectional motion perpendicular to the muscle's direction of orientation. The user may also use the GUI 108 to input a location of a trigger point on a specific muscle or region location while the massage is being performed. Exact trigger point locations, including the location in Cartesian coordinate space relative to the position of the patient can be stored in memory, and analyzed by the system for diagnostic therapeutic programming.

The GUI 108 can be attached to, and therefore can be moved and positioned by positioning lever 109 so that it is easily accessible to a patient 113 whether lying prone or supine face up or down.

An embodiment includes using a number of predefined human three-dimensional (3D) models provided to the system. The human 3D models have body scan data points used to identify exact locations of skeletal structure and key skeletal muscle groups, relative to the locations of body scan data points in Cartesian coordinate space for the predefined models provided to the system. According to the system, these predefined models are defined in terms of using 3D scanning techniques of multiple subjects in order to create 3D cloud data points for each subject. The 3D cloud data points are used to identify anatomical locations of skeletal structure and skeletal muscles which are assigned to the locations of the cloud data points for each subject model, which are provided to the system as predefined models. These predefined models typically include multiple subjects, of different heights, weights, ages, sexes, bodyfat type, lean body mass type, and ethnicities. The number of predefined models may increase over time and updated to the system and the system's use of associated algorithms.

In an embodiment, a patient enters their input data of height, weight, age, sex, body fat type, lean body mass type, and ethnicity using the GUI 108 or smartphone application and the input data will be provided to processor 150. The input data will closely match the patient to the category of predefined model that most closely matches the patient input data, and the patient will be assigned that predefined 3D model. An algorithm, based on human statistical averages, will “skew”, or “stretch” or “compress” the predefined model 3D cloud point model to more closely match the exact patient input data. This algorithm will create a “new predefined model” which is a more tailored 3D cloud point model specific to the patient's input data of height, weight, age, sex, body fat type, lean body mass type, and ethnicity.

In an embodiment, adhesion marking placed on an instructed location or multiple locations on the patient's body can provide one or more data points to the processor 150, including exact Cartesian coordinate position of the adhesion marking in space. Typically, instructed locations of adhesion marking placed on the patient's body will apply to certain anatomical locations in Cartesian coordinate space, which will be used as data points provided to the processor 150. Positioning reference cushions 105a-b and 106a-b, may also be adhesive to the table 103 and contain within the cushion a sensor providing a location of the positioning reference cushion to the processor 150 to provide more data of the patient's exact position or pose on table 103. The positioning reference cushions may also be adhesive to the table 103 with identifying indicia, shown by 210 and 211, which requires input of identifying numbers of the positions of positioning reference cushions 105a-b and 106a-b, which may be input using GUI 108, which can be used to provide data of the patient's exact position or pose on table 103, but without the use of sensors contained within the reference cushions.

In an embodiment, image sensors input data from 130, 131, and 132, provided to processor 150, may also be used to further update the “new predefined model”.

Image sensors 130, 131, and 132 are sensor devices configured to obtain electronic images of a patient before and during a therapy session. The image sensor 130, 131, and 132 can be used in conjunction with adhesion marking to provide one or more data points to the processor 150, which may be used as input signals to the processor 150. The image signals obtained from image sensors 130, 131, and 132 may be transmitted to remote device 159 and/or therapist device 160, or other location, via network 190. The image sensor signals may be used as input to an artificial intelligence algorithm to generate body scan data points, which may be used to update the patient's 3D cloud point model, that are provided to the processor(s) 150, 153, 154 as input signals. The image sensor signals may also be provided to GUI 108, as described herein.

The image sensor data signals may be used to generate a 3D map of the position and features of a patient's body during a therapy session. The image sensor signals may be used to generate the 3D map and/or generate a motion template stored in memory. The signals, 3D map, and template may define a sequence of desired regions of the patient's body to be massaged and/or desired massage motions to be applied to regions of the patient's body. The program is also modifiable while the patient is receiving the massage therapy session. The image sensor can determine, for example, a location of the upper back of a patient. This may include anatomical landmarks such as the spinal column, neck and trapezius muscles. The control and/or operation of the vertical support member 102d, horizontal support member 102b and Y-axis support track 102c, may cause a specific massage therapy type to be applied to different size areas on the patient's body and different amounts of pressure.

Image sensor data of body scan data points may include structural skeletal locations of the patient's body which may include: head; shoulders; shoulder gridle and scapula; elbows; wrists; spine; tailbone; hip girdle; pelvic girdle; hips; knees; ankles; or any combination thereof.

In an embodiment, image sensor data of body scan data point locations of skeletal structures of a patient's may be used for the identification of skeletal muscle groups that originate or insert to the skeletal structure locations, relative to the body scan data points.

In an embodiment, one of the image sensors, preferably 131, or 132, which have views of the patient while on table 103 that are unobstructed by frame 102, may use 3D scanning techniques such as LiDAR to scan the patient body and create a 3D point cloud of the patient's body. LiDAR point clouds of patient body scans consist of triangulated mesh of multiple vertices or points.

In an embodiment, 3D scanning techniques such as LiDAR can be used for scanning multiple subjects of different sizes, identified specific to their age/sex/height/weight/body type/ethnicity. These subjects' cloud data points may be defined relative to their specific anatomical locations of skeletal structure and skeletal muscles. These subjects may make up a list of 3D models to represent a broad category of predefined models, which may be used as predefined models which are skewed to closely match a patient's input data to the GUI 108 of their age/sex/height/weight/body type/ethnicity, using algorithms based on human statistical averages of human anatomical measurements that will skew the predefined model point data to more closely match the patient input data in order to create the “new predefined model”.

In an embodiment, a 3D scan may be taken for each therapeutic position for a predefined subject model, as well as a patient, including prone (face-down), supine (face-up), or side-lying on each side. A LiDAR scan can create cloud data points for each individual position based on the triangulated mesh vertices. With these cloud points, it is possible to identify and map the locations of the anatomy of key skeletal structures and symmetrical muscle groups' locations for each predefined model. Each defined location of skeletal structure and muscle group typically relates directly to the locations of the cloud data points in Cartesian coordinate space relative to table 103. These predefined models may be used to automatically identity specific muscle locations relative to the cloud data points.

In an embodiment, after a patient's input data to the GUI 108 of their age/sex/height/weight/body type/ethnicity, which using algorithms based on human statistical averages of human anatomical measurements, the processor will skew the predefined model point data to more closely match the patient input data in order to create the “new predefined model”, the patient may then be 3D scanned using 3D scanning techniques such as LiDAR, in the same therapeutic positions as the subject models, which will create a new model of 3D cloud point data that is specific to the individual patient. An algorithm, based on an iterative closest point model, will be used minimize the difference between what was the patient's “new predefined model” of cloud data points which was based on the patient input data to the GUI 108, and the 3D cloud data points of the new patient 3D LiDAR scan. The two clouds of points, the predefined cloud versus the patient 3D scan cloud, will be closely matched using an algorithm based on an iterative closest point model, in order to more closely identify the exact locations of anatomical structure and individual muscles specific to the individual patient.

In an embodiment, predefined models and new users are scanned on a therapy table 103, and the scanner may be image sensors, preferably 131 or 132, which could be positioned above the patient. The table 103 could serve as a scale reference background to create a very ‘clean’ scan with no ‘noise’ to obstruct the scan, which can be used to create very precise cloud points for the system to identify. Other methods for 3D scanning of a human subject, such as a person standing in a room, may create cloud points that are less precise due to multiple objects in the room creating ‘noise’ during the scan, for example.

Results of a 3D scan may also be affected by certain types of clothing, for example, loose fitting clothing, which may lead to a recommendation or disclaimer provided to the patient, that tight fitting clothing, such as the type of tight-fitting clothing designed for exercise, would lead to more accurate scans and program automation.

In an embodiment, massage therapy programs are designed for the predefined 3D models based on their cloud points in Cartesian coordinate space. The massage therapy programs are designed to move the attached device, 101 for example, in contact with the patient's individual muscles from their proximal and distal attachments, as well as entire fascial lines, which are series of muscles that are closely connected through connective tissue. The programmed movement of the massage therapy device in order to contact individual muscles and fascial lines is based on the identification of anatomical structures, bone landmarks, individual muscles, and fascial lines which are defined relative to the cloud points of predefined 3D models in Cartesian coordinate space. As the predefined 3D model is skewed to match the patient input data, so too is the programmed motion path. Likewise, as the predefined model is further skewed to match the input of image sensors, so too is the programmed motion path.

In an embodiment, data is collected on the “plus-or-minus” (+/−) error ratio of the new massage program path of the updated predefined model based on the patient 3D scan input provided by image sensors 130, 131, or 132, compared to the massage program path that was determined based only on the patient input variables to the GUI 108. This error ratio data, which provides context on the accuracy of methods for defining anatomical locations of an individual patient, may be analyzed for machine learning purposes to improve algorithms over time.

In an embodiment, pre-defined 3D models are programmed to correlate to approximately 21 individual muscles (right or left) that are considered relative to the posterior side of the body, and approximately 16 (right or left) individual muscles that are considered relative to the anterior side of the body. These individual muscles are symmetrical to the skeletal structure of the right and left sides of the body, which will equate to a total of 42 posterior individual muscles and 32 anterior individual muscles. Certain individual muscles and anatomical structures are oriented closely to the lateral sides of the body, including for example, portions of the latissimus dorsi, serratus anterior, external oblique, tensor fascia latae, gluteus minimum, gluteus medius, illiotibial band, and peroneals. Lateral muscles may require another axis of rotation which may be located within device support 104 for the attached device 101 to be rotated at an angle of 90 degrees to the right or to the left, or B-axis relative to frame 103, which is rotated by actuator 300 which is located within device support 104. Without the additional axis of rotation, lateral muscles can also be accessed by directing the patient to lay on their side. For purposes of approximate classification, the lateral muscles are identified as either posterior or anterior based on the portion of the muscle that is accessible by posterior or anterior therapy. Likewise, medial muscles of the inner leg such as certain adductor muscles would require an additional axis of rotation for access, or, alternatively, a direction to laterally rotate the leg to expose the adductor muscle to direct contact with the device.

In an embodiment, predefined models will include defined fascial line locations, which include a grouping of multiple defined individual muscles. Current research shows that an individualistic view of focusing only on single muscles is an altered view of the reality of the anatomical make-up of the tensile fascia tissue that encases every muscle in the body and makes up a fascial system from head to toe and provides structural integrity for the skeletal bones and muscles. One note, among many possible notes, as evidence of the fascial system's role in physical or massage therapy, is that there are six times as many nerve endings in the fascia that encases a muscle compared to a muscle itself, therefore, we ‘feel’ the fascia six times more than the individual muscle. We classify fascial lines and use terms of paths of orientation, which is defined as the direction the muscle is oriented, and then links to the next muscle that is oriented in a similar direction. These orientations can also be defined as deep or superficial. Defined locations of lines on predefined models include a superficial back line, superficial front line, front arm line, back arm line, lateral lines, spiral lines, deep core or underlying core, and functional back and functional front lines. Like the individual muscle locations that make up a fascial line, the locations are identified by the defined 3D cloud point locations.

In an embodiment, fascial lines will be identified and imposed on the body using 3D scan techniques and body scan data points to analyze the length of the identified and imposed fascial lines geometrically and in Cartesian coordinate space for diagnostic therapeutic programming purposes. In this embodiment, the distance of anatomical landmarks or body scan data points can be analyzed for geometric symmetry or asymmetry.

In an embodiment, during a portion of a massage therapy program, the therapeutic device will perform multiple paths back and forth while in contact with an individual muscle from its approximate proximal attachment location to its approximate distal attachment location on the patient's body, and may include a multitude of different therapeutic techniques, such as oscillations, for example. One feature of the total time of therapy on an individual muscle may include a focus on specific locations along the muscle that commonly correlate to fascial constrictions sometimes referred to as “trigger points” or “muscle knots”. Common locations of “trigger points” have been researched and documented as certain specific locations along a muscle's orientation and these specific locations will also be defined or predefined as a part of the predefined 3D model cloud points and be pre-programmed into massage therapy programs, as the common trigger point locations relate to the cloud point location in Cartesian coordinate space.

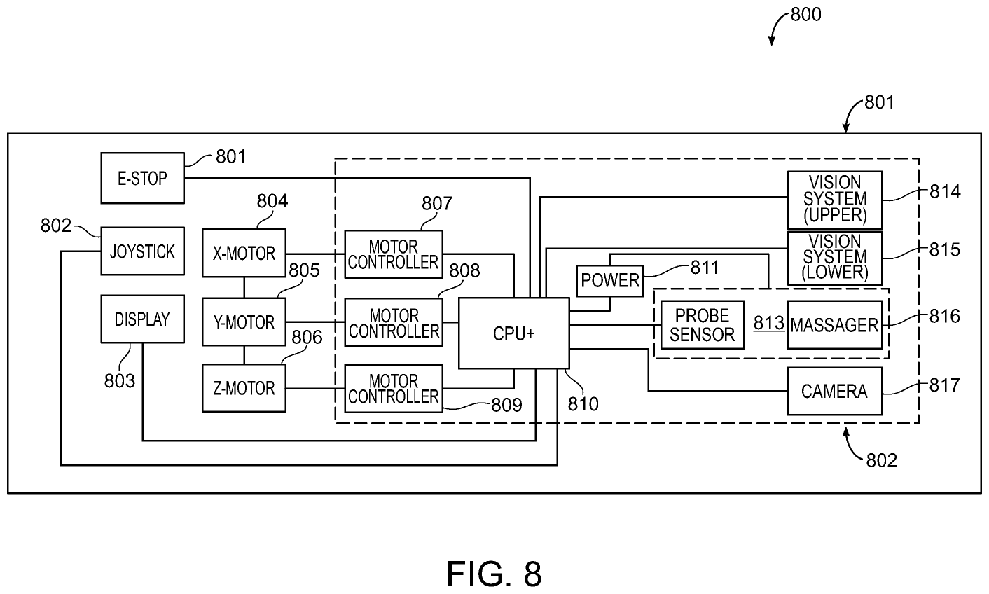

FIG. 8 shows a block diagram 800 of an exemplary software map for the therapy system 100. All components peripheral components of the system 100 are contained within the software map 801. All peripheral components are connected to the central computing system 802 within the system 100. Emergency stop control 801 is directly connected to the CPU 810. The user control joystick 802 is directly connected to the CPU 810. The display is 803 is directly connected to the CPU 810. The X-motor 804, Y-motor 805, and Z-motor 806 are connected to their respective motor controllers 807, 808 and 809, which connect to the CPU 810. Power 811 is provided to the CPU 810 as well as both the probe sensor 813 and massager 186, which are in turn connected to the CPU 810. Upper and lower vision systems 814 and 815, respectively, are each connected to the CUP 810. The cameras 817 are also directly connected to CPU 810.

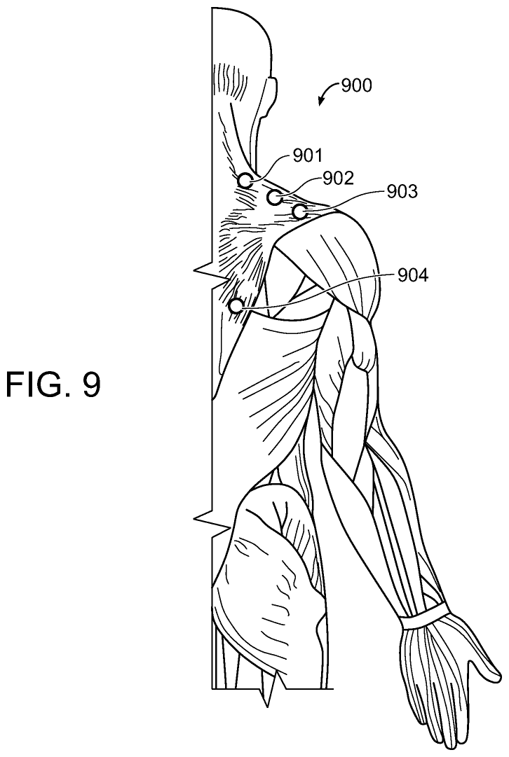

FIG. 9 illustrates a typical human muscle system for the trapezius muscle system 900, showing specific locations of trigger points 901, 902, 903, and 904 for the trapezius muscle.

In an embodiment, characteristics of a “trigger point” may include a hardness in the muscle which input data from the one or more pressure sensors 301 may provide a detection of a distinct change of pressure feedback to assist in identifying the specific locations of “trigger points” within individual muscles.

In an embodiment, another characteristic of a trigger point may include a specific location within the muscle of increased tenderness and pain, which the patient may at any point have the option to either confirm the predefined location as a trigger point based on a perceived level of pain grade which they may input using the GUI 108 or remote control 600, or add a new specific location along the muscle as a location of increased pain which the patient may input as a new trigger point location based on their perceived level of pain grade which the patient may input using the GUI 108 or remote control 600, the current location may be defined as a trigger point to be remembered by the system in Cartesian coordinate space for diagnostic therapeutic programming.

In an embodiment, another characteristic of a trigger point may be a referral of a patient's pain pattern that was associated with the individual muscle while on the trigger point location. Again, the patient or therapist may confirm or add the specific trigger point location using GUI 108 or remote control 600.

In an embodiment, another characteristic of trigger point therapy includes a relief of the pain after a given time of therapy on the specific location of the trigger point. Time of therapy on a specific trigger can be documented to be approximately 45 seconds of minimum time of ischemic pressure to elicit the physiological therapeutic response to unconstrict the constricted tissue. Pain relief can be documented by the patient and graded over time and input by the patient using GUI 108 or remote control 600. Pain relief can be noted and analyzed by the system as a source of progress and success of therapeutic sessions and programming. Pain is undoubtedly an important tool for diagnostic therapeutic programming and a measure of progress in therapeutic programming, but also undoubtedly relies on the patient's perception and input into the system before the system can use pain as a reference for programming and a parameter to evaluate.

In an embodiment, during a portion of a massage therapy program, the therapeutic device will perform multiple paths back and forth while in contact with an individual muscle from its approximate proximal attachment location to its approximate distal attachment location on the patient's body. During this time, the system will cue the patient to confirm a location of a trigger point using the characteristics described. Specifically, pain or tenderness along a portion of the muscle in contact with the device will be the main characteristic of focus that the system will cue the patient to give their input feedback on, via the GUI 108. In this embodiment, the GUI 108 may display a pre-recorded video and audio of a human therapist that is demonstrating the device in contact with the same muscle that the patient is receiving therapy on. In this embodiment, the recording of the therapist will cue the patient to enter if there is a location of pain or tenderness along the path of orientation of the muscle. This will be entered either by touching the screen of the GUI 108 or using the remote control 600 in order to coordinate a “cursor” on the GUI 108 in a manner to input the data. The therapist will specifically give the cue for the patient when the device location is on the predefined location of a trigger point for that specific muscle. The patient input of pain with a trigger point will be followed by their grading of the pain on a scale of 1 through 5, for example. The pain associated with the trigger point and the grade, which is input by the patient, is an important parameter which the system will use to contextually map the patient and which the system will use for priority in diagnostic therapeutic programming.

In an embodiment, the system may use LiDAR, and/or time of flight sensors, and inertial measurement unit in order to create loop closure when the system is identifying the exact location of the therapeutic device's contact with a patient during a massage program session. Image sensors 130, 131, or 132, preferably 131 or 132, may include LiDAR or Time of Flight Sensors. As the therapeutic device is moving autonomously, it may use a combination of LiDAR, time of flight sensors, and Inertial Measurement Unit (IMU) to know its previous locations, so as it is mapping the body of the patient on the table 103, it will recognize that a return to a previous location is not a “new location” along the traveled path. Therefore, it can ‘close the loop’ of its path in order to better understand the mapping of the individual patient and their current positioning on the table 103. This system can use lasers or near infrared for camera vision so light in the room is not a factor.

In an embodiment, the IMU provides physics measurements, for example, acceleration. If, for instance, there is an error in registration between two data points, the IMU provides data showing the acceleration and velocity in specific directions which can be used to show specific positioning locations. The Inertial Measurement Unit works together with the other sensors. The Inertial Measurement Unit provides an estimate of the location between two LiDAR cloud points or Time of Flight points, for example. The data collected from the IMU's sensors will allow the system to better track the exact device position relative to the patient.

In an embodiment, Simultaneous Localization and Mapping (SLAM) may also apply to the real-time tracking of the current location or positioning of the user. When a user is lying on table 103 and using the headrest 107, the user will likely be in a similar position for each session of use, and that position will likely stay relatively constant throughout the session. Positioning reference cushions 105a-b, and 106a-b which can be adhesive to the table 103, may be used to ensure the patient 113 is laying in a similar position on table 103. However, if the positioning reference cushions are not used, minor variations are likely to occur. A patient may move or adjust in certain ways when therapy occurs on further extremities such as the lower leg, for example, these variations of positioning need to be accounted for in order to provide accurate and consistent therapy.

In an embodiment, a Visual SLAM concept allows for any repositioning of a user to be accounted for in real-time and the current 3D positioning to always be taken into account by the system, especially without the use of positioning reference cushions 105a-b, and 106a-b. As with other data collected, the system can learn from simultaneous localization and mapping of patient's during operations of massage therapy programs to identify patterns and improve over time.

In an embodiment, the system will cue the patient to position themselves in certain positions which are beneficial for therapy on a specific individual muscle. For example, the adductors of the inner thigh may be contacted by cuing a supine patient to bend their knee and laterally rotate their hip to better expose their inner thigh. The adductors may also be accessed on a side-laying patient if the patient is cued to bring the knee of their top leg towards their chest, thus exposing the inner thigh of their bottom leg, for example, a patient laying on their left side may bring their right knee towards their chest to expose the inner thigh of their left leg. These are examples of how the system may need to coordinate its use of sensors for real-time repositioning of the patient and identification of the individual muscles the device is to contact with based on the patient position.

In an embodiment, visual servoing, or other robotic camera techniques, may be used as a method of controlling the X, Y, and Z motion using real-time feedback from image sensors. Visual servoing may include one camera using 2D vision or a bi-camera or stereo camera in order to provide 3D camera depth perception, which may include image sensors 130, 131, or 132. Computer vision methods can use patient features from the patients position on table 103, or other potential location of therapy, and determine how the therapeutic device should move in order to reach the desired location on the patient's body. Kinematic models including concepts of inverse kinematic and forward kinematic solvers can be used with a visual servo method.

In an embodiment, visual servoing can be used with a proportional integral derivative controller as a control loop mechanism using system feedback that continuously calculates an error value as the difference between a desired point and a measured process variable and applies correction based on proportional, integral, and derivative terms. This applies an accurate and responsive correction to a control function. For example, a desired speed or acceleration is programmed by the system to move the therapeutic device from one point to another while in contact with a patient, but friction from the patient's clothing slows the desired programmed speed, the proportional integral derivative control algorithms restore the movement of the therapeutic device to the desired speed with minimal delay and overshoot by increasing the power of the actuators in a controlled manner in conjunction with the visual servo method. The AI Machine Learning could improve these functions.

In an embodiment, one or more image sensors, such as 131 or 132, may allow for an eye-in-hand configuration for visual servoing. This configuration would position one or more image sensors in close proximity to the device support 104 which may be referred to as end-effector mounted image sensors.

In an embodiment, visual servoing may use a single camera, a stereo camera, LiDAR, or Time of Flight Sensors, or a combination of these, in order to improve the device's contact with targets on the patient's body during therapy.

Embodiments which may include the described one or more image sensors use include the frame 102 attached to a therapy table. Another embodiment may be a stand-alone frame that may be smaller in length and oriented to attach to stable mounts on the floor in order to stand alone and may include the ability to re-orient the device support 104 and attached device so the device contact point may face towards the floor, perpendicular to the floor, or towards the ceiling. In this embodiment, the device re-orientation would enable laying therapy underneath the frame, seated therapy in front of the frame, or seated leg rest in which a patient would position their leg above the frame with the device oriented towards the ceiling in order to perform seated posterior leg therapy, all of which may be performed with the same stand-alone frame when the device support is re-oriented. In this embodiment, other stable objects such as a bed frames, chair frames, door frames, or exercise frames such as squat racks, may be used as stable objects the stand-alone frame may be attached to by the patient for multiple positions of therapy. Other embodiments include seated chair embodiments and reclining bed embodiments. These embodiments may use the one or more image sensors as previously described to improve operations of the device contact with target locations on the patient's body for therapy.

In an embodiment, a combination of visual servoing, a fixed scale background of therapy table 103, and a relatively still patient, which may or may not be assisted by positioning reference cushions, will allow for relatively simple algorithm calculations that will enable relatively accurate therapy for the patient. In this embodiment, the patient's head will be positioned within the therapy table headrest 107 for prone, supine, or side-laying therapy. Amongst these positions, the head will be positioned within the headrest 107, which may tilt up at an angle to better accommodate supine or side-laying positions, almost identically each time the patient positions their head into the headrest for these therapeutic positions. As the head is positioned in an identical position, so too will the patient's torso as the connection of the head through the spine will relate to an identical torso position relative to each therapeutic position. The system may cue the individual for position of their extremities for better operation and identifying the target for contact of the device on the 3D structure of the patient. However, the frame of the human body, including the rectangular nature of the torso's relationship between the shoulder girdle and pelvic girdle, as well as the cylindrical nature of the legs and arms, allow for ease of pattern recognition and target recognition for the system to identify in order to allow for relative accuracy of therapy as well as improved accuracy relative to the individual patient and their 3D structure over time.

In an embodiment, the use of visual servoing, and/or simultaneous localization and mapping, will be used to better map the 3D structure of the patient and better learn the patient over the course of time of operation with the individual patient. Essentially, with continued operation, the system will better map the 3D structure of the patient, improve operation of contact with that 3D structure, including accuracy of contact with a specific target or series of targets. Machine learning protocols, or algorithms may be stored in memory and processed by processor, artificial intelligence algorithms may be stored in a memory accessed by network, such as a server with neural network (NN) program code storage, convolutional neural network (CNN) program code storage, recurrent neural network (RNN) program code storage, using the data acquired during operation with a patient, including all data related to visual servoing or simultaneous localization and mapping, in order to improve operations with and better understand the patients 3D structure over time.

In an embodiment, machine learning protocols, or algorithms may be stored in memory and processed by processor, artificial intelligence algorithms may be stored in a memory accessed by network, such as a server with neural network (NN) program code storage, convolutional neural network (CNN) program code storage, recurrent neural network (RNN) program code storage, using the data acquired during all operations. The network will access all data from the use of every operation, disclaimed to and agreed upon by the individual patient, of every device in connection to the network, in order to analyze a large amount of data to better understand the 3D structures of all humans and operations of the device with humans in general.

In an embodiment, the one or more pressure sensors 301 will also provide feedback loop. This allows running of a therapy program with a predetermined baseline constant pressure of 5 lbs of contractile force, for example. The original predetermined massage program path would be designed for the constant baseline of 5 lbs of contractile force, as an example, to determine the vertical support member 102d Z-axis path in Cartesian coordinate space relative to the patient 113. Then, the real-time feedback loop from the pressure sensors 301 will acquire data and +/− ratio to improve and correct the Z-axis motion path needed to maintain the 5 lbs of tactile force with the patient during the running of the massage program's motions. The real-time pressure feedback will alter the massage program in real-time to maintain the baseline constant pressure throughout the massage program while acquiring data for machine learning to improve performance over time.

In an embodiment, data will also be acquired based on needed corrections to maintain determined motion path and acceleration and velocity of horizontal support member 102b X-axis and Y-axis support track 102c Y-axis motions for machine learning.

In an embodiment, during the massage program, the patient may have the option to input a higher or lower pressure setting. For example, to maintain a constant of 10 lbs of tactile force instead of 5 lbs throughout the massage program which the patient may input using the graphic interface 108 and/or remote controller 600. The feedback loop can provide data that compares the original Z path altered to the an current Z path which allows for the 101bs of constant sensed pressure.

The new pressure setting will also provide data on the +/− ratio to the original X and Y motions and speed of motions i.e., a higher pressure setting would likely encounter higher resistive force against the programs X and Y motions resulting from increased friction and feedback of anatomical bony landmarks—certain articles of clothing would also create a certain friction profile, polyester vs cotton, loose fitting vs tight fitting, clothing vs bare skin, specifications of which may be disclaimed to the user.

In an embodiment, anatomical bony landmarks are associated with the predetermined and generated body scan data points that are used in the design of the predetermined therapy program. The so called anatomical bony landmarks are anatomical locations of the human body that have minimal subcutaneous muscle and therefore less Z motion path before the pressure sensed feedback contact profile of hard bone vs a softer muscle. The bony landmark can give a pressure feedback profile that is unique compared to a large muscle, for example.

In an embodiment, due to the unique pressure feedback profile, data can also be acquired on the location of the bony landmarks and body scan data points and their generated location based on all of the previously described input, vs the location of the real-time pressure feedback profile associated with the bony landmark and how the X, Y, and Z location of the pressure feedback profile relates in a +/− ratio in order to provide further data for machine learning to improve performance over time. This data, the alterations to the programs path, will also take into account the amplitude of the gun, the user can input selection of higher or lower speed to the amplitude of the therapy device, such as a percussion gun, in real-time, which would have an effect on the +/− ratio of program motions X, Y, and Z and sensed pressure—data acquired for machine learning.

In an embodiment, the one or more pressure sensors 301 may be used to provide feedback for certain therapeutic techniques. One such technique would be a series of a contractions of a muscle while in contact with a therapeutic device, which would be followed by a relaxation of the muscle. This technique is sometimes used as a muscle activation technique to be employed before the start of a workout or physical activity session. In this example, a contraction of a muscle would yield a harder pressure response, measured by the pressure sensor 301, which would be followed by a lower pressure response during the relaxation of the muscle. During this specific technique, the goal of the system would be to maintain a similar pressure feedback during both the contraction phase and relaxation phase. This scenario entails a similar continuous feedback loop that would be distinct from other program operations, and this data can be analyzed by AI machine learning to be improved over time.

In an embodiment, another therapeutic technique that can benefit from input data provided by pressure sensor 301, would be while therapy is performed on a patient 113 muscle's orientation, an increased pressure would be exerted towards the muscle's proximal attachment, while a decreased pressure would be exerted towards distal attachment. Likewise, while therapy is performed on a patient 113 muscle's orientation, increased pressure would be exerted towards the muscle's distal attachment, while a decreased pressure is exerted towards a muscle's proximal attachment. Such a technique may be used with a structural analysis to bring a muscle where you want it to go to on order to improve the skeletal geometry. As in, a short front fascial line may round the upper spine and shoulders forward, it is necessary to lift the muscles of the front fascial line by focusing on increased pressure towards a proximal attachment and decreased pressure towards the distal attachment. Likewise, the upper spine and surrounding musculature needs to be pulled down by focusing on increased pressure towards a distal attachment and decreased pressure towards a proximal attachment.

In an embodiment, a general massage therapy program for pre-workout may include structural improvements to fascial lines or active release techniques. Active release techniques involve a focus of time on specific trigger point locations, while the patient is directed to move the joint associated with individual muscles that is receiving trigger point therapy. For example, a patient is receiving trigger point therapy on their hamstring muscle, the system directs the patient to slowly bend and straighten their knee while the device is in contact with the specific trigger point location. The pressure sensor 301 may provide input data feedback in order to maintain a certain amount of pressure while in contact with the patient's trigger point location while the patient is moving the joint associated with the specific trigger point location.

In an embodiment, characteristics of a “trigger point” may include a hardness in the muscle. Input data from the one or more pressure sensors 301 may detect a distinct change of pressure feedback to assist in identifying specific locations of “trigger points” within individual muscles. Specific to the use of a percussion massage gun as the therapeutic device used in contact with a hardness of a trigger point, the percussion massage gun may experience a rebounding or a recoil effect. This may occur when the percussion massage gun comes in contact with a hard surface including a trigger point or bone landmark. The rebounding or recoil effect may be seen as a higher bouncing of the contact point of the percussion massage gun off of the specific location on the patient's body. This distinct bouncing or recoil effect will also give a distinct pressure sensor feedback profile, which may be input data from 301, which will result in an adjustment by the system to decrease the pressure of the device in contact with the patient by moving the Z-axis in order to minimize the recoil effect. The recoil or bouncing effect is counterproductive to the patient therapy and may potentially have an effect on the system frame 102. The trigger point pressure feedback profile and recoil effect is unique to percussion massage gun therapy, which can be identified by the system. The system will remember bony landmark locations in Cartesian coordinate space and will know that the recoil feedback profile can identify a trigger point when in contact with an individual muscle orientation path, not when in contact with the bony landmark locations.

In an embodiment, time of therapy on a specific trigger can be documented to be approximately 45 seconds of minimum time of a certain amount of pressure from the therapeutic device in contact with the trigger point, during which time, input data from one or more pressure sensors 301 may be provided to the system, in order to elicit the necessary physiological therapeutic response for the patient.

In an embodiment, pain relief experienced by the patient 113 is an important input parameter which will be used in part as a determination for the necessary physiological therapeutic response for the patient, which may be input by the patient on GUI 108 or smartphone application and graded over time. Pain relief input may be stored in memory and analyzed by the system as a source of progress and success of therapeutic diagnostic techniques, and diagnostic therapeutic programming.

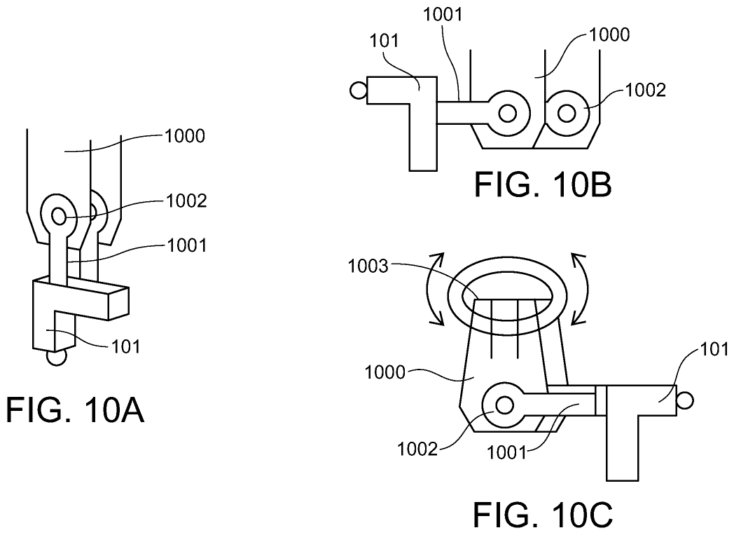

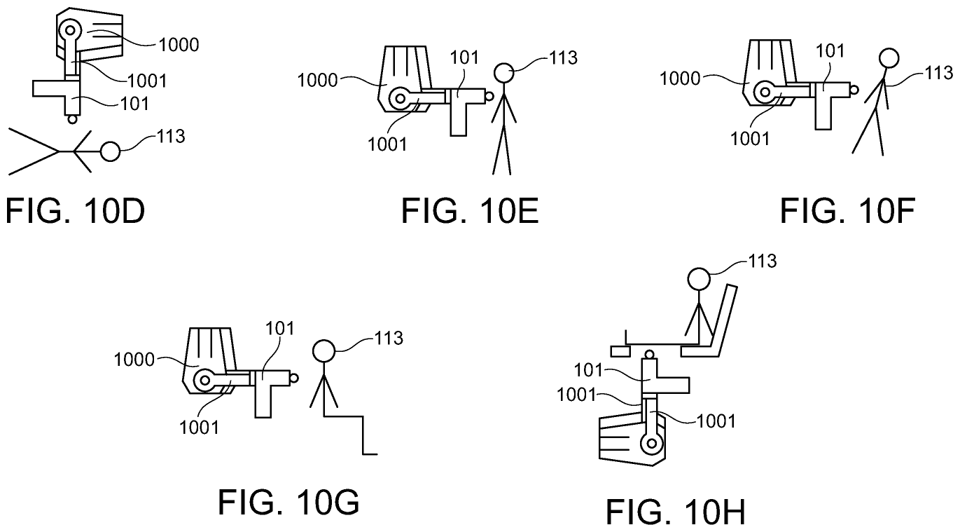

FIGS. 10A-10H illustrate a view of lever device attachments between the therapy device 101 and the frame 1000 via arms 1001 which is used as an example for adding additional axis of rotations. Arms 1101 are coupled to the device 101, and are attached to the frame 1001 via an attachment mechanism 1002, which allows for 90-degrees of articulation. FIG. 10B shows the device rotated 90-degrees. The device may be rotated using manual or mechanical levers. This rotation permits multiple angles of contact with the device on the patient's body. These additional axes of rotations may also be used to utilize the re-orientation of the therapy device 101 to point to the floor, perpendicular to floor, or to the ceiling which may be used to orient the device in a laying (FIG. 10D), standing (FIG. 10E), seated (FIG. 10G), side-laying (FIG. 10F), or footrest (FIG. 10H) therapeutic positions.

In these embodiments, a 4-axis system includes an additional rotation about one axis. When viewing lateral or medial therapy (inner side or outer side of the body), only a 90-degree angle right to left would likely be needed for effective therapy on the medial or lateral sides of the body. This would be considered the B-axis in relation to the system, which would allow for the lateral and medial parts of the body to be accessed while the user is in a single position. For example, a user is laying facedown, the system identifies the glute minimus as a key individual muscle to focus, rather than the user needing to lay on their side, the system can access the B-axis and turn the device to access the glute minimus muscle which is a predominantly laterally oriented muscle. Likewise, the system may identify the adductor muscles of the inner thigh as a key group of muscles to focus. Rather than the patient having to turn their leg out to show the inner thigh, the system can access the B-axis and orient the device to turn towards the inner thigh.

FIG. 10C shows an exemplary 5-axis system of the system of 10A and 10B, where a system would correlate to an additional rotation axis. In this example, with the patient 113 underneath the system and device, it would allow the rotation of the device to technically move from the previously described B-axis, accessing the medial and lateral sides of the body, and orient the B axis to what would equate to an A-axis. This would be done by an additional rotational point 1103. This may serve purposes of therapy on the top or bottom of a laying patient's body, onto the upper trapezius above the shoulders, or bottom of the feet, for example.

The orientations of the additional rotational axis 1003 may serve purpose for multiple systems of use and repositioning of the system and the patient for different modalities of therapy. This would apply to a patient being able to access multiple positions of therapy: laying (FIG. standing (FIG. 10E), seated (FIG. 10F), side-laying (FIG. 10G), or footrest (FIG. 10H), with the use of a single system. The orientations of the additional rotational axis may also allow medial/lateral therapy for the multiple positions of therapy with the use of a single system.

In an embodiment, a 6-axis system would allow a rotational axis in the A, B, and C, axis independently. The independent motion of each may allow for faster and smoother freedom of motion and change of angles of a therapeutic device. Each added axis of rotation would utilize an associated actuator.

Another embodiment of this disclosure is a remote control of the holster. In this embodiment, a remote therapist, or other remote operator may control operation of the instrument remotely. Thus, the remote operator can control the location, pressure and movement of the arms, as described herein as well as operation of the instrument, via the holster, from a remote location. Therefore, the holster provides local control as well as remote control, from a different location of the instrument.

According to this disclosure, the patient may control all of the vertical, horizontal, Y-axis support members, as well as the operational status of an instrument. The holster is device agnostic and may be customized to provide desired control of any suitable instrument mounted to the vertical arm 102d via the holster.

Alternatively, other machine learning protocols, or algorithms may be stored in memory and processed by processor. Artificial intelligence algorithms may be stored in a memory accessed by network, such as a server with neural network (NN) program code storage, convolutional neural network (CNN) program code storage, recurrent neural network (RNN) program code storage and provided to therapist device.

In an embodiment, the system will incorporate what amounts to an AI Therapist that is used to analyze a patient and provide a therapy program and strategy for therapy based on its system diagnosis.

In an embodiment, the system will use a combination of image sensor input and human input to output a diagnostic therapeutic program. In an embodiment, the system will use 3D scan input from image sensors 130, 131, or 132 for analysis. The system will also use input from the patient using GUI 108 or smartphone application. The patient input may include pain reference location and level of pain grade, prior injury location, and exercise or activity type for recovery. During operation of a therapy session, a patient may also input locations of pain and pain grade, which will be used by the system for diagnostic therapeutic programming.

In an embodiment, the system will analyze the input parameters in order to output a strategy that includes a prioritization of fascial lines and individual muscles to perform time of therapy on using a multitude of therapeutic techniques, which may be prioritized over several sessions, each session as a certain amount of time.

In an embodiment, when the system outputs an individual muscle to diagnose in a therapy program, that individual muscle will have pre-programmed list of associative muscle groups that we may define as a ‘Deeper Diagnosis’. The pre-programmed associative muscle groups will be based on muscles that are commonly affected by tightness, constriction, or damage relative to the individual muscle, in some cases, these commonly affected muscles are in close proximity to that individual muscle, and sometimes referred to as satellite trigger points.

In an embodiment, other pre-programmed associative muscle groups included in a ‘Deeper Diagnosis’ are muscles that share a path of orientation, sometimes referred to in terms of sharing a “fascial tissue connection”, or “kinetic chain link”, or fascial line. Muscle orientation can be considered based on its path of direction from its origin to insertion on the skeletal structure, and in this way, multiple muscles are oriented in succession to allow for full body motions and stabilization. Along with these orientations, the layer of the muscle can be considered, as well, meaning superficial (closer to the skin), or underlying (underneath a superficial muscle). Muscle groups along these paths of orientation can commonly affect one another, as well. These two sets of associative muscle groups will create the ‘Deeper Diagnosis’ to be pre-programmed for every individual muscle in order to keep the individual muscle diagnosed into the context of the whole-body system of the patient's body and to immediately expand on a potential treatment strategy beyond a single individual muscle. We will use general terms to identify these ‘Deeper Diagnosis’ associative muscle groups, such as: commonly affected muscles and paths of orientations. In this embodiment, the ‘Deeper Diagnosis’ gives the system a broader number of muscles that may be equally as important for the patient to receive therapy on as the individual muscle that was diagnosed.

In an embodiment, the strategy of the diagnostic therapeutic program will be evaluated based on improvements of the input to the system including to the analysis of the 3D scan, and the pain location and grade. In this embodiment, one or more of the image sensors, preferably 131 or 132, will provide an updated 3D scan of the patient that will be re-analyzed to show geometric improvements closer to the normal predefined model, which will be based on geometric symmetries. If improvement is not measured during an evaluation it will result in an update of the strategy. In this embodiment, the patient will update input to the GUI 108, or smartphone application, in which they will input the pain location and pain grade. If improvement is not noted on the previous input of the location and grade of pain, it will result in an update to the specific strategy involved, in order to better provide relief of pain for the patient. The evaluation of the strategy will be used for machine learning purposes, in order to improve strategies for diagnostic therapeutic programming over time. In an embodiment, evaluation of a strategy would call for a measured success within a completion of the diagnosed time period or diagnosed number of massage therapy sessions of a therapy program completed by the patient in order to properly evaluate the strategy.

In an embodiment, exercise recovery may be evaluated from human input, however, highly accurate evaluation of exercise recovery or the relationship between a diagnostic therapeutic program and exercise performance may require an application programming interface which would acquire data through network 190 from a patient exercise data tracking application. Otherwise, specific exercise data for evaluation of the diagnostic therapeutic program would rely on the patient input data to GUI 108 or smartphone application.

In an embodiment, the input parameters may be constantly updated based on updates from new 3D scan input and new patient input.

In an embodiment, the 3D scan data provided by one or more image sensors will be an analysis of the patient's 3D cloud points compared to a predetermined “normal” model. In this embodiment, the evaluation of the patient's 3D cloud point compared to a predetermined normal model will focus on geometric deviations away from the normal model. The normal model based on geometric symmetries.

In an embodiment, the analysis of geometric deviations of the patient's 3D cloud points compared to a predetermined normal model involves an identification and analysis of the skeletal geometry. Identification of the skeletal system and individual muscles has been established previously through the method of first skewing an anatomically predefined model to match the patient's input data of height/weight/sex etc., followed by a further skewing, using iterative closest point algorithm, based on the 3D scan data of the patient. After the patient 3D scan is anatomically identified based on the skeletal anatomy and its relation to the 3D point cloud location in Cartesian coordinate space, the system can evaluate the skeletal geometry compared to the predefined normal model, which includes a general symmetry amongst the planes of the body, right to left (frontal plane), front to back (sagittal plane), and horizontal plane rotation (transverse plane).

In an embodiment, skeletal geometry may be defined as where is the skeleton positioned in Cartesian coordinate space and what does the skeleton's position in space say about its associated fascia and muscle tissue.

In an embodiment, the skeletal geometry may be defined by degrees of a tilt of certain skeletal structures relating to right or left (frontal plane), or front or back (sagittal plane), including structures such as: head; shoulder girdle; rib cage; pelvic girdle; and any combination thereof.

In an embodiment, an analysis of a right or left tilt involves individual muscles of the lateral fascial lines responsible for the pulling of the skeletal structure into the tilt right or left.

For example, in the analysis of the skeletal geometry of a patient, 3D scan data of the patient would be input into the system. The system would then output several analyses. The system would output an analysis showing a right tilt of the shoulder girdle and rib cage and a left tilt of pelvic girdle; an analysis showing a requirement to lengthen muscles of the lateral line of the right side from shoulder to hip. (Intercostals, latissimus dorsi, serratus anterior, abdominal obliques, tensor fasciae latae, gluteus minimus, gluteus medius); and an associated ‘Deeper Diagnosis’ of the muscles directly involved in the diagnosis to be remembered by the system; or any combination thereof.

In an embodiment, an analysis of a front or back tilt involves individual muscles of the front and back fascial lines. An anterior or front tilt of the pelvic girdle involves the hip flexor muscles of the deep core fascial line.

For example, in the alternative analysis of the skeletal geometry analysis of the patient, 3D scan data would be input into the system. The system would then output several analyses. The system would output an analysis showing a front pelvic tilt; and an analysis showing the requirement to lengthen the muscles of the hip flexors involving the superficial front line and deep core line. (psoas, rectus femoris); an associated ‘Deeper Diagnosis’ to be remembered by the system; or any combination thereof.

In an embodiment, the skeletal geometry may be defined by degrees of a curve of certain skeletal structures relating to the front to back (sagittal plane), analyzed from a side view, which would include: spine segments; upper (thoracic)-lordosis or kyphosis; lower (lumbar) —lordosis or kyphosis; or any combination thereof.

In an embodiment, an analysis of a front or back curve in the spine involves individual muscles of the front and back fascial lines.

For example, in the alternative analysis of the skeletal geometry analysis of the patient, 3D scan data would be input into the system. The system would then output several analyses. The system would output an analysis showing a front curve in the upper spine defined as kyphosis; an analysis showing the requirement to lengthen the muscles of the superficial front line and the front arm line fascia relating to the location of the front of the shoulders; an associated ‘Deeper Diagnosis’ to be remembered by the system; or any combination thereof.

In an embodiment, the skeletal geometry may be defined by degrees of a rotation of certain skeletal structures relating to the direction in which the front of the named structure is pointing, analyzed as left or right or medially or laterally (transverse plane), including: femur; tibia; pelvic girdle; spine; head; humerus; rib cage; calcaneus (heel)—can be medially rotated; or any combination thereof.

In an embodiment, the skeletal geometry may be defined by degrees of a shift of certain skeletal structures relating to a displacement away from center of gravity including predominately—a displacement right or left of the shoulder girdle's relationship to the hip girdle or pelvic girdle.

In an embodiment, the fascial lines are identified by the system relative to the patient's 3D scan data. Body scan data points may be used to geometrically measure the length of the identified fascial lines relative to one another. The analysis of fascial line length relative to one another is another method of analyzing asymmetries in the patient's body's structure that should be addressed in an effective therapy program. In this embodiment, the analysis of the line length will compare fascial lines that are bilateral, meaning there are two of each, right and left, including: spiral fascial lines; lateral fascial lines; functional back lines; functional front lines; back arm lines; front arm lines; superficial front-line vs superficial back line; or any combination thereof.

In this embodiment, the length of the lines can be measured and analyzed to shed light on the possible symmetries or asymmetries between the bilateral lines or the superficial front and back lines. In a sound structure, these lines would be symmetrical. Focus will be placed on lengthening the shorter of the two lines if there is a measured asymmetry. The combination of these measurements with the previous described analysis of the skeletal geometry will encompass the entire postural or structural analysis of the patient.

In an embodiment, priority is placed on the locations with the highest degrees of deviation from the normal model. Without high degrees of deviations from geometric normal, it is still beneficial to measure any degree of deviation, no matter how small, for note of possible postural or structural improvement. Improvements to postural structure, closer to a predefined normal, is for the purpose that each cell is in a mechanical balance for optimal function by creating an even tone across the entire fascial system which could have long-term effects of immunological health, improved physiology, prevention of future injury, greater sense of self and physical potential.

In an embodiment, the analysis of the skeletal geometry will result in the assessment of the fascia and muscle tissue associated with the skeletal geometry that pulls on the skeletal structure which results in the output of the geometry analyzed. Determination will be made on what are the individual muscles and fascial lines that may be short or damaged that are responsible for the pulling or maintaining the skeleton into its current geometry. In some cases, only a single individual muscle or a portion of a fascial line may be directly impacting the skeletal geometry, and not the whole line necessarily. Understanding skeletal structure as interconnected bones which are attached by movable joints that are moveable based on their soft tissue attachments (individual muscles and fascial lines), then the geometric shape of the structure will be determined, undeniably, by the connecting soft tissue in a way that when the geometry is defined, there are few options available to debate as the source of shortness or pulling of the skeleton into the defined geometry. The result is that when the parameters of the deviation away from a normal geometry are defined, then the direction of the geometric deviation can be defined, and each defined geometric deviation will have a predefined or pre-programmed list of only a few possible objective soft tissue options that are pulling the skeletal structure into the analyzed geometric position.

In an embodiment, the development of a therapeutic diagnostic program will focus on the associated fascia and muscles, described as the ‘Deeper Diagnosis’, based on parameters including: postural/structural analysis; pain reference location and pain grade; prior injury reference location; exercise/activity type and recovery; or any combination thereof.

In an embodiment, the development of a diagnostic therapeutic program will prioritize the highest degrees of skeletal geometry deviations from normal and their associated fascia line and commonly affected muscles (Deeper Diagnosis), and locations of pain and highest pain grades and their associated fascia lines and other commonly affected muscles (Deeper Diagnosis). This does not mean that previous injury and exercise type and recovery needs are not included in the programming but the highest initial priority is the improvement of skeletal structure and pain relief.

In an embodiment, the structural analysis provides at least a portion of a fascial line and its individual muscles and satellite trigger points (Deeper Diagnosis), and pain reference location provides an individual muscle and its associated line and satellite trigger points (Deeper Diagnosis), prior injury location provides muscles around a joint and their associated fascial lines, a portion of the line above and below the injury location, and exercise or activity type and recovery provides individual muscles and exercise or activity type tightness patterns, which provides a series of individual muscles, followed by a Deeper Diagnosis.

In an embodiment, the diagnostic therapeutic program will have no shortage of requirements for therapy output by the system based on the entire set of input/output parameters. The priority will be placed on structure and pain; however, the system will focus on all input parameters and their specific output needs to be addressed in an overall therapeutic program.

In an embodiment, a patient may choose to prioritize a specific input parameter as their top priority for therapy, for example exercise or activity recovery based on their most recent exercise or activity type.

In an embodiment, the diagnostic therapeutic programming will focus on a series of sessions that specifically address each of the listed parameters. In this embodiment, each parameter would have their own individual diagnosed program with their own metric tracking and evaluation relating specifically to the given parameter. In this embodiment, the patient will choose which diagnosed program they would like to continue, and each program would include a series of sessions. Each program can be analyzed for effectiveness related to the specific parameter upon completion of the program. These programs include: structural or postural program series; pain relief program series; injury rehab program series; exercise or activity recovery program series; or any combination thereof.

In an embodiment, evaluation and revision of strategy may be constantly updated and reassessed based on new input parameters. Memory can be made of each time an input parameter was assessed and what strategy was developed, how was it followed by the patient, and how were the results evaluated, throughout the history of the patient's use of the system, and every time a new parameter is updated to the program. An evaluation of the strategy should show improvements in structure, pain, prior injury and exercise recovery at the end of the diagnosed number of sessions within the individual program.

In an embodiment, a program based on a total structural or postural reset based simply on the structure of the fascial lines of the human body, which can be tailored to the individual based on the patient's tight or damaged individual muscles within the fascial lines, will be diagnosed over approximately 10 sessions of 30 minutes each focusing on postural or structural improvement series of sessions focusing on the fascial lines of the body, including: superficial front line, and front arm line; superficial back line, and back arm lines; lateral lines; spiral lines; lower deep core-inner legs; upper deep core-hip flexors and core; back underlying-piriformis hip rotators-posterior tibialis; underlying arm lines; back functional line integration-shoulder to opposite hip; front functional line integration-ipsilateral front line-function front line; or any combination thereof.

In an embodiment, AI system machine learning can improve structural analysis of skeletal geometry in order to better comprehend the larger patterns of a patient's structural relationships. Pattern recognition in posture or structure, relating to 3D scan cloud data points that deviate furthest from a predefined “normal symmetry” is a central skill to what we call Structural Analysis. The requirements of AI System of learning are less for new techniques of specifically manipulating the muscle tissue but for an unbiased point of view to develop the strategy of a diagnostic therapeutic program and “reading” the patterns of the patient's body's 3D structure. AI Machine Learning can help provide a global way of looking at musculoskeletal patterns that lead to skeletal geometry. AI Machine Learning can help analyze skeletal structure and associated muscle groups together and understand their synergistic role structurally, rather than analyzing the body by narrowly focusing only on individual muscles. If only focusing narrowly on individual muscles, the system would then ignore the muscle's pull on the proximal or distal structures beyond. The system will not discount the need for therapeutic techniques to be applied to individual muscles and their therapeutic needs, but it sets the individual muscle in proper context with the whole skeletal structure and the full body of muscles from head to toe.

In an embodiment, structural analysis based on 3D scan and deviations from a “Normal” 3D scan which uses a therapy table as a background scale eliminates “noise” associated with 3D scanning. Also, if the system is identifying points for operation, it makes sense to have the patient be in the same position while scanned as the patient will be in during operation of therapy. Therefore, scanning the patient on the table, and having predefined models that are scanned on the table—likely in a prone, supine, and side-laying positions for scans, will create the best 3D scans for operation. Although lying positioning has a different gravitational effect on the body vs a standing posture, if the deviations from “normal” are pronounced in the laying position, it can display just how defined the asymmetries may be, and in this way, may be a better diagnostic tool than the standing posture analysis.

In an embodiment, a patient may directly choose an individual muscle for direct therapy. Some patients may have an understanding of their own anatomy, or possibly were told by a therapist or other professional what individual muscle the user should focus on. This allows the user to directly input that specific muscle to focus. Embodiments described herein will in turn, output the associative muscle groups as its ‘Deeper Diagnosis.’ The user may input the data via the touch screen display, graphic user interface 108.

For example, the input/output process of muscle selection and therapeutic programming may be as follows. The user may input a muscle group, such as trapezius (left) as their individual key muscle of focus, and the system would output “Left Trapezius Muscle Identified” and “Deeper Diagnosis: Closely Affected Muscles: levator scapula, supraspinatus (on the left side of body). Path of Orientation Muscles: Posterior and Superficial Arm Path: Deltoid, forearm extensors (on the left side of the body).”

In an embodiment, the patient may select a location of a pain reference pattern. Pain location is an important input parameter for diagnostic therapeutic programming and is based on the individual patient's ability to communicate or input that location. For many patients, pain is a chronic factor in their daily lives. Pain can be debilitating and needs to be resolved for patient health and well-being. Pain is also an important ‘signal’ from the body that there is a structural asymmetry that deviates from “normal” and needs to be addressed.

In an embodiment, pain reference location will be selected using the touch screen display, such as a graphic user interface (GUI) 108. Pain can also be graded on a level of user's perceived pain. While some users may not have a knowledge of their own anatomy, most users will be able to relate to the location or area of the body they currently feel pain. On the touch screen display (GUI) the user can relate their area of pain on an interactive image of a human anatomical display. The display will show a human anatomy anterior (front of body) and posterior display (back of body), as well as options for lateral sides of the body. Side note, lateral sides of the body will be related to certain pain patterns associated specifically to areas such as iliotibial band pain, for example, which is an area of pain that is difficult to classify as either anterior or posterior. The multiple options of different pain patterns will be symmetrical to the right and left sides of the body, just as the human anatomy of key muscle groups and skeletal structure are symmetrical to the right and left sides of the body. The system will focus on pain patterns that are pre-programmed to correlate to approximately 21 individual key muscles that are considered posterior, and approximately 16 individual key muscles that are considered anterior. These pain pattern options will be symmetrical to right and left sides of the body, which will equate to a total of 42 posterior pain pattern options, with each posterior option associated with an individual key muscle, and 32 anterior pain pattern options, with each anterior pattern associated with an individual muscle. These pain patterns and associated muscles may be updated to the system over time for improvements and additions of non-listed muscles. For certain muscle groups, a user may be prompted for side-laying therapy, which may provide better therapeutic access to certain laterally oriented muscles such as the glute minimus, tensor fasciae latae, or peroneals. For certain medially oriented muscles, such as the adductors, the user may be prompted to rotate a leg laterally in order to provide better therapeutic access to the medial side of the leg. Often, the therapeutic need of an individual will be based on a pain pattern or key muscle on only the left or only the right side of the body. However, the user may also select the same pain pattern on both sides of the body in the case that their pain pattern is bilateral (felt on both sides of the body).

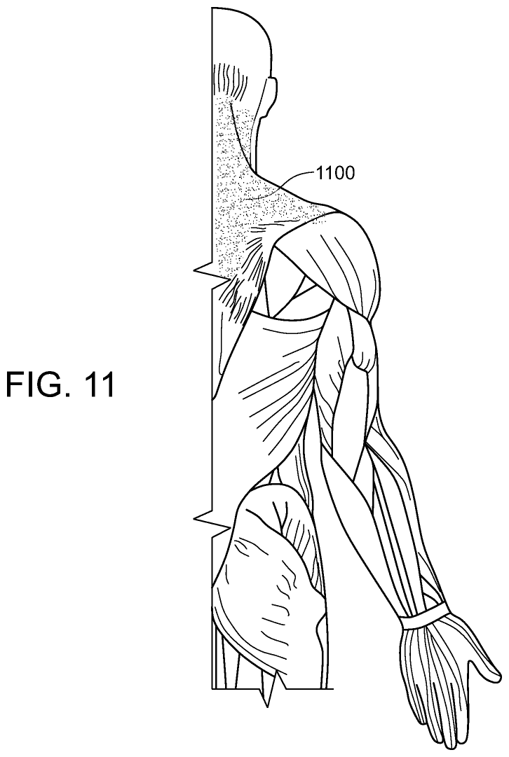

In an embodiment, the selection of a pain pattern may be input with a “cursor” on the touch screen, with an “arrow” point is provided for the user to “drag” over the human anatomical display. While the cursor is being dragged over the human anatomical display, options of pain patterns will begin to appear in a red highlighted pattern, as an example, as the cursor is dragged over the specific locations. When the user identifies the pain reference pattern that most closely matches the related location on their own body, they can select that pattern with a “double click”, for example. FIG. 11 illustrates a partial view of a posterior portion of a human with the highlighted pain pattern associated with the right trapezius muscle when the cursor is dragged over it to display the pain pattern option available for selection.

FIG. 11 shows the pain pattern appearing in red 1100 when the cursor was dragged over the area. This pain pattern is linked to the right trapezius muscle. Upon selection, the patient will then be prompted to “grade” their level of pain on a scale of 1 to 5 or 1 to 10, as an example. Grading the level of pain can give higher priority of pain patterns for the system to focus, as users may be experiencing and select more than one pain pattern. The higher the pain grade, gives the pain pattern a higher priority for therapeutic programming. Pre-programmed for every pain pattern will be an individual muscle. Once the system has its individual muscle based on the patient's input of a pain pattern selection, the pre-programmed associative muscles will be ready to output as a ‘Deeper Diagnosis’.

For example, a user input and system output by be as follows. The user may input a “pain pattern along left lumbar spine”, and a “pain grade of 4 out of 5”.

The system would output “individual muscle left psoas;” “first priority for therapy based on pain grade;” “Deeper Diagnosis: Commonly Affected Muscles: Left Quadratus Lumborum, Left Rectus Abdominus, Left Tensor Fasciae Latae, Left Gluteus Maximus, Left Glute Minimus, Left Glute Medius, Left Piriformis, Left Erector Spinae;” and “path of orientation muscles: Underlying Path: Left Tibialis Posterior, Left Adductors, Left Piriformi.”

The user may in turn input: “Pain Pattern along left Posterior Iliac Crest;” and “Pain Grade 3 out of 5.”

The system may then output: “Individual Muscle Left Quadratus Lumborum;” “Second Priority for Therapy based on Pain Grade;” “Deeper Diagnosis: Commonly Affected Muscles: Left Glute Minimus, Left Glute Medius, Left Piriformis;” and “Path of Orientation Muscles: Underlying Path: Left Tibialis Posterior, Left Adductors, Left Psoas, Left Piriformis, Right Tensor Fasciae Latae, Right Peroneals.”

The user may then input: “Pain Pattern along Glute Max origin from the Sacrum to its insertion near Posterior Hip;” “Pain Grade 1 out of 5.”

The system may then output; “Key Muscle Right Piriformis;” “Fourth Priority for Therapy based on Pain Grade;” “Deeper Diagnosis: Commonly Affected Muscles: Right Glute Minimus, Right Glute Medius;” “Path of Orientation Muscles: Underlying Path: Right Tibialis Posterior, Right Adductors, Right Psoas.”

In an embodiment, previous joint injury locations will be a parameter for the patient to input to GUI 108 for diagnostic therapeutic programming. Previous injuries can often be nagging and a constant source of tension for an individual patient. Identifying the previous injury location gives the AI further context to develop a program specific to the individual. The therapeutic plan will consist of therapy on the muscles directly attached, originated or inserted around the associated joint, and include portions of the muscles' associated fascial lines relating to the portions directly above and below the joint location.

In an embodiment, similar to the selection of a pain reference location, the patient can select the location of the previous joint injury on the touch screen, these options for joint injury selections include: shoulders, elbows, wrists, hips, knees, ankles, and spine/vertebrae.

For example, a user input and system output for previous injury selection may by be as follows. The user may input an identification of the previous right knee injury.

The system may then identify individual muscles of right quads, right hamstrings, right calves, and right anterior tibialis; or any combination thereof.

The system may also identify a “Deeper Diagnosis” for each muscle identified.

In an embodiment, the patient may input recent exercise type as a parameter for diagnostic therapeutic programming. Embodiments described herein identify the individual muscle groups associated with specific types of exercise as well as some of the tightness patterns involved with certain types of exercise. These exercise type inputs can be selected among a list of exercises and types on the touch screen display GUI 108. However, an individual's exercise data may also be potentially gathered from the network 190.

For example, the input output flow for a chart exercise recovery may be as follows. The user may input: “Exercise Type: Cycling.”

The system may then output: “Predominant muscles for fatigue: Quads first priority based on the most predominant muscle fatigued; Glutes second priority; Hip Flexors (Psoas) third priority; Hamstrings fourth priority;” “Tightness Pattern: anterior deltoid, pectoralis major, pectoralis minor;” “Underactive Muscles: erector spinae, rhomboids, rotator cuffs, latissimus dorsi;” and ‘Deeper Diagnosis’ of associative muscle groups for each key muscle identified;” or any combination thereof.

In an embodiment, Cycling is an option for an exercise type which is classified as predominantly lower body involving hips and knees, while ankle range of motion is limited. Due to tightness patterns associated with the seated position, the hips are not fully extended throughout the duration of the exercise, which tightens the hip flexors further. Also, because of the weight onto the glutes from the seated position, the glutes are often underactive and tight. Due to the tightness in the hip flexors, the front of the shoulders generally folds and round forward, the upper spine is rounded forward, and the lower spine is arched back. This leaves a whole-body system of therapeutic need due to tightness patterns associated with cycling beyond just the predominantly fatigued muscles, which would be Quads first.

For example, the user may input: “Exercise Type: Running.”

The system may then output: “Predominant muscles for fatigue: Glute Complex: Glute Maximus, Glute Medius, Glute Minimus; Hip Flexors (Psoas); Quads; Hamstrings; Calves; Anterior Tibialis;” “‘Deeper Diagnosis’ associated with each muscle identified;” or any combination thereof.

In an embodiment, Running is classified as an exercise type that is a more natural movement for the body, however, there is much more ankle and lower leg involvement especially with ground impact forces, as well as hip stabilizing muscles like the Glute Medius and Glute Minimus. Because of the natural movement, running is not given a priority to a specific lower body joint but evenly addresses the hips, knees and ankles.

For example, the user may input: “Exercise Type: Rowing.”

The system may then output: “Predominant muscles for fatigue: Quads first priority based on Predominant muscle fatigued; Lats second priority; Glutes third; Pecs fourth;” “Tightness Pattern: Tight Key Muscles: anterior deltoid, pectoralis major, pectoralis minor;” “Underactive Key Muscles: erector spinae, rhomboids, rotator cuffs, latissimus dorsi;” “Deeper Diagnosis of all identified muscles;” or any combination thereof.

In an embodiment, Rowing is an exercise type that involves the upper body pull motion with the lower body push motion. The Predominant movement pattern involves: Shoulder extension—lats and pecs, Elbow flexion—biceps, Hips—glutes, hip flexors, Knees—Quads, hamstrings. While the hip flexors and hamstrings pull the body forward on the rower, the predominant force output is on the hip and knee extension back with the upper body pull. Therefore, the Quads and glutes are of a higher priority than the hip flexors and hamstrings. While the hips move in extension and therefore fatigue the glutes, the further range of motion is at the knee which makes this a quad-dominant exercise. Due to associations with the seated position, the hips are not fully extended throughout the duration of the exercise, which tightens the hip flexors further. Also, because of the weight onto the glutes from the seated position, the glutes are often underactive and tight. Due to the tightness in the hip flexors, the front of the shoulders generally folds and round forward, the upper spine is rounded forward, and the lower spine is arched back. This leaves a whole-body system of therapeutic need due to tightness patterns associated with cycling beyond just the predominantly fatigued muscles, which would be Quads first.

For example, the user may input: “Exercise Type: Functional Weightlifting Exercises;” “Squats—including options such as single leg, step ups or lunges.”

The system may then output: “Predominant muscles for fatigue: Glutes; Quads; Hamstrings;” “Deeper Diagnosis of each identified muscle;” “or any combination thereof.

In an embodiment, Squats are an exercise type that is considered a natural movement predominantly involving hips and knees focusing on glutes and hamstrings in hip extension and quads in knee extension.

For example, the user may input: “Exercise Type: Deadlifts.”

The system may then output: “Predominant muscles for fatigue: Glutes; Hamstrings; Erector Spinae;” “Deeper Diagnosis of each identified muscle.”

In an embodiment, Deadlifts are an exercise type that is considered a natural hinge at the hips with the spine controlled parallel to the ground predominantly involving glutes and hamstrings controlling hip extension and erector spinae controlling spine extension.

For example, the user may input: “Exercise Type: Presses—including horizontal and overhead Presses.”

The system may then output: “Predominant muscles for fatigue: Deltoid; Pectoralis; Rotator cuffs; Triceps;” “Deeper Diagnosis for each identified muscle.”

In an embodiment, presses are an exercise type that are a natural upper body motion involving deltoids, pectoralis, and rotator cuffs controlling flexion of the shoulders and triceps controlling extension of the elbows.

For example, the user may input: “Exercise Type: Pulls—including rows, pullups.”

They system may then output: “Predominant muscles for fatigue: Latissimus dorsi; pectoralis; Biceps;” “Deeper Diagnosis of each identified muscle” or any combination thereof.

In an embodiment, pulling exercises are an exercise type that are a natural upper body motion involving latissimus dorsi and pectoralis controlling shoulder extension and biceps controlling elbow flexion.

In an embodiment, a patient may have the opportunity to input data on exercise intensity and volume which may be considered as the difficulty of the workout as a reference for the system to prioritize the Total Time of Therapy. For example, higher sets, repetitions, and weight of pounds lifted would equate to higher volume and intensity, and more fatigue will be placed on the predominant muscles involved in a weightlifting exercise, for example. Higher volume and Intensity place a higher priority on exercise recovery as recovery from higher intensity exercise is more difficult for the body physiologically. Likewise, different exercise types can also be specific to higher or lower intensity. Such as, higher watt output and/or distance cycling, faster speed and/or distance running, or faster speed and/or distance rowing.

In an embodiment, the category of exercise type may include activities that the patient engages in a significant amount of recent time, which may be associated with common tightness patterns. These activities may include sitting, golf, or tennis, for example.

In an embodiment, a patient may choose a program series specific to common tightness patterns associated with certain types of activities or exercise types. These programs will include a series of sessions devoted to each activity or exercise type based on their common tightness patterns in order to improve upon that exercise or activity type and minimize any negative effects. In this embodiment, the programs will consist of several individual muscles associated with a common tightness pattern that will make up a series of sessions dedicated to the individual muscles and their associated ‘deeper diagnosis’. These exercise or activity type programs may include, for example: Cycling Program Series; Running Program Series; Rowing Program Series; Functional Weightlifting Program Series; Cross-training Program Series; Pilates Program Series; Yoga Program Series; Golf Program Series; Tennis Program Series; Sitting Program Series; or any combination thereof.

In this embodiment, a patient may work several hours a week seated at a desk and wants to address the consequences of the common tightness patterns associated with sitting. An example would be as follows.

The user may input: “Sitting Program Series.”

The system would then output: “Defined Tightness Pattern—Hip Flexor muscles: Psoas; Rectus Femoris; Tensor Fasciae Latae; Rounded shoulder muscles; Pectoralis major; Pectoralis minor; or any combination thereof.

In this embodiment, these individual muscles defined in the common tightness pattern would include their Deeper Diagnosis. In this embodiment, a single session may be devoted to a single individual muscle and its deeper diagnosis. In some cases, an individual muscle defined in the common tightness pattern will be included in another of the individual muscle's deeper diagnosis.

In this embodiment, an example of the series of sessions may be: Session 1: Psoas and its deeper diagnosis; Session 2: Rectus Femoris and its deeper diagnosis; Session 3: Tensor Fasciae Latae and its deeper diagnosis; Session 4: Pectoralis Major and its deeper diagnosis; Session 5: Pectoralis Minor and its deeper diagnosis; or any combination thereof.

In an embodiment, the system may be updated over time to improve input/output methods, including, in this case, more exercise or activity options for selections and more specifications on output diagnostics associated with exercise or its intensities.

In an embodiment, predefined muscle locations are Pre-programmed to correlate to approximately 21 individual key muscles that are considered posterior, and approximately 16 individual muscles that are considered anterior. These muscles are symmetrical to right and left sides of the body, which will equate to a total of 42 posterior muscles, and 32 anterior muscles. In this embodiment, each individual is pre-programmed correlate with a diagnostic therapeutic programming parameter including: The Pain Pattern; The Exercise Pattern; Structural Pattern; Joint Injury Pattern; Deeper diagnosis Pattern; or any combination thereof.

In an embodiment, the individual muscles and their associated diagnostic therapeutic programming parameters are pre-programmed to be identified as follows.

For example: “POSTERIOR SHOULDER GIRDLE; TRAPEZIUS; Pain Pattern: on the trapezius muscle's location (C1 to T12, to spine of scapula); Exercise Pattern: Overhead Presses, High pulls, Olympic Weightlifting; Structural Pattern: shoulders elevated, “hunched” towards ears beyond deviated from ‘normal,’ Joint Injury Pattern: Shoulder injury, neck injury; Deeper diagnosis: Commonly Affected Muscles: levator scapula, supraspinatus; Path of Orientation Muscles: Superficial Posterior Arm Path: Deltoids, forearm extensors.”

For another example: “LEVATOR SCAPULA; Pain Pattern: pain on muscle location (underlying to trapezius, C4 to superior medial angle of scapula); Exercise Pattern: Overhead Presses, High pulls, Olympic Weightlifting; Structural Pattern: shoulders elevated, “hunched” towards ears beyond deviated from “normal;” Joint Injury Pattern: Shoulder injury, neck injury; Deeper diagnosis: Commonly Affected Muscles: splenius capitis, scalenes (neck muscles); Path of Orientation Muscles: Underlying Posterior Arm Path: rhomboids, rotator cuffs, triceps.”

For another example: “RHOMBOIDS: Pain Pattern: pain on muscle's location (C7 to T5, medial border of scapula); Exercise Pattern: pulling exercises; Structural Pattern: underactivity due to rounded upper spine and anteriorly rounded shoulders; Joint Injury Pattern: Shoulder; Deeper diagnosis: Commonly Affected Muscles: levator scapula, trapezius, infraspinatus, pectoralis major; Path of Orientation Muscles: Underlying Posterior Arm Path: levator scapula, rotator cuffs, triceps; Full Body Spiral Path: same side serratus anterior, same side external oblique, opposite internal oblique, opposite tensor fasciae latae, opposite anterior tibialis, opposite peroneals, opposite biceps femoris, same side erector spinae.”

For another example: “DELTOID POSTERIOR: Pain Pattern: pain on muscle's location (spine of scapula to humerus); Exercise Pattern: Presses; Structural Pattern: underactivity due to rounded upper spine and anteriorly rounded shoulders; Joint Injury Pattern: Shoulder; Deeper diagnosis: Commonly Affected Muscles: triceps, latissimus dorsi, teres major; Path of Orientation: Superficial Posterior Arm Path: trapezius, forearm extensors.”

For another example: “LATISSIMUS DORSI: Pain Pattern: Referred pain near inferior angle of scapula (humerus, ribs 3-4, inferior angle of scapula, T6-T12, L1-L5); Exercise Pattern: Pulling exercises, rowing; Structural Patterns: underactivity due to anteriorly rounded shoulders; Injury Pattern: Shoulder; Deeper diagnosis: Commonly Affected Muscles: teres major, triceps, rectus abdominus; Path of Orientation: Superficial Anterior Arm Path: pectoralis major, forearm flexors; Functional Posterior Path: opposite glute maximus, opposite vastus lateralis.”

For another example: “TERES MAJOR: Pain Pattern: pain on muscle's location (humerus, inferior angle of scapula); Exercise Pattern: pulling and pressing; Structural Pattern: underactivity anteriorly rounded shoulders; Injury Pattern: shoulder; Deeper diagnosis: Commonly Affected Muscles: triceps, latissimus dorsi, Deltoid, teres minor, subscapularis; Path of Orientation: Underlying Posterior Arm Path: rhomboids, rotator cuffs, triceps.”

For another example: “INFRASPINATUS: Pain Pattern: Referred pain on the Deltoid and brachialis muscles; Exercise Pattern: Presses; Structural Pattern: underactivity anteriorly rounded shoulders; Injury Pattern: Shoulder; Deeper diagnosis: Commonly Affected Muscles: teres minor, teres major, Deltoids, biceps, supraspinatus, latissimus dorsi; Path of Orientation: Underlying Posterior Arm Path: rhomboids, rotator cuffs, triceps.”

For another example: “TRICEPS: Pain Pattern: Referred pain on Posterior Deltoid, posterior forearm extensors near elbow (tennis elbow); Exercise Pattern: Presses; Structural Pattern: underactivity due to anteriorly rounded shoulders; Injury Pattern: elbow; Deeper diagnosis: Commonly Affected Muscles: latissimus dorsi, teres minor, teres major, brachioradialis, forearm extensors; Path of Orientation: Underlying Posterior Arm Path: rhomboids, rotator cuffs.”

For another example: “POSTERIOR FOREARM, hand/finger EXTENSORS; Pain Pattern:—Referred pain on muscle's location, near elbow (tennis elbow); Exercise Pattern: Presses; Structural Pattern: NA; Injury Pattern: elbow; Deeper diagnosis: Commonly Affected Muscles: brachioradialis; Path of Orientation: Superficial Posterior Arm Path: trapezius, deltoids.”

For another example: “POSTERIOR TORSO: ERECTOR SPINAE; Pain Pattern: Referred pain on glute maximus, posterior iliac crest, glute medius, along T12-L1, inferior angle of scapula pain; Exercise Pattern: Deadlifts; Structural Pattern: excessive lordosis (arching) of lower spine (anterior pelvic tilt); Injury Pattern: Spine/vertebrae; Deeper diagnosis: Commonly Affected Muscles: latissimus dorsi, Quadratus Lumborum; Path of Orientation: Superficial Posterior Path: hamstrings (biceps femoris, semitendinosus/membranosous), calves (gastrocnemius, soleus); Full Body Spiral Path: rhomboids, serratus anterior, external oblique, opposite internal oblique, opposite tensor fasciae latae, opposite anterior tibialis, opposite peroneals, opposite biceps femoris.”

For another example: “QUADRATUS LUMBORUM: Pain Pattern: Referred pain along iliac crest, sacrum/tailbone, glute maximus; Exercise Pattern: NA; Structural Pattern: Asymmetrical hip height; Injury Pattern: lumbar spine; Deeper diagnosis: Commonly Affected Muscles: glute minimus, glute medius, piriformis; Path of Orientation: Underlying Full Body Path: tibialis posterior, adductors, psoas, piriformis.”

For another example: “POSTERIOR LOWER LIMB: GLUTE MAXIMUS; Pain Pattern: Referred pain on sacroiliac joint, tailbone to ischial tuberosity; Exercise Pattern: Squats, Deadlifts, Cycling, Rowing, Running; Structural Pattern: underactivity due to anterior pelvic tilt; Injury Pattern: Hip; Deeper diagnosis: Commonly Affected Muscles: glute medius, glute minimus, hamstrings, psoas, rectus femoris; Path of Orientation: Lateral Path: obliques, glute minimus/medius, tensor fasciae latae, peroneals; Functional Posterior Path: vastus lateralis on the same side, latissimus dorsi on the opposite side.”

For another example: “GLUTE MEDIUS: Pain Pattern: Referred pain on sacroiliac joint, sacrum, posterior hip; Exercise Pattern: Squats, Deadlifts, Running; Structural Pattern: anterior pelvic tilt, hip height asymmetry; Injury Pattern: hip; Deeper diagnosis: Commonly Affected Muscles: Quadratus Lumborum, glute minimus, piriformis, tensor fasciae latae; Path of Orientation: Lateral Path: obliques, glute minimus, glute maximus, tensor fasciae latae, peroneals.”

For another example: “GLUTE MINIMUS: Pain Pattern: Referred pain on illiotibial band, posterior hip, biceps femoris, soleus; Exercise Pattern: Squats, Deadlifts, Running; Structural Pattern: hip height asymmetry; Injury Pattern: Hip; Deeper diagnosis: Commonly Affected Muscles: piriformis, glute medius, vastus lateralis, Quadratus Lumborum, glute maximus; Path of Orientation: Lateral Path: obliques, glute minimus, glute maximus, tensor fasciae latae, peroneals.”

For another example: “PIRIFORMIS: Pain Pattern: pain on muscle's location sacrum to posterior hip; Exercise Pattern: Squats; Structural Pattern: anterior pelvic tilt; Injury Pattern: Hip; Deeper diagnosis: Commonly Affected Muscles: glute minimus, glute medius; Path of Orientation: Underlying Full Body Path: tibialis posterior, adductors, psoas.”

For another example: “BICEPS FEMORIS: Pain Pattern: Referred pain posterior lateral knee; Exercise Pattern: Squats, Deadlifts, Cycling, Running; Structural Pattern: underactivity due to anterior pelvic tilt; Injury Pattern: Knee; Deeper diagnosis: Commonly Affected Muscles: semitendinosus/membranosous, adductors, Quadratus Lumborum, rectus abdominus; Path of Orientation: Superficial Posterior Path: erector spinae, semitendinosus/membranosous, gastrocnemius, soleus; Full Body Spiral Path: opposite rhomboids, opposite serratus anterior, opposite external oblique, same side internal oblique, same side tensor fasciae latae, same side anterior tibialis, same side peroneals, opposite erector spinae.”

For another example: “SEMITENDINOSUS/MEMBRANOSOUS: Pain Pattern: Referred pain lower buttock upper hamstring; Exercise Pattern: Squats, Deadlifts, Cycling, Running; Structural Pattern: underactivity due to anterior pelvic tilt; Injury Pattern: Knee; Deeper diagnosis: Commonly Affected Muscles: bicep femoris, adductors, Quadratus Lumborum, rectus abdominus; Path of Orientation: Superficial Posterior Path: erector spinae, bicep femoris, gastrocnemius, soleus.”

For another example: “ADDUCTOR MAGNUS: Pain Pattern: Referred pain anterior groin/thigh; Exercise Pattern: Squats, Deadlifts, Running, Cycling; Structural Pattern: Tightness due to anterior pelvic tilt; Injury Pattern: Hip, Knee; Deeper diagnosis: Commonly Affected Muscles: vastus medialis; Path of Orientation: Underlying Full Body Path: tibialis posterior, piriformis, psoas, Quadratus Lumborum.”

For another example: “GASTROCNEMIUS: Pain Pattern: Referred pain medial epicondyle of femur, lateral fibular head, medial calf to Achilles; Exercise Pattern: Running; Structural Pattern: Tightness due to anterior pelvic tilt; Injury Pattern: Knee, Ankle; Deeper diagnosis: Commonly Affected Muscles: soleus, hamstrings; Path of Orientation: Superficial Posterior Path: erector spinae, hamstrings, soleus.”

For another example: “SOLEUS: Pain Pattern: Referred pain sacroiliac joint, middle Gastroc, heel Achilles; Exercise Pattern: Running; Structural Pattern: Tightness due to anterior pelvic tilt; Injury Pattern: ankle; Deeper diagnosis: Commonly Affected Muscles: gastrocnemius, quads on the same side of the body; Path of Orientation: Superficial Posterior Path: erector spinae, hamstrings, gastrocnemius.”

For another example: “POSTERIOR TIBIALIS: Pain Pattern: Referred pain Achilles heel pain pattern; Exercise Pattern: Running; Structural Pattern: Tightness due to anterior pelvic tilt; Injury Pattern: Ankle, Knee; Deeper diagnosis; Commonly Affected Muscles: peroneals; Path of Orientation: Underlying Full Body Path: adductors, piriformis, psoas, Quadratus Lumborum.

For another example: “ANTERIOR SHOULDER GIRDLE: SERRATUS ANTERIOR: Pain Pattern: pain on muscle's location, referred pain to mid inferior angle of scapula, latissimus dorsi; Exercise Pattern: Presses, Pulls, Rowing; Structural Pattern: Tightness due to anteriorly rounded shoulders; Injury Pattern: Shoulder; Deeper diagnosis: Commonly Affected Muscles: latissimus dorsi; Path of Orientation: Full Body Spiral Path: rhomboids, external oblique same side, internal oblique opposite side, tensor fasciae latae opposite side, tibialis anterior opposite side, biceps femoris opposite side.”

For another example: “PECTORALIS MINOR: Pain Pattern: pain anterior delt; Exercise Pattern: Pulls, Rowing; Structural Pattern: Tightness due to anteriorly rounded shoulders; Injury Pattern: Shoulder; Deeper diagnosis: Commonly Affected Muscles: pectoralis major, Deltoid; Path of Orientation: Underlying Anterior Arm Path: biceps, brachialis.”

For another example: “PECTORALIS MAJOR: Pain Pattern: on muscle's location, anterior delt; Exercise Pattern: Presses, Pulls, Rowing; Structural Pattern: Tightness due to anteriorly rounded shoulders; Injury Pattern: Shoulder; Deeper diagnosis: Commonly Affected Muscles: Deltoid, trapezius, rhomboids; Path of Orientation: Superficial Anterior Arm Path: latissimus dorsi, forearm flexors; Functional front line: rectus abdominus, adductor longus on the opposite side.”

For another example: “ANTERIOR DELTOID: Pain Pattern: on muscle's location; Exercise Pattern: Presses; Structural Pattern: Tightness due to anteriorly rounded shoulders; Injury Pattern: Shoulder; Deeper diagnosis: Commonly Affected Muscles: pectoralis major, biceps brachii, posterior deltoid; Path of Orientation: Superficial Arm Path: trapezius, forearm extensors.”

For another example: “SUBSCAPULARIS: Pain Pattern: pain on infraspinatus muscle; Exercise Pattern: Presses, Pulls; Structural Pattern: Tightness due to anteriorly rounded shoulders; Injury Pattern: Shoulder; Deeper diagnosis: Commonly Affected Muscles: pectoralis major, latissimus dorsi, triceps, deltoids; Path of Orientation: Underlying Arm Path: rotator cuffs, rhomboids, triceps.”

For another example: “BICEPS: Pain Pattern: pain on anterior deltoid; Exercise Pattern: Pulls, Rowing; Structural Pattern: Tightness due to anteriorly rounded shoulders; Injury Pattern: Elbow, Shoulder; Deeper diagnosis; Commonly Affected Muscles: brachialis, triceps; Path of Orientation: Underlying Anterior Arm Path: pec minor, brachialis.”

For another example: “BRACHIALIS: Pain Pattern: pain near thumb palm base on same side; Exercise Pattern: Pulls, Rowing; Structural Pattern: Tightness due to anteriorly rounded shoulders; Injury Pattern: Elbow, Shoulder; Deeper diagnosis; Commonly Affected Muscles: brachioradialis, biceps; Path of Orientation: Underlying Anterior Arm Path: pec minor, biceps.”

For another example: “BRACHIORADIALIS; Pain Pattern: thumb side near elbow radius location (golfers elbow); Exercise Pattern: Pulls, Rowing; Structural Pattern: NA; Injury Pattern: Elbow; Deeper diagnosis: Commonly Affected Muscles: forearm extensors; Path of Orientation: Underlying Anterior Arm Path: pec minor, biceps, brachialis.”

For another example: “ANTERIOR TORSO: PSOAS: Pain Pattern: pain on Rectus femoris, anterior thigh, along lumbar spine; Exercise Pattern: Running, Cycling, Rowing; Structural Pattern: Tightness due to anterior pelvic tilt; Injury Pattern: Hip, Lumbar Spine; Deeper diagnosis: Commonly Affected Muscles: Quadratus Lumborum, rectus abdominus, tensor fasciae latae, gluteus maximus, glute minimus, glute medius, piriformis, erector spinae; Path of Orientation: Underlying Full Body Path: tibialis posterior, adductors, piriformis.”

For another example: “RECTUS ABDOMINUS: Pain Pattern: lower abdomen, mid back; Exercise Pattern: Core Exercises; Structural Pattern: Tightness due to anterior pelvic tilt; Injury Pattern: Lumbar Spine; Deeper diagnosis: Commonly Affected Muscles: external oblique, internal oblique, psoas; Path of Orientation: Superficial Anterior Path: quads, anterior tibialis.”

For another example: “OBLIQUES: Pain Pattern: superior to rectus femoris, medial to ASIS; Exercise Pattern: Core Exercises; Structural Pattern: Tightness due to Hip Height asymmetry; Injury Pattern: Lumbar spine; Deeper diagnosis: Commonly Affected Muscles: psoas, erector spinae; Path of Orientation: Full Body Spiral Path: rhomboids, external oblique same side, internal oblique opposite side, tensor fasciae latae opposite side, tibialis anterior opposite side, biceps femoris opposite side; Lateral Path: glutes, peroneals, anterior tibialis.”

For another example: “ANTERIOR LOWER LIMB: TENSOR FASCIAE LATAE: Pain Pattern: Lateral Illiotibial band; Exercise Pattern: Running, Cycling, Rowing; Structural Pattern: Tightness due to anterior pelvic tilt; Injury Pattern: Hip; Deeper diagnosis: Commonly Affected Muscles: glute minimus, rectus femoris, psoas; Path of Orientation: Full Body Spiral Path: rhomboids opposite side, external oblique opposite side, internal oblique same side, tibialis anterior same side, biceps femoris same side; Lateral Path: glutes, peroneals, anterior tibialis.”

For another example: “QUADS (VASTUS LATERALIS, RECTUS FEMORIS, VASTUS INTERMEDIUS, VASTUS MEDIALIS): Pain Pattern: rectus femoris=knee cap pain, vastus lateralis=Illiotibial band pain, vastus medialis=pain on muscle's location, vastus intermedius=anterior upper thigh pain on muscle's location; Exercise Pattern: Running, Cycling, Rowing, Squats; Structural Pattern: Tightness due to anterior pelvic tilt; Injury Pattern: Hip, Knee; Deeper diagnosis: Commonly Affected Muscles: hamstrings, tensor fasciae latae, psoas Path of Orientation: Superficial Anterior Path: rectus abdominus, anterior tibialis.”

For another example: “ADDUCTOR LONGUS: Pain Pattern: anterior thigh near anterior inferior iliac spine; Exercise Pattern: Running, Cycling, Rowing, Squats, Deadlifts; Structural Pattern: Tightness due to anterior pelvic tilt; Injury Pattern: Hip, Knee; Deeper diagnosis: Commonly Affected Muscles: vastus medialis; Path of Orientation: Underlying Full Body Path: tibialis posterior, psoas, piriformis; Functional front line: opposite lateral side of rectus abdominus, opposite pectoralis major.”

For another example: “TIBIALIS ANTERIOR: Pain Pattern: on muscle's location; Exercise Pattern: Running; Structural Pattern: underactivity due to anterior pelvic tilt; Injury Pattern: Knee, Ankle, Foot; Deeper diagnosis: Commonly Affected Muscles: peroneals; Path of Orientation: Superficial Anterior Path: quads, rectus abdominus; Full Body Spiral Path: rhomboids opposite side, external oblique opposite side, internal oblique same side, tensor fasciae latae same side, biceps femoris same side; Lateral Path: glutes, peroneals, tensor fasciae latae.”

For another example: “PERONEALS: Pain Pattern: lateral compartment of lower leg; Exercise Pattern: Running; Structural Pattern: Tightness due to anterior pelvic tilt, Hip height asymmetry; Injury Pattern: Ankle, Foot; Deeper diagnosis: Commonly Affected Muscles: anterior tibialis; Lateral Path: glutes, anterior tibialis, tensor fasciae latae; Full Body Spiral Path: opposite rhomboids, opposite serratus anterior, opposite external oblique, same.side internal oblique, same side tensor fasciae latae, same side anterior tibialis, same side biceps femoris, opposite erector spinae.

As stated, the locations of individual muscles are predefined and the associated outputs are pre-programmed.

In an embodiment, priority for therapy of individual muscles involves a combination of structural analysis, pain location and pain grade, previous injury, and exercise recovery, the output provides several muscles which the system will output based on the image sensor input of 3D scan of the patient which can be geometrically analyzed to provide a structural analysis, and patient input to the GUI 108 may provide pain location and pain grade, previous injury, and exercise recovery.

In an embodiment, when the system gives priority for individual muscles for therapy it does not necessarily mean that therapy will be performed in the order of the first priority to last priority during a diagnosed massage therapy session. For instance, if therapy were performed in order from first to last, during a massage therapy session addressing several diagnosed individual muscles, the user may be prompted to turn over several times during a therapy session for muscles located on the anterior side of the body or posterior side. Therefore, it would likely be more appropriate to prioritize in order of first priority to last priority only on the posterior side. Then, the user may be prompted to turn over, so prioritization of first to last can then be performed on the anterior side. In this way, the user may only be prompted to turn over once during a massage therapy session.

In an embodiment, prioritization for individual muscles will be based predominantly on the Total Time of Therapy on an individual muscle's orientation. In an embodiment, the operation of a massage therapy program will include time of therapy on an individual muscle that will be performed with the therapeutic device in contact with the patient at the location of the individual muscle.

In an embodiment, a diagnosed program will include the individual muscles found to be of highest priority. In this embodiment, the program will generally begin with a focus on the entire fascial line associated with individual muscles found to be of highest priority, in some cases the individual muscle diagnosed as highest priority for therapy will share a fascial line.

In an embodiment, a diagnosed massage therapy program session will generally begin with “trips” along the entire fascial line's orientation with the device in contact with the patient. The trips along the entire fascial lines orientation may include therapeutic techniques such as oscillations, for example. The trips along the entire fascial line will generally include similar time amongst each individual muscle within the path of that fascial line. After several trips, the program may focus on the portion of the line closest to the individual diagnosed muscle to perform trips only along the portion of the line. After several trips along the portion of the line, the system will narrow its focus along the prioritized diagnosed individual muscle's orientation from its origin to insertion. The therapeutic device will perform multiple “trips” back and forth on the individual muscle and may include therapeutic techniques such as oscillations, for example.

In an embodiment, one feature of Total Time of Therapy on an individual muscle will be a focus on specific locations of muscle constrictions within the individual muscle, sometimes referred to as “trigger points” or “muscle knots”. Specific locations of “trigger points” will be pre-programmed on the predefined model for each individual muscle. These specific locations may be confirmed by the patient using GUI 108 or remote controller 600, while the massage therapy program is in operation.

In an embodiment, during the time the device is in contact with an individual muscle, the device will be targeted on a specific location along the muscle's orientation that will be predefined on the patient model as a common trigger point location. When the device is in contact with a specific trigger point location, the system will cue the patient to give their feedback input to the system. The confirmation of a trigger point by the patient will be their input to GUI 108 or remote control 600 as a perceived pain reference with the specific location being input by the patient as yes or no. If yes, the patient will be cued to give their input of Pain Grade, of 1 to 5, for example. The input data will be used as a parameter within the category of Pain Reference Location and Pain Grade to be used for Diagnostic Therapeutic Programming. This is an important factor in therapy and the mapping of an individual to put their body and 3D structure in context.

In an embodiment, during the massage therapy session, the patient may be cued when to give input to the system from pre-recorded audio and video displayed on the GUI 108. The pre-recorded audio and video displayed may include a video demonstration of a massage therapy session using this system and apparatus with a model patient while a therapist explains details of the device's contact with the different anatomical locations in real-time as the video displays the same anatomical location contacted on the model patient in the demonstration video as the real-time contact with patient who is in their therapy session and viewing the GUI 108. In this embodiment, the demonstration video may show the device in contact with the model patient's trapezius muscle at the same time the device in real-time will be in contact with the patient's trapezius who is viewing the demonstration video on the GUI 108. The therapist in the video demonstration may cue the patient to give their input at specific portions of the therapy session by speaking to the patient through the pre-recorded video and audio display. For example, the therapist may say “This is the orientation of Trapezius muscle path, does this point along the path cause you any pain or tenderness?”

In an embodiment, the system may cue the patient to move a joint associated with the individual muscle the device is in contact with. This technique is sometimes referred to as Active Release. In this embodiment, the video and audio display may show a demonstration video with the device in contact with a model patient's hamstring as the real-time device is in contact with the patient. The therapist in the demonstration video may cue the patient when to move their knee by saying, “This is the orientation of the hamstring muscle path, can you slowly bend your knee for a count of three seconds and slowly straighten your knee for a count of three seconds?”, for example.

In an embodiment, the patient may have the option to select from several options of different therapeutic techniques to be performed by the system during the duration the therapeutic device is in contact with an individual muscle or an entire fascial line. In this embodiment, the massage therapy program would plan a duration of several trips to move along the orientation of an individual muscle or fascial line. The planned trips may include several different therapeutic techniques, such as oscillations, motions parallel to the orientation of the muscle or fascial line, motions cross-parallel or perpendicular to the orientation, motions of increased pressure towards the proximal attachment and decreased pressure towards the distal and vice versa, among other therapeutic techniques, in this embodiment, the patient may have the option to choose a therapeutic technique in real-time during the duration the therapeutic device is in contact with their fascial line or individual muscle, which may be input using GUI 108 or remote control 600.

In an embodiment, the patient may adjust the path of the massage therapy program in the X-axis, Y-axis, and Z-axis during operation of the massage therapy program using GUI 108 or remote control 600.

In an embodiment, the GUI 108 will display a real-time view of the therapeutic device in contact with the patient's body through input data provided by image sensors 130, 131, or 132.

In an embodiment, the patient may choose to perform a completely manually run massage therapy program, in which the patient controls the X-axis, Y-axis, and Z-axis in real-time using remote control 600, while being provided data through GUI 108.

In an embodiment, as the therapeutic device is in contact with an individual muscle during operation, the GUI 108 will provide a real-time view and display of the device in contact with the patient body, and provide a description to the patient on GUI 108 which informs the patient on what individual muscle the therapeutic device is currently in contact with, and when the device moves in contact with a different individual muscle, the GUI 108 will inform the patient on what individual muscle the therapeutic device is currently in contact with. Similarly, the GUI 108 may inform the patient on what fascial line the individual muscle belongs to and therefore what fascial line the therapeutic device is currently in contact with.

In an embodiment, the GUI 108 may also provide the patient with data on locations of trigger points during operation of therapy when the device is in contact with an individual muscle. The patient may pause operation at any point, or while the program is in operation, and have the option to either confirm the predefined location of the trigger point, or add a new location to be recorded as a trigger point to be remembered by the system, based on the patient's perceived pain when the device is in contact with that specific location. The GUI 108 will inform the patient on characteristics of a trigger point location, including a specific location of increased pain or tenderness or hardening of the muscle. The new location will be identified and remembered by the system in Cartesian coordinate space. The input data will be used as a parameter within the category of Pain Reference Location and Pain Grade to be used for Diagnostic Therapeutic Programming. This is an important factor in therapy and the mapping of an individual to put their body and 3D structure in context.

In an embodiment, Time of therapy on a specific trigger location is generally 45 seconds of minimum time for the therapeutic device to be in contact with the specific trigger point location, which may include different therapeutic techniques while the device remains in contact with the specific location, in order to elicit the necessary physiological response. Pain relief associated with specific trigger point therapy can be noted by the patient and input to GUI 108. Pain relief can be noted and analyzed by the system as a source of progress and success of the therapeutic program.

In an embodiment, a user may start lying face-down (prone) for a therapy session. The therapy program will focus first on the fascial line associated with the individual muscles diagnosed on the posterior side of the user's body, before narrowing to the individual muscles on the posterior side of the body themselves, for time of therapy specifically on the individual muscles. The individual muscle given the first priority on the posterior side of the body, based on pain grade or highest structural deviation, may receive a total time of 8 minutes of therapy while the device is in contact with that individual muscle. The 8 minutes, as an example, may include several “trips” from the muscle's origin to insertion, including therapeutic techniques such as oscillations. Within the 8 minutes of total time, a focused time on three different specific trigger point locations within the individual muscle may be performed for 60 seconds on each individual trigger point, for example.

In an embodiment, the second highest prioritized individual muscle on the posterior side of the body, based on pain grade and structural deviation, may receive 6 minutes of therapy. The 6 minutes of Total Time of Therapy may be performed in similar fashion as the previous described muscle.

In an embodiment, the third highest prioritized muscle on the posterior side of the body, may then receive 4 minutes of therapy, as an example.

In an embodiment, during a massage therapy program, following the treatment of individual muscles on the posterior side of the patient's body, the patient may then be prompted to turn facing up (supine), and now the diagnosed individual muscles on the anterior side of the patient's body will be prioritized for time of therapy in a similar manner.

In an embodiment, the system will store in memory and metrically track the Total Time of Therapy performed for every individual muscle to be logged for purposes of analysis and progress through the diagnostic therapeutic program. As described, each individual key muscle will have its pre-programmed ‘Deeper Diagnosis’ list of muscles. In certain cases, the muscles that fall within a ‘Deeper Diagnosis’ will overlap with one another. This is another purpose for the Total Time of Therapy to be remembered and metrically logged, so as not to do the same muscle multiple times as a part of a ‘Deeper Diagnosis’. The priority for these ‘deeper diagnosis’ muscles will be lower than the first diagnosed individual muscles that were directly diagnosed based on the input reference parameters. However, the ‘deeper diagnosis’ will remain a part of the broader whole-body approach to diagnostic therapeutic programming.

In an embodiment, during operation of a massage therapy program, the patient will be shown a synopsis of the Total Time of Therapy on diagnosed individual muscles planned in real-time, on GUI 108.

For an example: “Posterior Side: Superficial Back Fascial Line 5:00 minutes; Right Erector Spinae: 8:00 minutes; Left Piriformis: 6:00 minutes; Left Biceps Femoris: 4:00 minutes —Turn Over—Anterior Side: Deep Front Core Fascial Line; Right Psoas: 8:00 minutes; Left Vastus Lateralis: 6:00 minutes; Right Adductors: 4:00 minutes; Next highest priority ‘Deeper Diagnosis’ muscles.”

In an embodiment, the ‘Deeper Diagnosis’ may be listed for extra time the patient may have available following completion of the time of therapy on the individual muscles given highest priority. Now that the priority muscles have been addressed, “extra time” can be focused on these ‘Deeper Diagnosis’ muscles.

In an embodiment, a series of sessions are devoted to the individual diagnosed muscles diagnosed in order of their priority and their Deeper Diagnosis, IE, 1st session devoted to the highest priority muscle and its deeper diagnosis, 2 nd session devoted to the second highest priority muscle and its deeper diagnosis, etc. In this embodiment, an example of a series of diagnosed sessions for an individual patient may be as follows.

For example: “Right ERECTOR SPINAE” is the diagnosed muscle with highest priority. “Session 1 includes: 1. Path of Orientation: Right Superficial Posterior Path: right erector spinae, right hamstrings (biceps femoris, semitendinosus/membranosous), Right calves (gastrocnemius, soleus)—5:00 minutes along the path of the line; Full Body Spiral Path: Right rhomboids, right serratus anterior, right external oblique, left internal oblique, left tensor fasciae latae, left anterior tibialis, left peroneals, left biceps femoris. —5:00 minutes along the posterior portion of the path (right rhomboids, left biceps femoris); Right Erector Spinae—8:00 minutes along the muscle's orientation; Commonly Affected Muscles: Right latissimus dorsi, right Quadratus Lumborum—5:00 minutes along each muscle's orientation; Turn over for anterior side; Full Body Spiral Path—5:00 minutes anterior muscles (right serratus anterior, right external oblique, left internal oblique, left tensor fasciae latae, left illiotibial band, left anterior tibialis, left peroneals); Right PSOAS is the diagnosed muscle with the second highest priority. Session 2 includes: Path of Orientation: Underlying Full Body Path: Right psoas, right tibialis posterior, right adductors, right piriformis—5:00 minutes focused on anterior muscles (right psoas, right adductors); Right Psoas—8:00 minutes; Commonly Affected Muscles: Right Quadratus Lumborum, Right rectus abdominus, right tensor fasciae latae, right gluteus maximus, right glute minimus, right glute medius, right piriformis, right erector spinae—5:00 minutes anterior muscles (right rectus abdominus, right tensor fasciae latae); Turn over for posterior side; Commonly Affected Muscles—5:00 minutes posterior muscles (right Quadratus Lumborum, Right glute maximus, right glute minimus, right glute medius, right piriformis, right erector spinae).”

In an embodiment, the patient may choose to speed up operations or “skip” forward to the next individual muscle, or simply stop operations altogether.

In an embodiment, the therapeutic device is a percussion massage gun. In this embodiment, the percussion massage gun will have changes of speed of percussion which can be changed in real-time. In this case, the system can identify the speed of amplitude associated with the specific type of percussion massage gun. Understanding the speed of amplitude can help the system to improve errors associated with change of speed, like changes in friction, for example, in order to run more smoothly. The speed of amplitude can also be remembered for the individual patient as a preference setting. The higher speed may also be considered as higher therapeutic intensity, which is a factor to be stored in memory and metrically tracked by the system as a part of the diagnostic therapeutic programming for data analysis.

In an embodiment, during operation of a massage therapy program, the pressure sensor 301 input data, allows the amount of pressure that the therapeutic device is exerting while in contact with the patient to be changed in real-time. The pressure sensor 301 will input data on the amount of pressure exerted while the therapeutic device is in contact with the patient throughout operation of a massage therapy program. The pressure sensor input data may be analyzed in order to improve operations and reduce error associated with increased friction, for example. The amount of pressure preferred by a patient can also be stored in memory and metrically tracked as a part of the diagnostic therapeutic programming analysis. The higher the pressure exerted on an individual muscle may also be considered as a higher intensity of therapy, which is a factor to be stored in memory and metrically tracked by the system in a therapy program to be analyzed.

In an embodiment, the total time of therapy can be defined in terms of the amount of time the therapeutic device is in contact on a specific location, the location being the identified individual muscles of the patient's body needed for therapy based on the inputs provided to the system. In this embodiment, time of massage therapy sessions can range in times of 10, 15, 20, 25, 30 or 45 minutes, for example. There is no limit for the number of consecutive sessions the patient may decide to choose. While diagnosed muscles will be a focus of diagnostic therapeutic programming, a full body approach, focusing on full body fascial lines, while maintaining a patient specific programming recommendation, will be optional programs for selection. A patient may also have options to select specific therapy programs designed for general therapy which may be accessed by all users or patients, including programs that promote general relaxation, Swedish, Chinese Traditional, general sleep quality improvement, increased circulation, pre/post-natal, or pre- or post-workout. These programs may also include programs designed by renowned physical therapists or massage therapists. These programs may be updated over time and accessed through network 400. In this embodiment, a patient may choose a program based on more time on specific individual muscles diagnosed by the system based on the inputs into the system, or may also choose from a variety of separate massage therapy programs provided to the patient.

In an embodiment, consistency of the completion of massage therapy programs or sessions will be a factor to be stored in memory and metrically tracked in a program diagnosis and analysis of the evaluation of diagnosis strategy

In an embodiment, a general massage therapy program for post-workout recovery may be focused on muscles that need increased recovery based on the exercise type or activity.

In an embodiment, a general massage therapy program for pre-workout may include structural improvements to fascial lines or active release techniques.

In an embodiment, a display application on the GUI 108 and smartphone application will include a patient's individual 3D Reference Model for the patient to access. The patient will have the option to view their 3D Reference Model, which will be to their individual scale based on the patient input data parameters and image sensor 3D data. The patient 3D Reference Model may be rotated for multiple views of the patient's 3D model including front, back, or side views. The 3D Reference Model will include predefined anatomical locations. The patient 3D Reference Model allows the patient to view their to scale 3D model that includes a summary of all of their input data parameters, including: the locations of diagnosed individual muscles highlighted for reference, along with trigger point locations and associated deeper diagnosis muscles, which may be viewed highlighted with a differentiating marker or color, pain reference locations and pain grades, previous injury locations, and the fatigue muscles or tightness patterns associated with their recent exercise or activity type. In this embodiment, diagnosed individual muscles may be highlighted in red on the 3D Reference Model, Deeper diagnosis Commonly Affected Muscles may be highlighted in orange and paths of orientations may be highlighted in yellow, for example. In this embodiment, patient input parameters including exercise and activity type, may be input to 3D Reference Model, without permanently saving the input data, in order for the patient to see how the input data may affect their 3D Reference Model's therapeutic diagnosis, for edification purposes. In this embodiment, postural and structural analysis will also be displayed. In this embodiment, a history of the patient's therapeutic metrics may be viewed including sessions completed and time of therapy on individual muscle locations and fascial lines.

In an embodiment, machine learning will use all the data acquired on an individual patient for diagnostic therapeutic programming purposes and to predict future areas of concern for therapy based on the patient's history of data.

In an embodiment, during operation of a massage therapy session a microphone may be used for audio input from the patient to be analyzed by the system. In this embodiment, the system may have certain designated audio recordings. A pre-recorded audio may cue the patient to respond and turn on the microphone to “listen” and interpret a list of audio responses by the patient: such as “yes” or “no”, for example. Each interpreted response would have a pre-programmed pre-recorded audio response from the system, such as: “Can you tell me if this is a tender or painful spot?” The microphone may be active for the following 10 seconds to wait for response of patient being “yes” or “no”. If a patient responds “yes”, the system may respond “How would you grade your level of pain 1 out of 5?”, which would leave the microphone active for the following 10 seconds to analyze the response of a client, “Three”. The system may respond, “OK, I'll remember that this may be an area of pain and possible muscle constriction.” Other such inputs from the user may be a prompted to turn on the microphone to “listen” such as “Hey, Therapist.” This prompt would activate the microphone and listen to interpret a list of audio responses: for example, “move left”, or “more pressure”, or “faster speed”, or “stop”.

In an embodiment, an Application Programming Interface (API) associated with a smartphone application allows for communication between applications. Collection of data from other applications that may be on a smartphone, for example. The goal is to acquire data relating to purposes of diagnostic therapeutic programming purposes and evaluation of strategy. Possible acquired data may include vitals, such as heart rate, and activity level and type. Applications that have access to heart rate vitals and activity, can measure parameters such as activity type, and intensity of that activity, and how that activity can be graded as exercise performance. And related to vitals, these applications can measure sleep quality, stress levels, and exercise recovery. Communication with these applications and data acquired by our system, may be through a network connection or a downloadable application on user smart device.

In this embodiment, data can be analyzed in relation to the use and effectiveness of the system as a whole and its specific therapeutic programming. This data may also be used as input data for diagnostic purposes, to recommend changes of parameters within the therapeutic programming, such as length of session, for example.

In this embodiment, the effectiveness of a therapeutic program may have a positive correlation with increased sleep quality, decreased stress levels, increased exercise recovery, increased exercise performance, and increased activity level.

In this embodiment, the acquired data can be analyzed to determine how the general use of our system correlates with improvements of the measurables, as well as how specific use of the diagnostic program correlates with improvements of measurables. A user can casually select a short program once a week not based on the system diagnostic—how does that short session correlate with positive measurables. Or, a user follows the exact diagnostic program which calls for a specification of four sessions a week of 30 minutes per session on suggested muscle locations, for example—how does this specific diagnostic correlate with positive measurables. What is ideal frequency of sessions (sessions per week), length of sessions (10, 15, or 30 minutes, for example), locations of sessions (which muscles are focused on), and what are their correlations with positive measurables, is all data that can be analyzed by AI.

In this embodiment, measurable data may be used as a diagnostic tool for the system. For instance, the measurable data shows what is determined as a high level of activity on that day. The system may, in turn, suggest that a longer therapy session may be necessary that day to more effectively recover from the higher intensity activity day. The data may show that the specific activity type was higher intensity for the lower body, this would yield a suggestion of the specific lower body muscles that were more intensely active on that day. The data may show high stress levels. The system may suggest more time of a session, and certain muscles that are often tightened in relation to stress, like the upper trapezius, for example. Or the measurable data may show decreased exercise recovery, the system may suggest that more time devoted to a therapy session may be of more benefit to the individual than a difficult exercise session, for example.

In this embodiment, the acquired data may be used as a personal health reminder in these cases. Such as, in this hypothetical, we have the correlative data that suggests use of the system, or use of certain specific programs of the system, improves specific measurements of increased sleep quality, decreased stress levels, increased exercise recovery, increased exercise performance, and increased activity level. Then, whichever measurable needs improvement, the data can be used to remind the individual that our system correlates to be an effective method or strategy to improve that given measurable, and therefore improve the overall health and well-being of that individual.

In this embodiment, the correlations of the system's use and improvements of measurable data should be positive on average. For example, if the measurables show that the data is not improving, then that specific individual may benefit from a different strategy of diagnostic therapeutic programming such as more time during a therapy session, or perhaps more time on certain locations relating to the individual's specific activity or exercise type.

In an embodiment, a smartphone application may include an application programming interface which may be used to schedule diagnosed therapy sessions into the patient's weekly schedule, which may include reminder notifications.

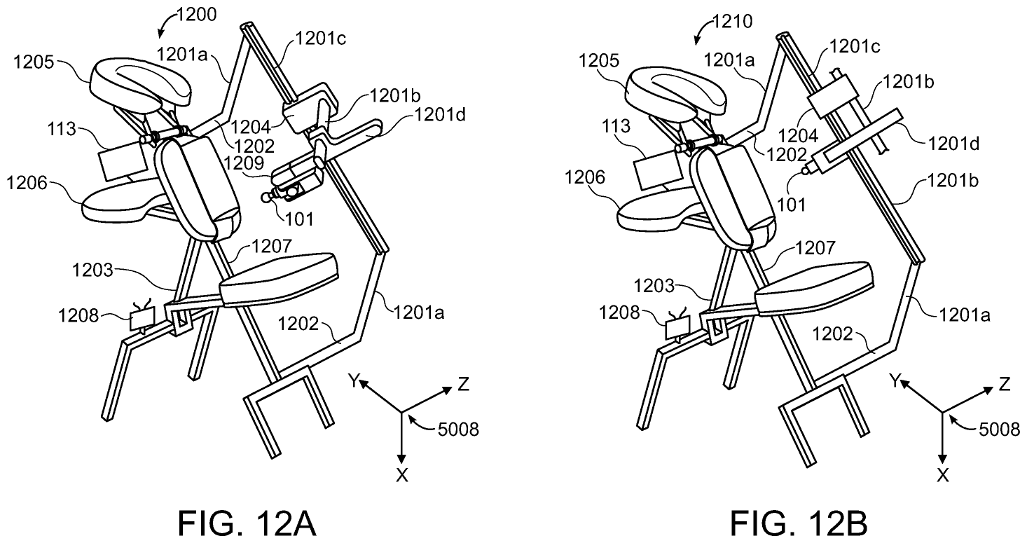

FIGS. 12A and 12B show an embodiment 1200 with a seated facedown massage chair 1203 as an option to use with the system 100 and method to control a therapeutic device in contact with a patient. FIG. 12A displays a frame 1201a-d similar to that of frame 102. The frame 1201 also contains a structure 1202 which extends the frame 1201 away from the chair 1203, such that the frame 1201 may rise above and behind the patient. Horizontal support member 1201a positions the Y-axis vertical support member parallel to the vertical spine 1207 of the chair 1203, such that the X-axis horizontal support member may extend behind the patient. A Z-axis vertical support member 1201d is designed to support a therapeutic device 101 at or near its distal end, in order to contact a patient sitting face-down on the seated facedown massage chair 1203. The therapeutic device 101 may be a percussion massage gun. The Z-axis vertical support member 1201d will have an actuator for moving the Z-axis vertical support member 1201d and the attached device 101 in the Z-axis to determine a pressure interaction with a patient. The Z-axis vertical support member 1201d will be coupled with an X-axis horizontal support member 1201b. The X-axis horizontal support member 1201b will have an actuator for moving the coupled Z-axis vertical support member 1201d and attached device 101 in the X-axis. The X-axis horizontal support member 1201b will be coupled to a Y-axis support track 1201c. The Y-axis support track 1201c will have an actuator for moving the X-axis horizontal support member 1201b in the Y-axis. FIGS. 12A and 12B shows a hinge 1204 at the horizontal support member's coupling with the Y-axis support track such that the horizontal support member may fold for purposes of storage, and to easily allow the patient to fold the armature out of the way while they seat themselves in the chair 1203. The chair 1203 includes a headrest/face rest 1205, as well as an elbow rest 1206. 3-dimensional orientation compass 5008 is shown for orientation clarity.

FIG. 12A shows the Y-axis support track 1201c attached to vertical portions or elevation legs 1201a which elevate the frame behind the seated patients back. The vertical portions or elevation legs 1201a are coupled to lateral legs 1202 which attach to the spine frame or vertical frame 1207 of the seated facedown massage chair 1203. The elevation legs may contain a hinge 1201a t their attachment to the lateral legs 1202, such that the elevation legs 1201a, and their attached Y-axis support track 1201c and coupled frame 1201b-d, are foldable for storage. This embodiment may also include a processor 1208, with CPU, and accompanying memory, is shown for identification but may be positioned in a compartment. The processor can control the actuators associated with the Y-axis support track 1201c, the horizontal support member 1201b, and vertical support member 1201d, as well as the attached device 101. An image sensor 1209 is shown to be positioned near the therapeutic device support near the distal end of the vertical support member 1201d to provide an input data view of the patient while seated facedown and the contact point of the therapeutic device which is provided to the processor. A pressure sensor may be contained within the device support and provide input to the processor. In this embodiment, as stated in the previous embodiments, the processor may connect to a network. The processor 1283 may receive input from one or more image sensors, one or more pressure sensors, inertial measurement unit, user input to graphic interface, and AI algorithm and coded programs. The processor 1208 will use the inputs to control the actuators. The graphic user interface 113 will be positioned to be accessed by the patient while the patient is face-down on the seated massage chair 1203 such that the GUI 113 can be accessed while the patient's face is in the face cushion or headrest. The patient may access similar diagnostic therapeutic programming as previously described, however, the seated facedown massage chair is predominantly designed for seated back therapy. The chair may also have a remote controller which can input control signals to the processor.

FIG. 12B shows embodiment 1210 which depicts the same massage chair 1203 as in FIG. 12A where the horizontal support member 1201b is folded at hinge 1204 such that the patient is capable of easily getting in and out of the chair, as well as allowing ease of storage of the chair. 3-dimensional orientation compass 5008 is shown for orientation clarity.

Previously described embodiments position a patient underneath the apparatus relative to gravity. For these embodiments, in order for the patient to receive therapy on their back, the patient would be oriented to face towards the floor while the apparatus is positioned above their back. Embodiments described herein describe the position of the apparatus underneath the patient, relative to gravity. These embodiments described herein, would allow for the patient to receive therapy on their back, for example, while facing up towards the ceiling, as opposed to facing down towards the floor. These embodiments may employ the use of a thin material which would allow the patient to lean back or lay back against while oriented to face up towards the ceiling.

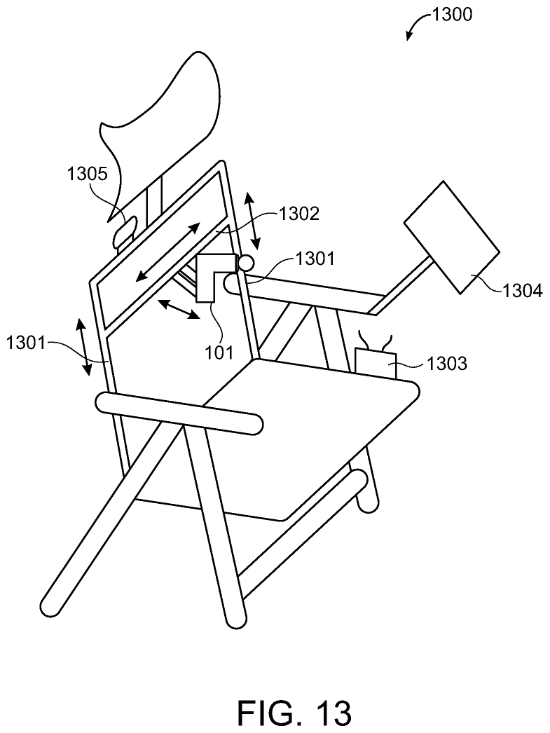

FIG. 13 displays a seated chair embodiment 1300 of the system 100. This embodiment shows two Y-support tracks 1301. The two Y-support tracks may be coupled to one or two actuators for moving the two Y-support tracks. A horizontal support member 1302 bridges across horizontally to couple to the two Y-support tracks. The one or two actuators that are coupled to the two Y-support tracks move the horizontal support member in the Y-axis. The horizontal support member is coupled to a vertical support member. The horizontal support member is coupled to an actuator which moves the vertical support member in the X-axis. The vertical support member contains a therapeutic device support located near its distal end. The vertical support member is coupled to an actuator for moving the vertical support member and attached therapeutic device 101 in the Z-axis and determines a pressure interaction with a patient. The vertical support member may be telescopic or multi-stage in order to have a smaller footprint for possible storage purposes. In this embodiment, the entire seated chair frame may be foldable for storage purposes. In this embodiment, therapeutic device support and device attachment is accessible on the frame behind the material which supports the patient while the patient is seated while leaning back. This embodiment, as is the case with previous embodiments described, may contain a device support for supporting a therapeutic device, such as a percussion massage gun, for example, which may be attached for operation, and removed following operation, or the device support may have a therapeutic device that is built into the system, such as a percussion massage device, which may not be attachable and removable. This embodiment may also include a processor 1303, with CPU, and accompanying memory. The device support may include a pressure sensor which can provide input data to the processor. A graphic user interface 1304 may be positioned for access by the patient, shown to be positioned near the arm rest. The processor 1303 may receive input from one or more image sensors 1305, one or more pressure sensors, user input to graphic interface, inertial measurement unit, and AI algorithm and coded programs. The processor will use the inputs to control the actuators. The processor may also connect to a network and receive input from the network. The chair may also have a remote controller which can input control signals to the processor.

In this embodiment, the material used to support the patient while leaning back is hidden from view from FIG. 13 in order to provide view of the frame. This material may be a solid material that is strong enough to support the patient, but also thin enough for the patient to receive therapeutic benefit from the therapeutic device's contact with the patient through the material. This material may be similar to other seated massage chair products, such as a synthetic leather material. This type of solid material likely makes an image sensor obsolete in terms of view of a patient. A material that employs the use of a mesh with micro spacing would allow for an image device to provide input of a view of the therapeutic device in contact with the patient. This embodiment of the seated chair would be used predominantly for therapy of the back.

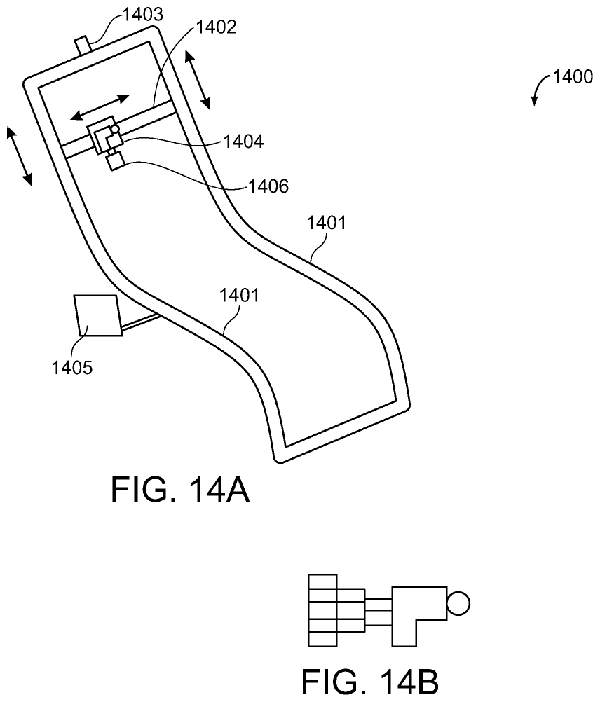

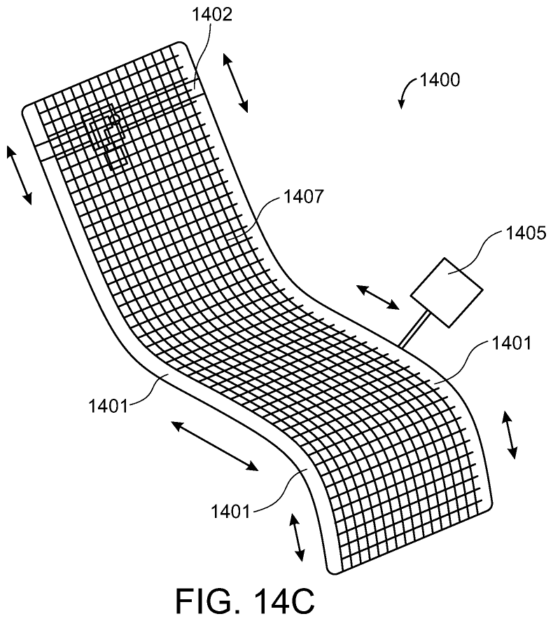

FIG. 14A displays a seated chair embodiment 1400 which is shaped to act as a “zero-gravity chair,” which puts the patient's body in a neutral position and evenly distributes the patient's weight across the length of the chair. This embodiment shows two Y-support tracks 1401. The two Y-support tracks may be coupled to one or two actuators 1403 for moving the two Y-support tracks. The two Y-axis support tracks contain curvilinear tracks at the approximate level of the patient's hips and knees. The curved tracks allow for the “zero-gravity” neutral position of the patient, while also allowing for motion of the Y-axis support tracks and therapeutic device to travel over the entire length of the patient's body. A horizontal support member 1402 bridges across horizontally to couple to the two y-support tracks. The one or two actuators that are coupled to the two Y-support tracks move the horizontal support member 1402 in the Y-axis. The horizontal support member 1402 is coupled to a vertical support member. The horizontal support member 1402 is coupled to an actuator which moves the vertical support member in the X-axis. The vertical support member contains a therapeutic device support 1404 located near its distal end. The vertical support member is coupled to an actuator for moving the vertical support member and attached therapeutic device in the Z-axis and determines a pressure interaction with a patient.

FIG. 14B shows that the vertical support member may be telescopic or multi-stage in order to have a smaller footprint. In this embodiment, therapeutic device support and device attachment is accessible on the frame behind the material which supports the patient while the patient is seated while leaning back, which would allow for attachment and removal of a therapeutic device, such as a percussion massage gun, for example. This embodiment, as is the case with previous embodiments described, may contain a device support for supporting a therapeutic device, such as a percussion massage gun, for example, which may be attached for operation, and removed following operation, or the device support may have a therapeutic device that is built into the system, such as a percussion massage device, which may not be attachable and removable. This embodiment may also include a processor, with CPU, and accompanying memory. The device support may include a pressure sensor which can provide input data to the processor. A graphic user interface 1405 may be positioned for access by the patient, shown to be positioned near the arm rest. The processor may receive input from one or more image sensors 1406, one or more pressure sensors, user input to graphic interface 1405, Inertial Measurement Unit, and AI algorithm and coded programs. The processor will use the inputs to control the actuators. The processor may also connect to a network and receive input from the network. The Y-axis tracks remain fixed in this embodiment and the reclining of the chair has a tilt of the angle of the entire chair to further lean back or sit up. This may be a manual tilt or may be automated with use of another actuator for automated reclining or inclining of the chair. The chair may also have a remote controller which can input control signals to the processor. The “zero-gravity” chair embodiment may employ the use of a solid, thin material for the patient to lean back against while seated in the chair, however, a solid material may make an image sensor obsolete for viewing the patient. A mesh material with micro spacing may be employed to provide image signals of the patient to the processor.

FIG. 14C illustrates the “zero-gravity” chair embodiment 1400 with a mesh material 1407. Mesh may be made of materials that can create a strong fabric-like structure such as Teslin, polyester, Kevlar™, nylon, which may be PVC coated, vinyl, acrylic, PVC coated polyester, or other suitable material.

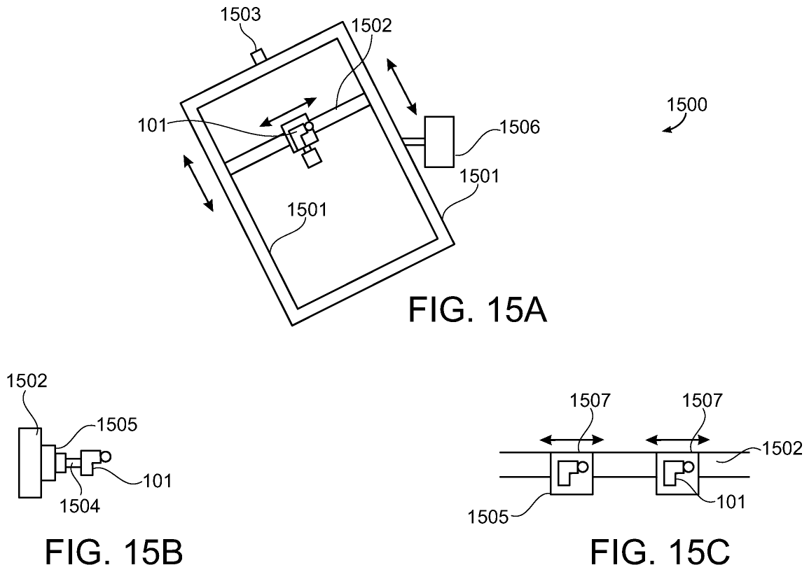

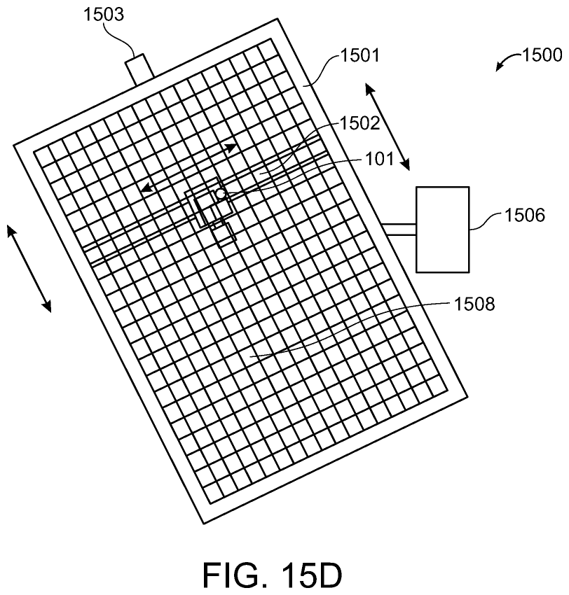

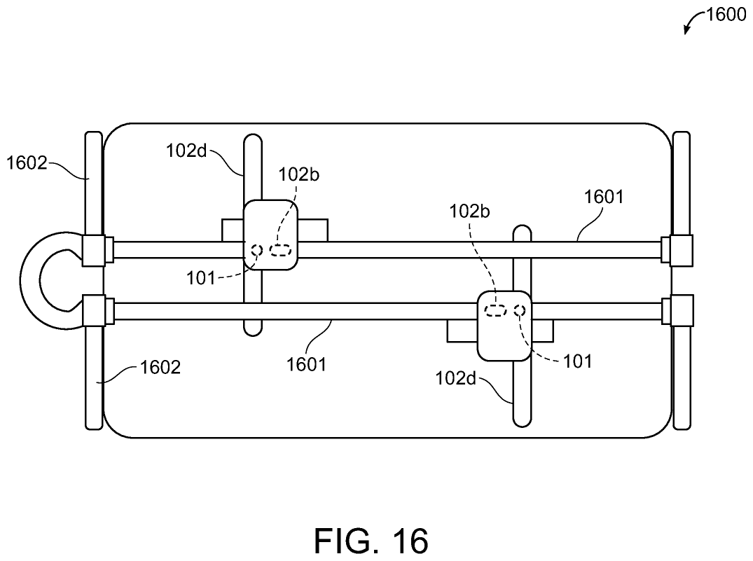

FIG. 15A shows a bed embodiment 1500 that includes the robotic frame positioned underneath a laying patient. The robotic frame consists of two Y-axis support tracks 1501 controlled by one or two actuators and moves the entire length of the patient. A horizontal support member 1502 bridges across horizontally to couple to the two Y-support tracks. The one or two actuators that are coupled to the two Y-support tracks move the horizontal support member in the Y-axis. The horizontal support member is coupled to a vertical support member 1504, which is coupled to the therapy device 101. The horizontal support member 1502 is coupled to an actuator 1503 which moves the vertical support member 1505 in the X-axis. The vertical support member 1505 contains a therapeutic device support 1504 located near its distal end. The vertical support member 1505 is coupled to an actuator for moving the vertical support member 1505 and an attached therapeutic device 101 in the Z-axis and determines a pressure interaction with a patient.

This embodiment may also include a processor, with CPU, and accompanying memory. The device support may include a pressure sensor which can provide input data to the processor. A graphic user interface 1506 may be positioned for access by the patient, shown to be positioned near the side of the bed. The processor may receive input from one or more image sensors, one or more pressure sensors, user input to graphic interface, Inertial Measurement Unit, and AI algorithm and coded programs. The processor will use the inputs to control the actuators. The processor may also connect to a network and receive input from the network. The bed may also have a remote controller which can input control signals to the processor. This embodiment may employ the use of a solid, thin material for the patient to lean back against while seated in the chair, however, a solid material may make an image sensor obsolete for viewing the patient. A mesh material with micro spacing may be employed to provide image signals of the patient to the processor.

FIG. 15B shows the vertical support member 1505 may be telescopic or multi-stage in order to have a smaller footprint. In this embodiment, therapeutic device support and device attachment is accessible on the frame behind the material which supports the patient while the patient is laying back, which would allow for attachment and removal of a therapeutic device, such as a percussion massage gun, for example. This embodiment, as is the case with previous embodiments described, may contain a device support 1504 for supporting a therapeutic device 101, such as a percussion massage gun, for example, which may be attached for operation, and removed following operation, or the device support may have a therapeutic device that is built into the system, such as a percussion massage device, which may not be attachable and removable.

FIG. 15C shows two gantry devices 1507 positioned on the horizontal support member 1502 X-axis. In these embodiments, the two gantries would have independent vertical support members 1505, each with a therapeutic device support located near their distal ends. In these embodiments, the independent vertical support members 1505 would each have an associated actuator for moving the vertical support 1505 members independently along the X-axis 1502. The vertical support members 1505 would also have separate actuators for moving the vertical support members and attached therapeutic device in the z-axis in order to determine a pressure interaction with a patient. The use of two gantries 1507, each with an attached therapeutic device 101, on a single horizontal support member 1502, may be applied to any of the previously described embodiments. The use of two gantries, each with an attached therapeutic device, on a single horizontal support member, would allow for therapy to be applied to the patient's right side and left side simultaneously. This may allow for the gantries to be programmed for a mirrored or symmetrical therapeutic program to be performed on the same anatomical locations of the right and left side of the body simultaneously. As previously described, each therapeutic device support may have one or more pressure sensors which can provide data to the processors.

FIG. 15D shows the embodiment 1500 with a mesh material 1508 embodiment. Mesh 1508 may be made of materials that can create a strong fabric-like structure such as Teslin, polyester, Kevlar™, nylon, which may be PVC coated, vinyl, acrylic, PVC coated polyester, or other suitable material.

In an additional embodiment, the robotic frame may be an automated or manual recliner that may be inclined to a certain degree or fully reclined for the patient to lay back. The robotic frame consists of two Y-axis support tracks controlled by one or two actuators and moves the entire length of the patient. A horizontal support member bridges across horizontally to couple to the two Y-support tracks. The one or two actuators that are coupled to the two Y-support tracks move the horizontal support member in the Y-axis. The horizontal support member is coupled to a vertical support member. The horizontal support member is coupled to an actuator which moves the vertical support member in the X-axis. The vertical support member contains a therapeutic device support located near its distal end. The vertical support member is coupled to an actuator for moving the vertical support member and an attached therapeutic device in the Z-axis and determines a pressure interaction with a patient. The vertical support member may be telescopic or multi-stage in order to have a smaller footprint. In this embodiment, therapeutic device support and device attachment is accessible on the frame behind the material which supports the patient while the patient is laying back, which would allow for attachment and removal of a therapeutic device, such as a percussion massage gun, for example. This embodiment, as is the case with previous embodiments described, may contain a device support for supporting a therapeutic device, such as a percussion massage gun, for example, which may be attached for operation, and removed following operation, or the device support may have a therapeutic device that is built into the system, such as a percussion massage device, which may not be attachable and removable. This embodiment may also include a processor, with CPU, and accompanying memory. The device support may include a pressure sensor which can provide input data to the processor. A graphic user interface may be positioned for access by the patient. The processor may receive input from one or more image sensors, one or more pressure sensors, user input to graphic interface, Inertial Measurement Unit, and AI algorithm and coded programs. The processor will use the inputs to control the actuators. The processor may also connect to a network and receive input from the network. The bed may also have a remote controller which can input control signals to the processor. This embodiment may employ the use of a solid, thin material for the patient to lean back against while seated in the chair, however, a solid material may make an image sensor obsolete for viewing the patient. A mesh material with micro spacing may be employed to provide image signals of the patient to the processor.

This embodiment could be adjustable by incline/recline and could be fully reclined to a laying position. The recline/incline may be adjusted manually. An actuator may be incorporated to make incline or recline automated. In order to operate the robotic frame from head to toe, while considering changing positions of incline or full recline, may benefit from a rail bend or switch concept similar to that used with railroad tracks, in order to accommodate the Y-axis support track moving the entire length of the patient's body whether the frame is inclined or reclined.

The bed or reclining embodiments may be foldable for storage with a hinge at the midway point of the Y-axis tracks.

For the embodiments described, in which the patient's back would be leaning or laying against a material while the therapeutic device contacts the patient through the material, a solid material may serve purposes of aesthetic, and providing additional support of weight of a user and potentially longer operational life of the material. The solid material Use of a sensor built into the material or weaved into the material. Sensors built or weaved into a material that a user may lay on, may be used as input data into the system. Weaving sensors interlaced with textiles and composite materials may involve piezoelectric and piezo-resistant pressure sensing. This may be used as an input for the scale and size of a user laying or seated on the material. This would be beneficial with a solid material that may make machine vision or scanning more obsolete. It may also be used to detect the exact location of the percussion gun, for example, or other therapeutic device, relative to the contact point with the patient.

In an embodiment in which a patient was to lay on a solid material, a separate image scan of a user, used for purposes of accurate therapy, may be effective but not necessarily while the system is in operation. For this embodiment, the patient input of height/weight/sex/body type-input data, described in previous embodiments, can also assist to provide accurate, autonomous therapy with the use of a solid material. This use of patient input can skew a predefined program to the scale of the patient using an algorithm based on human statistical averages. Use of depth perception input data, similar to time of flight, may be beneficial for this solid material due to the scale of the patient slightly sinking into the material. Therefore, a depth sensor may be employed to sense the depth of the person sinking into the frame.

For certain embodiments, it is useful to incorporate a synthetic mesh material that the user will lie on. This mesh material surface is similar to lying on a bed or reclining in a chair, while the device contacts the patient through the mesh. This allows a patient to receive therapy on the posterior side of their body without needing to lay face-down. In this embodiment, one or more image sensors would be underneath the patient lying or reclined on the mesh fabric and could provide image signals of the patient and the therapeutic device location in contact with the patient's body. Using 3D scanning techniques such as LiDAR, or depth sensing such as time of flight sensors, it is possible to identify a patient through the mesh. The mesh material permits the image sensing techniques to be able to “see” the user.

In this embodiment, an image sensor can “see through” a mesh, in the sense of lasers or light reflecting off of objects and returning to the sensor receiver. The mesh has “micro” spacing for the lasers or light to pass through before returning to the scanner—in this sense, the scanner can differentiate between the mesh and the patient laying or leaning on the mesh.

This embodiment would allow one or more image sensors to the scan a patient similar to the embodiment of a patient scanned on a therapy table. The scan with a mesh can create, at the minimum, a very “clean” 2D scan. A 2D scan can similarly use iterative closest point conceptual algorithms or similar registration algorithms in comparison to a “predefined” model, which would allow for accurate therapy of predefined anatomical locations, including locations of fascial lines, individual muscles, and trigger points, as described in previous embodiments. Similar to the embodiments where a user would be lying underneath sensors, lying or reclining on a mesh would enable predefined models, as previously described, to be used to identify key muscle locations which can be skewed through AI algorithms to match the identity of a new patient, which allows for all diagnostic therapeutic programming based on input data to be implemented for these embodiments, as well. As described in previous embodiments, patient input data parameters may be used for diagnostic therapeutic programming, which will be beneficial with these mesh bed or chair embodiments. Data may be input on the graphic interface and image sensors can provide input data of the patient as well as operation of the robotic frame and therapeutic device's contact with the patient. Inertial Measurement Unit can provide physics of motion. Pressure sensors can provide data of pressure exerted on a patient through the mesh material.

In this embodiment, a patient may lay on their side for therapy on the lateral side of their body and scanned on their side for potential structural analysis. A patient may potentially lay face-down on the mesh for anterior therapy (front side of body), however, the main focus of the mesh concept is to provide ease of full body posterior therapy while the patient laying relaxed on their back, which may be beneficial for certain populations. A patient may lay on their side for therapy on the lateral side of their body, as well.

In an embodiment, a heat conduction material may be weaved or built into a solid material or mesh material that the patient would sit or lay back against. An electric heating of the material the user would lay on may serve therapeutic benefit, as heat is often used in therapy for its benefits of increased circulation. With an electric heat conduction built or weaved into the material, the user may access heat and its therapeutic benefits simultaneously with the contact from the therapeutic device. The therapeutic device itself on any embodiment may include a tool that includes a targeted heat application with may be electrically conducted.

FIG. 16 shows an embodiment 1600 where there may be the use of two elevated Y-axis support tracks 1601 positioned above the table, each elevated above the table with vertical supports or elevation legs. The Y-axis support tracks are each coupled to independent horizontal support members 1602. The Y-axis support tracks are each coupled to independent actuators for moving the independent horizontal support members in the Y-axis. The independent horizontal support members 1602 may be movable in the X-axis and may be telescopic or booming. An example of a booming motion of a horizontal support member in the X-axis, may be one which extends the horizontal support member over the table as it moves further through the X-axis, and retracts the horizontal support member away from the table as it moves the other direction through the X-axis. In this embodiment, an independent horizontal support member 1602 may contact the same side of a patient's body simultaneously with a separate independent horizontal support member. Meaning, both attached therapeutic devices may contact two locations on the right side of the body simultaneously, or two locations on the left side simultaneously, as well as one on the upper body or one on the lower body simultaneously, or a mirrored symmetrical therapy on the right and left side simultaneously. In this embodiment, each horizontal support member 1602 would have their own independent actuators for moving each horizontal support member independently. In this embodiment, each horizontal support member is coupled with a vertical support member with a therapeutic device support on or near its distal end to support a therapeutic device. In this embodiment, each vertical support member would have its own actuator for moving the vertical support member and attached therapeutic device in the z-axis and determine a pressure interaction with a patient. Each device support may also contain one or more pressure sensors. In this embodiment, as displayed in FIG. 16, the two Y-support tracks and two horizontal support members may be foldable, similar to FIGS. 9A and 9B. In this embodiment, the vertical portions or elevation legs contain hinges at their coupling with the therapy table, and the horizontal support members contain a hinge at their coupling with the Y-axis support tracks. This allows for both frames to be folded parallel to horizontal planar surface of the therapy table for purposes of storage.

The functions performed in the above-described processes and methods may be implemented in differing order. Furthermore, the outlined steps and operations are only provided as examples. Some of the steps and operations may be optional, combined into fewer steps and procedures, or expanded into additional steps and procedures without detracting from the disclosed embodiments' essence.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject disclosure as defined by the appended claims.

What is claimed is:

1. A system for facilitating massage therapy of a patient, the system comprising:
a Z-axis support member configured to move along a Z-axis, the Z-axis support member including:
a mounting surface on or near its distal end, wherein the mounting surface is configured to receive a therapy device;
a Z-axis actuator operably coupled to the Z-axis support member, the Z-axis actuator configured to move the Z-axis support member along the Z-axis;
an X-axis support member operably coupled to the Z-axis support member, the Z-axis support member configured to move along the X-axis support member in the X-axis;
an X-axis actuator operably coupled to the X-axis support member, the X-axis actuator configured to move the Z-axis support member along the X-axis;
a Y-axis support member movably supporting the X-axis support member, such that the X-axis support member is movable along a Y-axis;
a Y-axis actuator operably coupled to the Y-axis support member, the Y-axis actuator configured to move the X-axis support member along the Y-axis;
at least one processor operably coupled to the X-axis actuator, the Y-axis actuator, and the Z-axis actuator;
a memory with computer code instructions stored thereon, the processor and the memory, with the computer code instructions, configured to cause the system to:
receive signals from a network device and transmit signals to the network device; and
control operation of the X-axis actuator, the Y-axis actuator, and Z-axis actuator, based at least in part on the received signals from the network device; and
a graphical user interface, operably coupled to the processor, the graphical user interface configured to:
receive input from a user and display data from the network device to generate control signals based at least in part on the user input and the data received from the network device; and
transmit the control signals to the processor to instruct the processor to control operation of the X-axis actuator, the Y-axis actuator, and Z-axis actuator.

2. The system of claim 1, wherein an additional axis of rotation is introduced at the coupling between the therapy device and the Z-axis support member, such that the therapy device is free to rotate around the X-axis.

3. The system of claim 1, further comprising one or more imaging sensors, the imaging sensors configured to:
generate image signals; and
provide the image signals to the processor.

4. The system of claim 3, wherein the processor is further configured to provide the image signals to the graphical user interface.

5. The system of claim 3, wherein the one or more imaging sensors include one or more cameras, time of flight sensors, LiDAR, or any combination thereof.

6. The system of claim 3, wherein a therapy plan is generated, said therapy plan comprising a combination of human input data and image sensor data.

7. The system of claim 1, further comprising utilizing an artificial intelligence technique to generate body scan data points that are provided to the processor as input signals.

8. The system of claim 7, in which the artificial intelligence technique is based on user defined variables of height, weight, sex, or any combination thereof.

9. The system of claim 1, in which one or more 3-dimensional human anatomy models are programmed in the memory of the processor, wherein the 3-dimensional human anatomy model identifies certain human anatomical locations identifiable as body scan data points, said scan points being defined by the system in 3-dimensional Cartesian coordinate space.

10. The system of claim 9, further comprising utilizing an artificial intelligence technique configured to alter the body scan data points in a 3-dimensional Cartesian coordinate space based on the user defined variables of height, weight, and sex or any combination thereof.

11. The system of claim 9, further comprising utilizing an artificial intelligence technique configured to alter the body scan data points in a 3-dimensional Cartesian coordinate space based on input from one or more imaging sensors, wherein the imaging sensors are configured to generate image signals and provide the image signals to the processor.

12. The system of claim 1, further comprising one or more pressure sensors disposed on either the Z-axis support member, or the X-axis support member, the one or more pressure sensors configured to:
sense pressure exerted by the mounting surface of the Z-axis support member, or the X-axis support member; and
provide sensed pressure data signals to the processor.

13. The system of claim 1, further comprising a remote controller operatively coupled to the processor, the remote controller further configured to:
provide user input control signals to the processor;
independently control motion of the Z-axis support member in the Z-axis;
independently control motion of the Z-axis support member in the X-axis; and
independently control motion of the X-axis support member in the Y-axis.

14. The system of claim 13, wherein the remote controller is further configured to control a therapy device, said therapy device being operably coupled to the mounting surface.

15. The system of claim 1, wherein the graphical user interface is further configured to:
provide user input control signals to the processor;
independently control motion of the Z-axis support member in the Z-axis;
independently control motion of the X-axis support member in the X-axis and the Y-axis; and
control the operation of a therapy device operably coupled to the mounting surface of the Z-axis support member.

16. The system of claim 1, further comprising a substantially planar surface configured to support the Y-axis support member.

17. The system of claim 16, wherein the X-axis support member further comprises:
elevation legs, said elevation legs being coupled to the Y-axis support member, and elevate the Y-axis support member above the planar surface; and
a hinge configured such that the Y-axis support member is able to fold parallel along the planar surface.

18. The system of claim 16, further comprising:
the Y-axis support member having a construction of a similar length to the planar surface, and a hinge operably coupled to the midway point of the Y-axis support member;
the planar surface having a construction of a similar length to the Y-axis support member, and a hinge operably coupled to the midway point of the planar surface; and
the Y-axis support member and the planar surfaces being coupled by said respective hinges, such that the Y-axis support member and the planar surface are able to fold in a parallel manner.

19. The system of claim 1, further configured such that:
the Y-axis support member is oriented to be behind or underneath a user;
a material is affixed between the user and the Y-axis support member, said material configured to support the weight of the user; and
a therapy device is attached to the Z-axis support member, and configured such that the therapy device is capable of applying pressure on the user through the material.

20. A system for controlling one or more support members, the system comprising, by a processor:
defining, in memory of the processor, one or more saved data sets configured to store representations about a user;
receiving input data from a user;
receiving signals from a patient device;
receiving signals from a network device;
generating control signals to control movement of the one or more support members based at least in part on the input data from a user, signals received from the patient device, and signals received from the network device; and
providing the control signals to one or more actuators operably coupled to the one or more support members.
